(19) United States
(12) Patent Application Publication
(10) Pub. No.: US 2026/0223898 A1
(43) Pub. Date: Aug. 6, 2026

(54) GLP-1 COMPANION BEVERAGES

(71) Applicant: PepsiCo, Inc., Purchase, NY (US)

(72) Inventors: Seyhun GEMILI, Montville, NJ (US); Da Som NO, White Plains, NY (US); Yuan FANG, Courtlandt Manor, NY (US); Marlena SHERIDAN, Park Ridge, NJ (US); Joseph GLEASON, Suffield, CT (US); Kate LOFFT, Park Ridge, NJ (US); Winsome JOHNSON, Ossining, NY (US); Brandon GUTIERREZ, Mount Vernon, NY (US); Phyllip AUGUSTIN, Yonkers, NY (US); Sarita PORBANDARWALA, Fair Lawn, NJ (US); Tara GLASGOW, New Canaan, CT (US); Mina SFONDILIS, Chicago, IL (US); Jason BILLIG, Thornwood, NY (US)

(21) Appl. No.: 19/465,627

(22) Filed: Jan. 30, 2026

Related U.S. Application Data
(60) Provisional application No. 63/752,274, filed on Jan. 31, 2025.

(51) Int. Cl. A23L 2/66; A23L 2/39; A23L 2/68

(52) U.S. Cl. CPC A23L 2/66; A23L 2/39; A23L 2/68

(57) ABSTRACT

The present disclosure provides high protein beverages for patients taking GLP-1 receptor agonists. Also provided are powder bases for providing high protein beverages and methods of maintaining muscle mass in a subject taking a GLP-1 receptor agonist.

### FIELD

The present disclosure provides high protein beverages for patients taking GLP-1 receptor agonists. Also provided are powder bases for providing high protein beverages and methods of maintaining muscle mass in a subject taking a GLP-1 receptor agonist.

### BACKGROUND

The introduction of new generation anti-obesity medications, particularly nutrient-stimulated hormone-based therapies such as glucagon-like peptide-1 receptor agonists (GLP-1 RAs), represents a significant advancement in the global fight against obesity. These therapies promote weight loss primarily by inducing satiety and delaying gastric emptying, resulting in significant weight reductions. However, GLP-1 RAs also reduce both fat and fat-free mass, including skeletal muscle, which plays a vital role in overall health and well-being. It is therefore important to incorporate lifestyle modifications into GLP-1 RA-assisted weight loss to support skeletal muscle health.

A high protein diet is advantageous during GLP-1 RA-assisted weight loss for several reasons. First, increased protein intake helps to reduce body weight and improve body composition by decreasing fat mass while preserving fat-free mass, including skeletal muscle. High-quality protein sources also provide essential amino acids that are necessary for muscle protein synthesis. Second, a high protein diet promotes enhanced satiety and increased thermogenesis, both of which contribute to better weight management. For these reasons, higher protein intake is recommended as part of effective weight loss strategy to optimize body composition and support long-term weight loss maintenance.

Currently, the most popular products available to meet these needs are protein shakes, which are often chalky in texture and limited in flavor options. There is a need for beverages that can provide high levels of protein and other nutrients to consumers taking weight loss products that are refreshing and provide more taste options.

### BRIEF SUMMARY

In a first aspect, the present disclosure provides a beverage comprising:
a. from about 1 wt % to about 10 wt % of protein;
b. a nanoemulsion comprising one or more vitamins, the nanoemulsion having a particle size distribution: D90 of not more than 25 nm;
c. one or more electrolytes; and
d. fiber;
   wherein the beverage has a turbidity measurement of less than 100 NTUs and/or an absorbance of less than 0.1 at 600 nm wavelength. In a second aspect, the present disclosure provides a beverage comprising:
a. from about 1 wt % to about 10 wt % of protein;
b. one or more electrolytes; and
c. fiber;
   wherein the beverage has a turbidity measurement of less than 100 NTUs and/or an absorbance of less than 0.1 at 600 nm wavelength.

In some aspects, the protein comprises collagen, pea protein, rice protein, whey protein isolate, or a combination thereof.

In some aspects, the whey protein isolate comprises one or more of:
a. no more than 1.3 wt % potassium;
b. no more than 0.50 wt % calcium; or
c. no more than 0.6 wt % sodium.

In some aspects, the beverage comprises from about 0.1 wt % to about 7 wt % of protein hydrolysate. In some aspects, the protein isolate and the protein hydrolysate are in a weight ratio of from about 90:10 to about 30:70.

In some aspects, the beverage comprises from about 10% DV to about 200% DV of the one or more vitamins. In some aspects, the one or more vitamins is selected from the group consisting of fat soluble vitamins, water soluble vitamins, and a combination thereof.

In some aspects, the beverage comprises from about 0.05 wt % to about 0.35 wt % of the one or more electrolytes.

In some aspects, the beverage comprises from about 0.5 wt % to about 3 wt % of the soluble fiber.

In some aspects, the beverage further comprises a sweetener. In some aspects, the sweetener is selected from the group consisting of a nutritive sweetener, a non-nutritive sweetener, and a combination thereof. In some aspects, the sweetener is a nutritive sweetener selected from the group consisting of allulose, fructose, galactose, glucose, high fructose corn syrup lactose, maltose, maltulose, sucrose, and a combination thereof. In some aspects, the sweetener is a non-nutritive sweetener is selected from the group consisting of aspartame, acesulfame potassium, sucralose, erythritol, monk fruit, xylitol, a steviol glycoside, and a combination thereof. In some aspects, the steviol glycoside is selected from the group consisting of stevoside, steviolbioside, rubusoside, dulcoside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside Q, and a combination thereof.

In some aspects, the beverage further comprises a flavoring agent. In some aspects, the flavoring agent is selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, mint flavor, ginger flavor, basil flavor, lemon flavor, vinegar flavor, peach flavor, watermelon flavor, and a combination thereof.

In some aspects, the beverage further comprises one or more minerals. In some aspects, the one or more minerals is selected from the group consisting of calcium, magnesium, potassium, sodium, iron, and a combination thereof.

In some aspects, the beverage further comprises caffeine.

In some aspects, the beverage further comprises from about 0.01 wt % to about 0.5 wt % of one or more acids. In some aspects, the one or more acids is selected from the group consisting of ascorbic acid, citric acid, lactic acid, malic acid, phosphoric acid, tartaric acid, and a combination thereof. In some aspects, the one or more acids is selected from the group consisting of malic acid, tartaric acid, and a combination thereof.

In some aspects, the beverage has a pH of about 3.0 to about 3.5. In some aspects, the beverage has a pH of about 6.5 to about 7.5.

In some aspects, the beverage is carbonated.

In some aspects, the present disclosure provides a powder base for preparing a beverage, the powder base comprising:
a. from about 40 wt % to about 80 wt % of protein;
b. one or more vitamins;
c. one or more electrolytes; and
d. fiber;
   wherein the powder base provides a beverage having a turbidity of less than 100 NTUs and/or an absorbance of less than 0.04 at 600 nm wavelength, when about 20 g to about 40 g of the powder is added to about 500 mL water and shaken for at least 15 seconds.

In some aspects, the present disclosure provides a powder base for preparing a beverage, the powder base comprising:
a. from about 40 wt % to about 80 wt % of protein;
b. one or more electrolytes; and
c. fiber;
   wherein the powder base provides a beverage having a turbidity of less than 100 NTUs and/or an absorbance of less than 0.04 at 600 nm wavelength, when about 20 g to about 40 g of the powder is added to about 500 mL water and shaken for at least 15 seconds. In some aspects, the powder base comprises collagen, pea protein, rice protein, whey protein isolate, or a combination thereof.

In some aspects, the whey protein isolate comprises one or more of:
a. no more than 1.3 wt % potassium;
b. no more than 0.50 wt % calcium; or
c. no more than 0.6 wt % sodium.

In some aspects, the powder base comprises from about 5% wt % to about 55 wt % of protein hydrolysate. In some aspects, the protein isolate and the protein hydrolysate are in a weight ratio of from about 90:10 to about 30:70.

In some aspects, the powder base comprises from about 0.01 wt % to about 0.3 wt % of one or more vitamins. In some aspects, the one or more vitamins is selected from the group consisting of fat soluble vitamins, water soluble vitamins, and a combination thereof.

In some aspects, the wherein the powder base comprises from about 1 wt % to about 5 wt % of the one or more electrolytes.

In some aspects, the powder base comprises from about 5 wt % to about 20 wt % of soluble fiber.

In some aspects, the powder base further comprises a sweetener. In some aspects, the sweetener is selected from the group consisting of a nutritive sweetener, a non-nutritive sweetener, and a combination thereof. In some aspects, the sweetener is a nutritive sweetener selected from the group consisting of allulose, fructose, galactose, glucose, high fructose corn syrup lactose, maltose, maltulose, sucrose, and a combination thereof. In some aspects, the sweetener is a non-nutritive sweetener is selected from the group consisting of aspartame, acesulfame potassium, erythritol, monk fruit, xylitol, a steviol glycoside, and a combination thereof. In some aspects, the steviol glycoside is selected from the group consisting of stevoside, steviolbioside, rubusoside, dulcoside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside Q, and a combination thereof.

In some aspects, the powder base further comprises a flavoring agent. In some aspects, the flavoring agent is selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof.

In some aspects, the powder base further comprises one or more minerals. In some aspects, the one or more minerals is selected from the group consisting of calcium, magnesium, potassium, sodium, iron, and a combination thereof.

In some aspects, the powder base further comprises caffeine.

In some aspects, the powder base further comprises from about 0.1 wt % to about 8 wt % of one or more acids. In some aspects, the one or more acids is selected from the group consisting of ascorbic acid, citric acid, lactic acid, malic acid, tartaric acid, and a combination thereof. In some aspects, the one or more acids is selected from the group consisting of malic acid, tartaric acid, and a combination thereof.

In some aspects, the present disclosure provides a method of preventing muscle mass loss in a subject taking a GLP-1 receptor agonist, the method comprising administering to the subject an effective amount of a beverage comprising:
a. from about 1 wt % to about 10 wt % of protein;
b. a nanoemulsion comprising one or more vitamins, the nanoemulsion having a particle size distribution: D90 of not more than 25 nm;
c. one or more electrolytes; and
d. fiber;
   wherein the beverage has a turbidity measurement of less than 100 NTUs and/or less than 0.04 absorbance at 600 nm wavelength.

In some aspects, the present disclosure provides a method of preventing muscle mass loss in a subject taking a GLP-1 receptor agonist, the method comprising administering to the subject an effective amount of a beverage comprising:
a. from about 1 wt % to about 10 wt % of protein;
b. one or more electrolytes; and
d. fiber;
   wherein the beverage has a turbidity measurement of less than 100 NTUs and/or less than 0.04 absorbance at 600 nm wavelength.

In some aspects, the GLP-1 receptor agonist is selected from the group consisting of dulaglutide, exenatide, liraglutide, semaglutide, tirzepatide, survodutide, mazdutide, retatrutide, maridebart cafraglutide, and a combination thereof. In some aspects, the GLP-1 receptor agonist is selected from the group consisting of liraglutide, semaglutide, tirzepatide, and a combination thereof.

In some aspects, the protein comprises the protein comprises collagen, pea protein, rice protein, whey protein isolate, or a combination thereof.

In some aspects, the whey protein isolate comprises one or more of:
a. no more than 1.3 wt % potassium;
b. no more than 0.50 wt % calcium; or
c. no more than 0.6 wt % sodium.

In some aspects, the protein comprises from about 0.5 wt % to about 7 wt % of whey protein hydrolysate. In some aspects, the whey protein isolate and the whey protein hydrolysate are in a weight ratio of from about 90:10 to about 30:70.

In some aspects, the beverage comprises from about 10% DV to about 200% DV of the one or more vitamins. In some aspects, the one or more vitamins is selected from the group consisting of fat soluble vitamins, water soluble vitamins, and a combination thereof.

In some aspects, the beverage comprises from about 0.05 wt % to about 0.35 wt % of the one or more electrolytes.

In some aspects, the beverage comprises from about 0.5 wt % to about 3 wt % of the soluble fiber.

In some aspects, the beverage further comprises a sweetener. In some aspects, the sweetener is selected from the group consisting of a nutritive sweetener, a non-nutritive sweetener, and a combination thereof. In some aspects, the sweetener is a nutritive sweetener selected from the group consisting of allulose, fructose, galactose, glucose, high fructose corn syrup lactose, maltose, maltulose, sucrose, and a combination thereof. In some aspects, the sweetener is a non-nutritive sweetener is selected from the group consisting of aspartame, acesulfame potassium, erythritol, monk fruit, xylitol, a steviol glycoside, and a combination thereof. In some aspects, the steviol glycoside is selected from the group consisting of stevoside, steviolbioside, rubusoside, dulcoside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside Q, and a combination thereof.

In some aspects, the beverage further comprises a flavoring agent. In some aspects, the flavoring agent is selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof.

In some aspects, the beverage further comprises one or more minerals. In some aspects, the one or more minerals is selected from the group consisting of calcium, magnesium, potassium, sodium, iron, and a combination thereof.

In some aspects, the beverage further comprises caffeine.

In some aspects, the beverage further comprises from about 0.01 wt % to about 0.5 wt % of one or more acids. In some aspects, the one or more acids is selected from the group consisting of ascorbic acid, citric acid, lactic acid, malic acid, phosphoric acid, tartaric acid, and a combination thereof. In some aspects, the one or more acids is selected from the group consisting of malic acid, tartaric acid, and a combination thereof.

In some aspects, the beverage has a pH of about 3.0 to about 3.5. In some aspects, the beverage has a pH of about 6.5 to about 7.5.

In some aspects, the beverage is carbonated.

In some aspects, the effective amount of the beverage is from about 350 mL to about 3000 mL. In some aspects, the effective amount of the beverage is provided in a single dose. In some aspects, the effective amount of the beverage has a volume that does not exceed 500 mL.

In some aspects, the effective amount of the beverage is provided as a series of divided doses. In some aspects, each divided dose has a volume that does not exceed 500 mL.

In some aspects, the method further comprises supplementing the beverage with an additional protein source. In some aspects, the additional protein source is selected from the group consisting of collagen, whey protein, wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof. In some aspects, the additional protein source comprises at least one protein and, optionally, at least one additional nutritive agent.

Additional aspects and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### DETAILED DESCRIPTION

The headings provided herein are not limitations of the various aspects of the disclosure, which can be defined by reference to the specification as a whole. It is also to be understood that the terminology used herein is for the purpose of describing particular aspects only, and is not intended to be limiting, since the scope of the present disclosure will be limited only by the appended claims.

### Definitions

For convenience, the meaning of some terms and phrases used in the specification, examples, and appended claims are provided below. Unless stated otherwise, or implicit from context, the following terms and phrases include the meanings provided below. The definitions are provided to aid in describing particular aspects, and are not intended to limit the claimed technology, because the scope of the technology is limited only by the claims. Unless otherwise defined, all technical and scientific terms used herein have the same meaning as commonly understood by one of ordinary skill in the art to which this technology belongs. If there is an apparent discrepancy between the usage of a term in the art and its definition provided herein, the definition provided within the specification will control.

The articles “a,” “an,” and “the” are used herein to refer to one or to more than one (i.e., to at least one) of the grammatical object of the article. By way of example, “an element” means one element or more than one element.

As used herein, the term “about” means within an acceptable error range for the particular value as determined by one of ordinary skill in the art, which depends in part on how the value is measured or determined, i.e., the limitations of the measurement system. For example, “about” can mean a range of up to 10% (e.g., up to 5% or up to 1%) of a given value.

The term “at least” prior to a number or series of numbers is understood to include the number associated with the term “at least,” and all subsequent numbers or integers that could logically be included, as clear from context. When at least is present before a series of numbers or a range, it is understood that “at least” can modify each of the numbers in the series or range. For example, “at least 3” means at least 3, at least 4, at least 5, etc. When at least is present before a component in a method step, then that component is included in the step, whereas additional components are optional.

As used herein, the term “collagen” refers to any food-safe collagen, including, but not limited to bovine collagen, porcine collagen, marine collagen, non-animal collagen, and a combination thereof. The term “non-animal collagen” refers to proteins that are similar to animal-based collagens in their amino acid structures. The non-animal collagens can be obtained through known fermentation technologies. The term collagen as used herein can also refer to food-safe collagen peptides prepared from the hydrolysis of bovine, porcine, marine, non-animal collagen, and any combination thereof.

As used herein, the terms “comprises,” “comprising,” “having,” “including,” “containing,” and the like are open-ended terms meaning “including, but not limited to.” To the extent a given aspect disclosed herein “comprises” certain elements, it should be understood that present disclosure also specifically contemplates and discloses aspects that “consist essentially of” those elements and that “consist of” those elements.

As used herein the terms “consists essentially of,” “consisting essentially of,” and the like are to be construed as a semi-closed terms, meaning that no other ingredients which materially affect the basic and novel characteristics of an aspect are included.

As used herein, the terms “consists of,” “consisting of,” and the like are to be construed as closed terms, such that an aspect “consisting of” a particular set of elements excludes any element, step, or ingredient not specified in the aspect.

### Compositions of the Disclosure

### Beverages

The present disclosure provides clear beverages comprising protein, vitamins, electrolytes, and fiber. In some aspects, the beverages can be carbonated. In some aspects the beverages can be non-carbonated.

In certain aspects, the beverage has a turbidity of less than 100 NTUs and/or an absorbance of less than 0.1 at 600 nm wavelength. In some aspects, the beverage has a turbidity of less than 99 NTUs and/or an absorbance of less than 0.1 at 600 nm wavelength. In some aspects, the beverage has a turbidity of less than 98 NTUs and/or an absorbance of less than 0.1 at 600 nm wavelength. In some aspects, the beverage has a turbidity of less than 97 NTUs and/or an absorbance of less than 0.1 at 600 nm wavelength. In some aspects, the beverage has a turbidity of less than 96 NTUs and/or an absorbance of less than 0.1 at 600 nm wavelength.

In certain aspects, the protein comprises collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, or a combination thereof. In some aspects, the protein comprises collagen, pea protein, rice protein, whey protein isolate, or a combination thereof. In some aspects, the protein comprises whey protein isolate.

In some aspects, the protein can be present in the beverage in an amount from about 1 wt % to about 10 wt %. In some aspects, the protein can be present in the beverage in an amount from about 1 wt % to about 9 wt %. In some aspects, the protein can be present in the beverage in an amount from about 1 wt % to about 8 wt %. In some aspects, the protein can be present in the beverage in an amount from about 1 wt % to about 7 wt %. In some aspects, the protein can be present in the beverage in an amount from about 1 wt % to about 6 wt %. In some aspects, the protein can be present in the beverage in an amount from about 1 wt % to about 5 wt %. In some aspects, the protein can be present in the beverage in an amount from about 1.25 wt % to about 4.5 wt %. In some aspects, the protein can be present in the beverage in an amount from about 1.5 wt % to about 4 wt %. In some aspects, the protein can be present in the beverage in an amount from about 1.75 wt % to about 3.75 wt %. In some aspects, the protein can be present in the beverage in an amount of about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6.0 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7.0 wt %, about 7.1 wt %, about 7.2 wt %, about 7.3 wt %, about 7.4 wt %, about 7.5 wt %, about 7.6 wt %, about 7.7 wt %, about 7.8 wt %, about 7.9 wt %, about 8.0 wt %, about 8.1 wt %, about 8.2 wt % o, about 8.3 wt % o, about 8.4 wt % o, about 8.5 wt % o, about 8.6 wt % o, about 8.7 wt % o, about 8.8 wt %, about 8.9 wt %, about 9.0 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, or about 10 wt %.

In some aspects, the protein in the beverage is comprised of a mixture of protein isolate and protein hydrolysate. Without being bound by a particular theory, protein hydrolysates are thought to increase plasma amino acid concentrations compared to intact protein isolates, accelerate protein digestion and absorption from the gut, augment postprandial amino acid availability, and tend to increase the incorporation rate of dietary amino acids into skeletal muscle protein. As protein hydrolysates typically have an unpleasant taste, using a mixture of protein isolate and protein hydrolysate is thought to provide improved digestion of the protein while maintaining acceptable flavor.

In some aspects, the protein isolate comprises no more than about 1.5 wt % potassium. In some aspects, the protein isolate comprises no more than about 1.4 wt % potassium. In some aspects, the protein isolate comprises no more than about 1.3 wt % potassium. In some aspects, the protein isolate comprises no more than about 1.2 wt % potassium. In some aspects, the protein isolate comprises no more than about 1.1 wt % potassium. In some aspects, the protein isolate comprises no more than about 1.0 wt % potassium. In some aspects, the protein isolate comprises no more than about 0.9 wt % potassium. In some aspects, the protein isolate comprises no more than about 0.8 wt % potassium. In some aspects, the protein isolate comprises no more than about 0.7 wt % potassium. In some aspects, the protein isolate comprises no more than about 0.6 wt % potassium. In some aspects, the protein isolate comprises no more than about 0.5 wt % potassium. In some aspects, the protein isolate comprises no more than about 0.4 wt % potassium. In some aspects, the protein isolate comprises no more than about 0.3 wt % potassium. In some aspects, the protein isolate comprises no more than about 0.2 wt % potassium. In some aspects, the protein isolate comprises no more than about 0.1 wt % potassium. In some aspects, the protein isolate does not comprise potassium.

In some aspects, the protein isolate comprises no more than about 0.70 wt % calcium. In some aspects, the protein isolate comprises no more than about 0.60 wt % calcium. In some aspects, the protein isolate comprises no more than about 0.50 wt % calcium. In some aspects, the protein isolate comprises no more than about 0.40 wt % calcium. In some aspects, the protein isolate comprises no more than about 0.30 wt % calcium. In some aspects, the protein isolate comprises no more than about 0.20 wt % calcium. In some aspects, the protein isolate comprises no more than about 0.10 wt % calcium. In some aspects, the protein isolate comprises no more than about 0.05 wt % calcium. In some aspects, the protein isolate comprises no more than about 0.1 wt % calcium. In some aspects, the protein isolate comprises no more than about 0.09 wt % calcium. In some aspects, the protein isolate comprises no more than about 0.08 wt % calcium. In some aspects, the protein isolate comprises no more than about 0.07 wt % calcium. In some aspects, the proteinisolate comprises no more than about 0.06 wt % calcium. In some aspects, the protein isolate comprises no more than about 0.05 wt % calcium. In some aspects, the protein isolate comprises no more than about 0.04 wt % calcium. In some aspects, the protein isolate comprises no more than about 0.03 wt % calcium. In some aspects, the protein isolate comprises no more than about 0.02 wt % calcium. In some aspects, the protein isolate comprises no more than about 0.01 wt % calcium. In some aspects, the protein isolate does not comprise calcium.

In some aspects, the protein isolate comprises no more than about 1.0 wt % sodium. In some aspects, the protein isolate comprises no more than about 0.95 wt % sodium. In some aspects, the protein isolate comprises no more than about 0.90 wt % sodium. In some aspects, the protein isolate comprises no more than about 0.85 wt % sodium. In some aspects, the protein isolate comprises no more than about 0.80 wt % sodium. In some aspects, the protein isolate comprises no more than about 0.75 wt % sodium. In some aspects, the protein isolate comprises no more than about 0.70 wt % sodium. In some aspects, the protein isolate comprises no more than about 0.67 wt % sodium. In some aspects, the protein isolate comprises no more than about 0.65 wt % sodium. In some aspects, the protein isolate comprises no more than about 0.60 wt % sodium. In some aspects, the protein isolate comprises no more than about 0.55 wt % sodium. In some aspects, the protein isolate comprises no more than about 0.50 wt % sodium. In some aspects, the protein isolate comprises no more than about 0.45 wt % sodium. In some aspects, the protein isolate comprises no more than about 0.40 wt % sodium. In some aspects, the protein isolate comprises no more than about 0.35 wt % sodium. In some aspects, the protein isolate comprises no more than about 0.30 wt % sodium. In some aspects, the protein isolate comprises no more than about 0.25 wt % sodium. In some aspects, the protein isolate comprises no more than about 0.20 wt % sodium. In some aspects, the protein isolate comprises no more than about 0.15 wt % sodium. In some aspects, the protein isolate comprises no more than about 0.10 wt % sodium. In some aspects, the protein isolate does not comprise sodium.

In some aspects, the protein isolate comprises one or more of: a) no more than about 1.5 wt % potassium; b) no more than about 0.7 wt % calcium, or c) no more than about 1.0 wt % sodium.

In some aspects, the protein isolate comprises one or more of: a) no more than about 1.2 wt % potassium; b) no more than about 0.60 wt % calcium, or c) no more than about 0.90 wt % sodium.

In some aspects, the protein isolate comprises one or more of: a) no more than about 1.0 wt % potassium; b) no more than about 0.50 wt % calcium, or c) no more than about 0.80 wt % sodium.

In some aspects, the protein isolate comprises one or more of: a) no more than about 0.80 wt % potassium; b) no more than about 0.40 wt % calcium, or c) no more than about 0.70 wt % sodium.

In some aspects, the protein isolate comprises one or more of: a) no more than about 0.60 wt % potassium; b) no more than about 0.30 wt % calcium, or c) no more than about 0.50 wt % sodium.

In some aspects, the protein isolate comprises one or more of: a) no more than about 0.40 wt % potassium; b) no more than about 0.10 wt % calcium, or c) no more than about 0.40 wt % sodium.

In some aspects, the protein isolate comprises one or more of: a) no more than about 0.20 wt % potassium; b) no more than about 0.08 wt % calcium, or c) no more than about 0.20 wt % sodium.

In some aspects, the protein isolate comprises one or more of: a) no more than about 1.2 wt % potassium; b) no more than about 0.05 wt % calcium, or c) no more than about 0.60 wt % sodium.

In some aspects, the protein isolate comprises one or more of: a) no more than 1.3 wt % potassium; b) no more than 0.50 wt % calcium, or c) no more than 0.60 wt % sodium.

In some aspects, the beverage comprises from about 0.1 wt % to about 7 wt % of protein hydrolysate. In some aspects, the beverage comprises from about 0.2 wt % to about 7 wt % of protein hydrolysate. In some aspects, the beverage comprises from about 0.3 wt % to about 7 wt % of protein hydrolysate. In some aspects, the beverage comprises from about 0.4 wt % to about 7 wt % of protein hydrolysate. In some aspects, the beverage comprises from about 0.5 wt % to about 7 wt % of protein hydrolysate. In some aspects, the beverage comprises from about 1 wt % to about 6.5 wt % of protein hydrolysate. In some aspects, the beverage comprises from about 1.5 wt % to about 6 wt % of protein hydrolysate. In some aspects, the beverage comprises from about 2 wt % to about 6 wt % of protein hydrolysate. In some aspects, the beverage comprises from about 2 wt % to about 5.5 wt % of protein hydrolysate. In some aspects, the beverage comprises from about 2.5 wt % to about 5 wt % of protein hydrolysate. In some aspects, the beverage comprises about 0.1 wt %, about 0.2 wt %, about 0.3 wt %, about 0.4 wt %, 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4%, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6.0 wt %, about 6.1 wt %, about 6.2 wt %, about 6.3 wt % o, about 6.4 wt % o, about 6.5 wt % o, about 6.6 wt % o, about 6.7 wt % o, about 6.8 wt % o, about 6.9 wt %, or about 7.0 wt %, of protein hydrolysate.

In some aspects, the protein isolate and the protein hydrolysate are present in the beverage in a weight ratio ranging from about 90:10 to about 30:70. In some aspects, the protein isolate and the protein hydrolysate are present in the beverage in a weight ratio ranging from about 80:20 to about 40:60. In some aspects, the protein isolate and the protein hydrolysate are present in the beverage in a weight ratio of 90:10, about 80:20, about 70:30, about 60:40, about 50:50, about 40:60, or about 30:70. In some aspects, the protein isolate and the protein hydrolysate are present in the beverage in a weight ratio of about 70:30.

In certain aspects, the beverage comprises from about 1 wt % to about 10 wt % of a mixture of protein isolate and protein hydrolysate, wherein the protein isolate and the protein hydrolysate are present in the beverage in a weight ratio ranging from about 90:10 to about 30:70. In some aspects, the beverage comprises from about 1 wt % to about 6 wt % of a mixture of protein isolate and protein hydrolysate, wherein the protein isolate and the protein hydrolysate are present in the beverage in a weight ratio ranging from about 80:20 to about 40:60. In certain aspects, the beverage comprises about 2 wt % to about 6 wt % of a mixture of protein isolate and protein hydrolysate, wherein the protein isolate and the protein hydrolysate are present in the beverage in a weight ratio ranging from about 70:30.

In certain aspects, the beverage comprises from about 1 wt % to about 10 wt % of a protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof, wherein the protein comprises a mixture of protein isolate and protein hydrolysate that are present in the beverage in a weight ratio ranging from about 90:10 to about 30:70. In some aspects, the beverage comprises from about 1 wt % to about 6 wt % of a protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof, wherein the protein comprises a mixture of protein isolate and protein hydrolysate that are present in the beverage in a weight ratio ranging from about 80:20 to about 40:60. In certain aspects, the beverage comprises about 2 wt % to about 6 wt % of a protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof, wherein the protein comprises a mixture of protein isolate and protein hydrolysate that are present in the beverage in a weight ratio of about 70:30.

In certain aspects, the beverage comprises from about 1 wt % to about 10 wt % of a protein selected from the group consisting of collagen, pea protein, rice protein, whey protein isolate (either non-animal whey protein obtained from fermentation processes known in the art or animal whey protein), and a combination thereof, wherein the protein comprises a mixture of protein isolate and protein hydrolysate that are present in the beverage in a weight ratio ranging from about 90:10 to about 30:70. In some aspects, the beverage comprises from about 1 wt % to about 6 wt % of a protein selected from the group consisting of collagen, pea protein, rice protein, whey protein isolate (either non-animal whey protein obtained from fermentation processes known in the art or animal whey protein), and a combination thereof, wherein the protein comprises a mixture of protein isolate and protein hydrolysate that are present in the beverage in a weight ratio ranging from about 80:20 to about 40:60. In certain aspects, the beverage comprises about 2 wt % to about 6 wt % of a protein selected from the group consisting of collagen, pea protein, rice protein, whey protein isolate, and a combination thereof, wherein the protein comprises a mixture of protein isolate and protein hydrolysate that are present in the beverage in a weight ratio of about 70:30.

In certain aspects, the beverage comprises a nanoemulsion comprising one or more vitamins. In certain aspects, the beverage does not contain vitamins. In some aspects, the one or more vitamins comprise fat soluble vitamins, water soluble vitamins, or a combination thereof. In some aspects, the beverage comprises a nanoemulsion of one or more vitamins. In some aspects, the nanoemulsion comprises medium chain triglycerides (MCT) and one or more surfactants. In some aspects the one or more surfactants comprises polysorbate 20, polysorbate 40, polysorbate 60, polysorbate 80, propylene glycol, or combinations thereof. In some aspects, the nanoemulsion comprises a mixture of MCT, polysorbate 60, and propylene glycol. In some aspects, the one or more vitamins comprise vitamin A, vitamin B1, vitamin B2, vitamin B3, vitamin B5, vitamin B6, vitamin B8, vitamin B9, vitamin B12, vitamin C, vitamin D, vitamin E, vitamin K, or a combination thereof. In some aspects, the one or more vitamins comprise vitamin D, vitamin E, or a combination thereof.

In some aspects, the nanoemulsion has a particle size distribution: D90 of not more than 30 nm. In some aspects, the nanoemulsion has a particle size distribution: D90 of not more than 25 nm. In some aspects, the nanoemulsion has a particle size distribution: D90 of not more than 20 nm. In some aspects, the nanoemulsion has a particle size distribution: D90 of not more than 20 nm, 21 nm, 22 nm, 23 nm, 24 nm, 25 nm, 26 nm, 27 nm, 28 nm, 29 nm, or 30 nm.

In some aspects, the beverage comprises a nanoemulsion comprising MCT, a surfactant selected from the group consisting of polysorbate 20, polysorbate 40, polysorbate 60, polysorbate 80, propylene glycol, and a combination thereof and one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 30 nm. In some aspects, the beverage comprises a nanoemulsion comprising MCT and a surfactant selected from the group consisting of polysorbate 60, propylene glycol, and a combination thereof and one or more vitamins selected from the group consisting of vitamin D, vitamin E, and a combination thereof, wherein the nanoemulsion has a particle size distribution: D90 of not more than 25 nm. In some aspects, the beverage comprises a nanoemulsion comprising a combination of MCT, polysorbate 60, and propylene glycol, and a combination of vitamin D and vitamin E, wherein the nanoemulsion has a particle size distribution: D90 of not more than 20 nm.

In some aspects, the beverage comprises from about 10% to about 200% of the daily value (DV) of the one or more vitamins. The “daily value” of a particular vitamin is the recommended amount of that vitamin that should be consumed each day as determined by the U.S. Food and Drug Administration. In some aspects, the beverage comprises from about 20% DV to about 175% DV of the one or more vitamins. In some aspects, the beverage comprises from about 30% DV to about 150% DV of the one or more vitamins. In some aspects, the beverage comprises from about 40% DV to about 140% DV of the one or more vitamins. In some aspects, the beverage comprises from about 50% DV to about 130% DV of the one or more vitamins. In some aspects, the beverage comprises from about 60% DV to about 120% DV of the one or more vitamins. In some aspects, the beverage comprises from about 70% DV to about 110% DV of the one or more vitamins. In some aspects, the beverage comprises from about 75% DV to about 125% DV of the one or more vitamins. In some aspects, the beverage comprises from about 90% DV to about 110% DV of the one or more vitamins. In some aspects, the beverage comprises about 100% DV of the one or more vitamins.

In some aspects, the beverage comprises a nanoemulsion comprising MCT, a surfactant selected from the group consisting of polysorbate 20, polysorbate 40, polysorbate 60, polysorbate 80, propylene glycol, and a combinations thereof, and from about 10% DV to about 200% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 30 nm. In some aspects, the beverage comprises a nanoemulsion comprising MCT, a surfactant selected from the group consisting of polysorbate 60, propylene glycol, and a combination thereof and from about 60% DV to about 120% DV of one or more vitamins selected from the group consisting of vitamin D, vitamin E, and a combination thereof, wherein the nanoemulsion has a particle size distribution: D90 of not more than 25 nm. In some aspects, the beverage comprises a nanoemulsion comprising a combination of MCT, polysorbate 60, and propylene glycol, and about 100% DV of vitamin D and vitamin E, wherein the nanoemulsion has a particle size distribution: D90 of not more than 20 nm.

In some aspects, the beverage comprises one or more electrolytes. In some aspects, the one or more electrolytes comprise sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, or combinations thereof. In some aspects, the one or more electrolytes comprise sodium chloride, potassium citrate, sodium citrate, or a combination thereof. In some aspects, the one or more electrolytes comprise a combination of sodium chloride, potassium citrate, and sodium citrate.

In certain aspects, the beverage comprises from about 0.05 wt % to about 0.35 wt % of one or more electrolytes. In certain aspects, the beverage comprises from about 0.10 wt % to about 0.30 wt % of one or more electrolytes. In some aspects, the beverage comprises from about 0.15 wt % to about 0.25 wt % of one or more electrolytes. In some aspects, the beverage comprises from about 0.10 wt % to about 0.20 wt % of one or more electrolytes. In some aspects, the beverage comprises about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, or about 0.35 wt % of one or more electrolytes.

In some aspects, the beverage comprise from about 0.05 wt % to about 0.35 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof. In some aspects, the beverage comprises from about 0.10 wt % to about 0.30 wt % of one or more electrolytes selected from the group consisting of sodium chloride, potassium citrate, sodium citrate, and a combination thereof. In some aspects, the beverage comprises from about 0.15 wt % to about 0.25 wt % of one or more electrolytes selected from the group consisting of sodium chloride, potassium citrate, sodium citrate, and a combination thereof. In some aspects, the beverage comprises about 0.1 wt % to about 0.2 wt % of a combination of sodium chloride, potassium citrate, and sodium citrate.

In some aspects, the beverage comprises one or more chelators. In some aspects the one or more chelators comprises citric acid, sodium citrate, potassium citrate, glutamic acid, diacetic acid, methylglycine, N,N-diacetic acid, aulvic acid, gluconic acid, sodium gluconate, glucono-delta-lactone, zinc gluconate, rosmarinic acid, quercetin, L-carnitine, potassium polyaspartate, phytic acid, polyphosphates (such as tetrasodium pyrophosphate, sodium tripolyphosphate, Graham's salt), or a combination thereof. In some aspects, the chelator comprises citric acid.

In some aspects, the beverage comprises from about 0.001 wt % to about 0.30 wt % of one or more chelators. In some aspects, the beverage comprises from about 0.001 wt % to about 0.25 wt % of one or more chelators. In some aspects, the beverage comprises from about 0.002 wt % to about 0.20 wt % of one or more chelators. In some aspects, the beverage comprises from about 0.003 wt % to about 0.15 wt % of one or more chelators. In some aspects, the beverage comprises from about 0.001 wt %, about 0.002 wt %, about 0.003 wt %, about 0.004 wt %, about 0.005 wt %, about 0.006 wt %, about 0.007 wt %, about 0.008 wt %, about 0.009 wt %, about 0.010 wt %, about 0.020 wt %, about 0.03 wt %, about 0.04 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, or about 0.30 wt % of one or more chelators.

In some aspects, the beverage comprises from about 0.5 wt % to about 3 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof. In some aspects, the beverage comprises about 0.75 wt % to about 2 wt % of soluble corn fiber.

In some aspects, the beverage comprises fiber. In some aspects, the fiber in the beverage comprises soluble fiber. In some aspects, the soluble fiber comprises Bacillus coagulans sodium, calcium polycarbophil, fructo-oligosaccharides, inulin, methylcellulose, polydextrose, psyllium husk, soluble corn fiber, oat, barley, fruit pectin, and a combination thereof. In some aspects, the soluble fiber comprises soluble corn fiber.

In some aspects, the beverage comprises from about 0.5 wt % to about 3 wt % of soluble fiber. In some aspects, the beverage comprises from about 0.75 wt % to about 2 wt % of soluble fiber. In some aspects, the beverage comprises about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, or about 3.0 wt % of soluble fiber.

In some aspects, the beverage comprises from about 0.5 wt % to about 3 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof. In some aspects, the beverage comprises about 0.75 wt % to about 2 wt % of soluble corn fiber.

In certain aspects, the beverage can further comprise one or more sweeteners. In some aspects, the one or more sweeteners comprise a nutritive sweetener, a non-nutritive sweetener, or a combination thereof.

Examples of suitable nutritive sweeteners include sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, honey, agave syrup, apple juice, white grape juice, pear juice, tagatose, and glucose syrup. In some aspects, the beverage comprises a nutritive sweetener selected from the group consisting of allulose, fructose, galactose, glucose, high fructose corn syrup lactose, maltose, maltulose, sucrose, and a combination thereof.

Examples of suitable non-nutritive sweeteners include aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof. In some aspects, the beverage comprises a non-nutritive sweetener selected from the group consisting of aspartame, acesulfame potassium, sucralose, erythritol, xylitol, a steviol glycoside, and a combination thereof.

Examples of suitable steviol glycosides include rebaudioside A, rebaudioside B, rebaudioside C (dulcoside B), rebaudioside D, rebaudioside E, rebaudioside F, rebaudioside H, rebaudioside I, rebaudioside J, rebaudioside K, rebaudioside L, rebaudioside M, rebaudioside N, rebaudioside O, rebaudioside R, rebaudioside S, rebaudioside T, rebaudioside U, rebaudioside V, dulcoside A, rubusoside, stevia extract, stevioside, mogroside IV, mogroside V, siamenoside, polypodoside A, pterocaryoside A, pterocaryoside B, mukurozioside, phlomisoside I, periandrin I, abrusoside A, cyclocarioside I, and a combination thereof. In some aspects, the beverage comprises a steviol glycoside selected from the group consisting of stevoside, steviolbioside, rubusoside, dulcoside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside Q, and a combination thereof.

In some aspects, the beverage can comprise one or more nutritive sweeteners in an amount from about 0.25 wt % to about 20 wt %. In some aspects, the beverage can comprise one or more nutritive sweeteners in an amount from about 0.3 wt % to about 15 wt %. In some aspects, the beverage can comprise one or more nutritive sweeteners in an amount from about 0.4 wt % to about 10 wt %. In some aspects, the beverage can comprise one or more nutritive sweeteners in an amount from about 0.4 wt % to about 9 wt %. In some aspects, the beverage can comprise one or more nutritive sweeteners in an amount from about 0.5 wt % to about 8 wt %. In some aspects, the beverage can comprise one or more nutritive sweeteners in an amount from about 1 wt % to about 5 wt %. In some aspects, the beverage can comprise one or more nutritive sweeteners in an amount of about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt % o, about 11 wt %, about 12 wt %, about 13 wt %, about 14 wt %, about 15 wt %, about 16 wt %, about 17 wt %, about 18 wt %, about 19 wt %, or about 20 wt %.

In some aspects, the one or more nutritive sweeteners can be sucrose. In some aspects, the beverage can comprise sucrose in an amount from about 0.25 wt % to about 20 wt %. In some aspects, the beverage can comprise sucrose in an amount from about 0.3 wt % to about 15 wt %. In some aspects, the beverage can comprise sucrose in an amount from about 0.4 wt % to about 10 wt %. In some aspects, the beverage can comprise sucrose in an amount from about 0.4 wt % to about 9 wt %. In some aspects, the beverage can comprise sucrose in an amount from about 0.5 wt % to about 8 wt %. In some aspects, the beverage can comprise sucrose in an amount from about 1 wt % to about 5 wt %. In some aspects, the beverage can comprise sucrose in an amount of about 0.25 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt %.

In some aspects, the beverage can comprise one or more non-nutritive sweeteners sweeteners in a total amount ranging from about 0.1 ppm to about 700 ppm. In some aspects, the beverage can comprise one or more non-nutritive sweeteners in a total amount ranging from about 0.5 ppm to about 600 ppm. In some aspects, the beverage can comprise one or more non-nutritive sweeteners in a total amount ranging from about 1 ppm to about 500 ppm. In some aspects, the beverage can comprise one or more non-nutritive sweeteners in a total amount ranging from about 2 ppm to about 400 ppm. In some aspects, the beverage can comprise one or more non-nutritive sweeteners in a total amount ranging from about 3 ppm to about 300 ppm. In some aspects, the beverage can comprise one or more non-nutritive sweeteners in a total amount ranging from about 0.1 ppm to about 280 ppm. In some aspects, the beverage can comprise one or more non-nutritive sweeteners in a total amount of about 0.1 ppm, about 0.5 ppm, about 1 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, or about 700 ppm.

In some aspects, the beverage can comprise rebaudioside A, rebaudioside B, rebaudioside C, rebaudioside D, rebaudioside M, rebaudioside F, rebaudioside J, or a combination thereof in a total amount ranging from about 0.1 ppm to about 700 ppm. In some aspects, the beverage can comprise rebaudioside A, rebaudioside B, rebaudioside C, rebaudioside D, rebaudioside M, rebaudioside F, rebaudioside J, or a combination thereof in a total amount ranging from about 0.5 ppm to about 600 ppm. In some aspects, the beverage can comprise rebaudioside A, rebaudioside B, rebaudioside C, rebaudioside D, rebaudioside M, rebaudioside F, rebaudioside J, or a combination thereof in a total amount ranging from about 1 ppm to about 500 ppm. In some aspects, the beverage can comprise rebaudioside A, rebaudioside B, rebaudioside C, rebaudioside D, rebaudioside M, rebaudioside F, rebaudioside J, or a combination thereof in a total amount ranging from about 2 ppm to about 400 ppm. In some aspects, the beverage can comprise rebaudioside A, rebaudioside B, rebaudioside C, rebaudioside D, rebaudioside M, rebaudioside F, rebaudioside J, or a combination thereof in a total amount ranging from about 3 ppm to about 300 ppm. In some aspects, the beverage can comprise rebaudioside A, rebaudioside B, rebaudioside C, rebaudioside D, rebaudioside M, rebaudioside F, rebaudioside J, or a combination thereof in a total amount ranging from about 0.1 ppm to about 280 ppm. In some aspects, the beverage can comprise rebaudioside A, rebaudioside B, rebaudioside C, rebaudioside D, rebaudioside M, rebaudioside F, rebaudioside J, or a combination thereof in a total amount of about 0.1 ppm, about 0.5 ppm, about 1 ppm, about 5 ppm, about 10 ppm, about 15 ppm, about 20 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, about 100 ppm, about 125 ppm, about 150 ppm, about 175 ppm, about 200 ppm, about 225 ppm, about 250 ppm, about 275 ppm, about 300 ppm, about 325 ppm, about 350 ppm, about 375 ppm, about 400 ppm, about 425 ppm, about 450 ppm, about 475 ppm, about 500 ppm, about 525 ppm, about 550 ppm, about 575 ppm, about 600 ppm, about 625 ppm, about 650 ppm, about 675 ppm, or about 700 ppm.

In some aspects, the beverage comprises one or more flavoring agents. The one or more flavoring agents can be natural or synthetic. Examples of flavoring agents include, but are not limited to, apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof. In some aspects, flavoring agents further comprise flavor modulating agents, such as bitterness mitigators, astringency mitigators, agents that provide coolness, warmness, or tingling sensation, agents that modulate offtaste, and the like.

In some aspects, the beverage comprises from about 0.01 wt % to about 1.2 wt % of one or more flavoring agents. In some aspects, the beverage comprises from about 0.05 wt % to about 1.1 wt % of one or more flavoring agents. In some aspects, the beverage comprises from about 0.07 wt % to about 1.0 wt % of one or more flavoring agents. In some aspects, the beverage comprises about 0.01 wt %, about 0.05 wt %, about 0.10 wt %, about 0.20 wt %, about 0.30 wt %, about 0.40 wt %, about 0.50 wt %, about 0.60 wt %, about 0.70 wt %, about 0.80 wt %, about 0.90 wt %, about 1.0 wt %, about 1.1 wt %, or about 1.2 wt % of one or more flavoring agents.

In some aspects, the beverage comprises one or more minerals. In some aspects, the one or more minerals, comprise calcium, magnesium, potassium, sodium, iron, or combinations thereof.

In some aspects, the beverage comprises from about 0.1% DV to about 100% DV of one or more minerals. In some aspects, the beverage comprises from about 0.5% DV to about 100% DV of one or more minerals. In some aspects, the beverage comprises from about 1% DV to about 100% DV of one or more minerals. In some aspects, the beverage comprises from about 5% DV to about 100% DV of one or more minerals. In some aspects, the beverage comprises from about 10% DV to about 100% DV of one or more minerals. In some aspects, the beverage comprises from about 20% DV to about 100% DV of one or more minerals. In some aspects, the beverage comprises from about 30% DV to about 100% DV of one or more minerals. In some aspects, the beverage comprises from about 40% DV to about 100% DV of one or more minerals. In some aspects, the beverage comprises from about 50% DV to about 100% DV of one or more minerals.

In some aspects, the beverage does not comprise caffeine. In some aspects, the beverage comprises caffeine. In some aspects, the beverage comprises from about 0.01 wt % to about 0.05 wt % of caffeine. In some aspects, the beverage comprises from about 0.01 wt % to about 0.04 wt % of caffeine. In some aspects, the beverage comprises from about 0.01 wt % to about 0.03 wt % of caffeine. In some aspects, the beverage comprises from about 0.01 wt %, about 0.02 wt %, about 0.03 wt %, about 0.04 wt %, or about 0.05 wt % of caffeine.

In certain aspects, the beverage comprises one or more acids. In some aspects, the one or more acids comprise ascorbic acid, citric acid, lactic acid, malic acid, phosphoric acid, tartaric acid, or combinations thereof. In some aspects, the beverage comprise malic acid, tartaric acid, or a combination thereof. In some aspects, the beverage comprises a combination of malic acid and tartaric acid.

In some aspects the beverage comprises from about 0.01 wt % to about 0.5 wt % of one or more acids. In some aspects, the beverage comprises from about 0.05 wt % to about 0.4 wt % of one or more acids. In some aspects, the beverage comprises from about 0.06 wt % to about 0.3 wt % of one or more acids. In some aspects, the beverage comprises from about 0.07 wt % to about 0.3 wt % of one or more acids. In some aspects, the beverage comprises from about 0.08 wt % to about 0.2 wt % of one or more acids. In some aspects, the beverage comprises about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, or about 0.50 wt % of one or more acids.

In some aspects the beverage comprises from about 0.01 wt % to about 0.5 wt % of one or more acids selected from the group consisting of malic acid, tartaric acid, and a combination thereof. In some aspects, the beverage comprises from about 0.05 wt % to about 0.4 wt % of one or more acids selected from the group consisting of malic acid, tartaric acid, and a combination thereof. In some aspects, the beverage comprises from about 0.06 wt % to about 0.3 wt % of one or more acids selected from the group consisting of malic acid, tartaric acid, and a combination thereof. In some aspects, the beverage comprises from about 0.07 wt % to about 0.3 wt % of one or more acids selected from the group consisting of malic acid, tartaric acid, and a combination thereof. In some aspects, the beverage comprises from about 0.08 wt % to about 0.2 wt % of one or more acids selected from the group consisting of malic acid, tartaric acid, and a combination thereof. In some aspects, the beverage comprises about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, about 0.21 wt %, about 0.22 wt %, about 0.23 wt %, about 0.24 wt %, about 0.25 wt %, about 0.26 wt %, about 0.27 wt %, about 0.28 wt %, about 0.29 wt %, about 0.30 wt %, about 0.31 wt %, about 0.32 wt %, about 0.33 wt %, about 0.34 wt %, about 0.35 wt %, about 0.36 wt %, about 0.37 wt %, about 0.38 wt %, about 0.39 wt %, about 0.40 wt %, about 0.41 wt %, about 0.42 wt %, about 0.43 wt %, about 0.44 wt %, about 0.45 wt %, about 0.46 wt %, about 0.47 wt %, about 0.48 wt %, about 0.49 wt %, or about 0.50 wt % of a malic acid, tartaric acid, or a combination thereof.

In aspects where the beverage comprises one or more acids, the beverage can have a pH of about 3 to about 3.5. In some aspects, the beverage can have a pH of about 3, about 3.1, about 3.2, about 3.3, about 3.4, or about 3.5.

In aspects where the beverage does not comprise one or more acids, the beverage can have a pH of about 6.5 to about 7.5. In some aspects, the beverage can have a pH of about 6.5, about 6.6, about 6.7, about 6.8, about 6.9, about 7.0, about 7.1, about 7.2, about 7.3, about 7.4, or about 7.5.

Typically the beverages are clear. In some aspects, where the protein and/or other components provide color to the beverage, the beverages described herein can further comprise one or more coloring agents to remove the color provided by the protein and/or other component. In some aspects the coloring agent is derived from a natural source. In some aspects, the coloring agent is derived from anthocyanin, a betanin, carmine, a carotenoid, chlorophyll, cochineal, curcumin, a cyclohexene dione dimer, a phycocyanin, or an agent derived from the reaction of an iridoid and an amino acid.

Anthocyanins are a class of compounds that provide pigmentation and are derived from natural sources. Anthocyanins found in black currants (Ribes nigrum) that provide pigmentation include 3-diglucoside and 3-rutinoside of cyanidin and delphinidin. Similarly, blueberries (Vaccinium augustifolium or Vaccinium corymbosum) typically contain the following anthocyanins that provide pigmentation: 3-glucosides, 3-galactosides, and 3-arabinosides of cyanidin, delphinidin, peonidin, petunidin, and malvidin. Exemplary anthocyanidins have structures as described below:

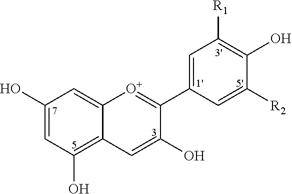

pelargonidin (R₁, R₂═H), cyanidin (R₁═OH, R₂═H), delphinidin (R₁, R₂═OH), peonidin (R₁═OCH₃, R₂═H), petunidin (R₁═OCH₃, R₂═OH), and malvidin (R₁, R₂═OCH₃).

A blue coloring agent that is derived from natural sources is gardenia blue, which may be formed by the reaction of an iridoid and an amino acid. For example, hydrolysis of the iridoid glycoside geniposide with beta-glucosidase, as indicated below, produces the iridoid genipin. Amino acids, such as glycine, lysine or phenylalanine, will react with the colorless genipin and form blue pigments:

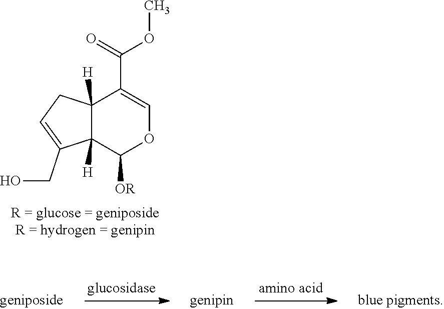

Phycocyanin is a blue protein complex found in Spirulina (blue green algae). Phycocyanins are proteins containing the covalently bound chromophore phycocyanobilin having the structure shown below:

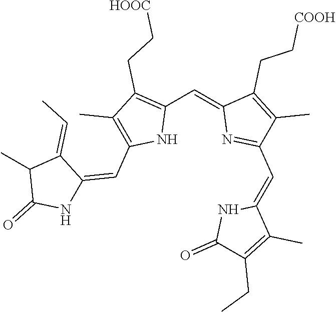

Further examples of colors derived from natural sources are carthamus yellow and carthamus red. Carthamus yellow and carthamus red may be derived from safflower (Carthamus tinctorius), and include cyclohexene dione dimers, which are classified as chalcone compounds. The chemical structure of carthamus yellow, or carthamin, is provided below:

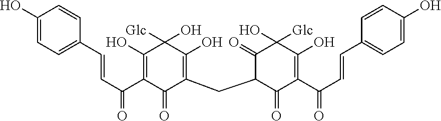

Beta-carotene and lycopene are carotenoids and are oil soluble pigments found in fruits, vegetables, etc. having the structures shown below:

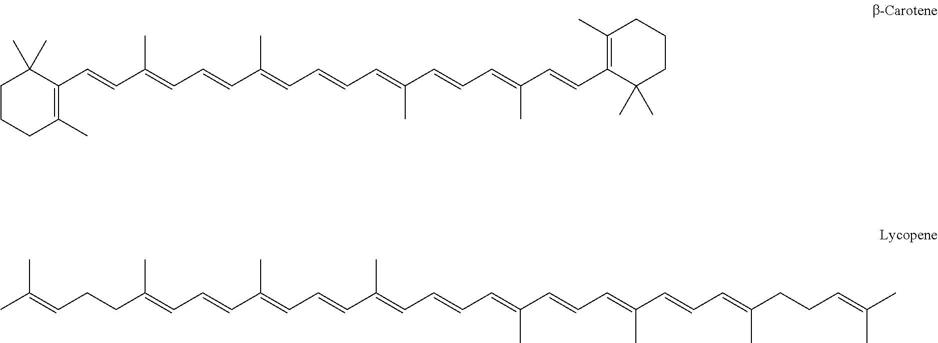

All of the aforementioned coloring agents can be purchased from well-known color manufacturing suppliers.

In some aspects, the one or more coloring agents can be present in the beverage in an amount of from about 0.05 ppm to about 100 ppm. In some aspects, the one or more coloring agents can be present in the beverage in an amount of from about 0.10 ppm to about 95 ppm. In some aspects, the one or more coloring agents can be present in the beverage in an amount of from about 0.20 ppm to about 90 ppm. In some aspects, the one or more coloring agents can be present in the beverage in an amount of from about 0.3 ppm to about 85 ppm. In some aspects, the one or more coloring agents can be present in the beverage in an amount of from about 0.40 ppm to about 80 ppm. In some aspects, the one or more coloring agents can be present in the beverage in an amount of from about 0.50 ppm to about 75 ppm. In some aspects, the one or more coloring agents can be present in the beverage in an amount of from about 0.60 ppm to about 70 ppm. In some aspects, the one or more coloring agents can be present in the beverage in an amount of from about 0.70 ppm to about 65 ppm. In some aspects, the one or more coloring agents can be present in the beverage in an amount of from about 0.8 ppm to about 60 ppm. In some aspects, the one or more coloring agents can be present in the beverage in an amount of from about 0.90 ppm to about 55 ppm. In some aspects, the one or more coloring agents can be present in the beverage in an amount of from about 1 ppm to about 50 ppm. In some aspects, the one or more coloring agents can be present in the beverage in an amount of from about 0.1.1 ppm to about 45 ppm. In some aspects, the one or more coloring agents can be present in the beverage in an amount of from about 1.10 ppm to about 40 ppm. In some aspects, the one or more coloring agents can be present in the beverage in an amount of from about 1.20 ppm to about 35 ppm. In some aspects, the one or more coloring agents can be present in the beverage in an amount of from about 1.30 ppm to about 30 ppm. In some aspects, the one or more coloring agents can be present in the beverage in an amount of from about 1.40 ppm to about 25 ppm. In some aspects, the one or more coloring agents can be present in the beverage in an amount of from about 1.50 ppm to about 20 ppm. In some aspects, the one or more coloring agents can be present in the beverage in an amount of from about 1.60 ppm to about 15 ppm. In some aspects, the one or more coloring agents can be present in the beverage in an amount of from about 1.70 ppm to about 10 ppm. In some aspects, the one or more coloring agents can be present in the beverage in an amount of from about 1.80 ppm to about 9 ppm. In some aspects, the one or more coloring agents can be present in the beverage in an amount of from about 1.90 ppm to about 8 ppm. In some aspects, the one or more coloring agents can be present in the beverage in an amount of from about 2.0 ppm to about 7 ppm. In some aspects, the one or more coloring agents can be present in the beverage in an amount of from about 0.05 ppm, about 0.10 ppm, about 0.20 ppm, about 0.30 ppm, about 0.4 ppm, about 0.5 ppm, about 0.6 ppm, about 0.7 ppm, about 0.8 ppm, about 0.9 ppm, about 1.0 ppm, about 1.1 ppm, about 1.2 ppm, about 1.3 ppm, about 1.4 ppm, about 1.5 ppm, about 1.6 ppm, about 1.7 ppm, about 1.8 ppm, about 1.9 ppm, about 2.0 ppm, about 2.1 ppm, about 2.2 ppm, about 2.3 ppm, about 2.4 ppm, about 2.5 ppm, about 2.6 pm, about 2.7 ppm, about 2.8 ppm about 2.9 ppm, about 3.0 ppm, about 3.1 ppm, about 3.2 ppm, about 3.3 ppm, about 3.4 ppm, about 3.5 ppm, about 3.6 ppm, about 3.7 ppm, about 3.8 ppm, about 3.9 ppm, about 4.0 ppm, about 4.1 ppm, about 4.2 ppm, about 4.3 ppm, about 4.4 ppm, about 4.5 ppm, about 4.6 ppm, about 4.7 ppm, about 4.8 ppm, about 4.9 ppm, about 5.0 ppm, about 5.5 ppm, about 6.0 ppm, about 6.5 ppm, about 7.0 ppm, about 7.5 ppm, about 8.0 ppm, about 9.0 ppm, about 9.5 ppm, about 10.0 ppm, about 11 ppm, about 12 ppm, about 13 ppm, about 14 ppm, about 15 ppm, about 16 ppm, about 17 ppm, about 18 ppm, about 19 ppm, about 20 ppm, about 21 ppm, about 22 ppm, about 23 ppm, about 24 ppm, about 25 ppm, about 30 ppm, about 35 ppm, about 40 ppm, about 45 ppm, about 50 ppm, about 55 ppm, about 60 ppm, about 65 ppm, about 70 ppm, about 75 ppm, about 80 ppm, about 85 ppm, about 90 ppm, about 95 ppm, or about 100 pm.

In some aspects, the present disclosure provides a beverage comprising from about 1 wt % to about 10 wt % of protein; a nanoemulsion comprising MCT and one or more surfactants having a particle size distribution: D90 of not more than 30 nm and comprising from about 10% DV to about 200% DV of one or more vitamins; from about 0.05 wt % to about 0.35 wt % of one or more electrolytes; and from about 0.5 wt % to about 3 wt % of soluble fiber; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein comprising protein isolate and protein hydrolysate, wherein the protein isolate and the protein hydrolysate are in a weight ratio of from about 90:10 to about 30:70, and wherein the protein isolate comprises one or more of: a) no more than 1.3 wt % potassium; b) no more than 0.50 wt % calcium, or c) no more than 0.60 wt % sodium; a nanoemulsion comprising MCT and one or more surfactants having a particle size distribution: D90 of not more than 30 nm and comprising from about 10% DV to about 200% DV of one or more vitamins; from about 0.05 wt % to about 0.35 wt % of one or more electrolytes; from about 0.5 wt % to about 3 wt % of soluble fiber; and one or more of the following: (a) from about 0.25 wt % to about 20 wt % of a nutritive sweetener; (b) from about 0.1 ppm to about 700 ppm of a non-nutritive sweetener; (c) from about 0.01 wt % to about 1.2 wt % of a flavoring agent; (d) from about 0.1% DV to about 100% DV of one or more minerals; (e) from about 0.5 ppm to about 100 ppm of one or more coloring agents; (f) from about 0.01 wt % to about 0.05 wt % of caffeine; and (g) from about 0.01 wt % to about 0.5 wt % of one or more acids; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein selected from the group consisting of collagen, whey protein (either animal whey protein or non-animal whey protein obtained from fermentation processes known in the art), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; a nanoemulsion comprising an oil phase comprising MCT, from about 10 wt % to about 40 wt % of propylene glycol, from about 40 wt % to about 80 wt % of one or more additional surfactants selected from the group consisting of polysorbate 20, polysorbate 40, polysorbate 60, polysorbate 80, and a combination thereof, and from about 10% DV to about 200% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 30 nm; from about 0.05 wt % to about 0.35 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, and from about 0.5 wt % to about 3 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof comprising protein isolate and protein hydrolysate, wherein the protein isolate and the protein hydrolysate are in a weight ratio of from about 90:10 to about 30:70; a nanoemulsion comprising an oil phase comprising MCT, from about 10 wt % to about 40 wt % of propylene glycol, from about 40 wt % to about 80 wt % of one or more additional surfactants selected from the group consisting of polysorbate 20, polysorbate 40, polysorbate 60, polysorbate 80, and a combination thereof, and from about 10% DV to about 200% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 30 nm; from about 0.05 wt % to about 0.35 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof; from about 0.5 wt % to about 3 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and one or more of the following: (a) from about 0.25 wt % to about 20 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, honey, agave syrup, apple juice, white grape juice, pear juice, tagatose, and glucose syrup; (b) from about 0.1 ppm to about 700 ppm of a non-nutritive sweetener selected from the group consisting of aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof; (c) from about 0.1 wt % to about 1.2 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 0.1% DV to about 100% DV of one or more minerals selected from the group consisting of calcium, magnesium, potassium, sodium, iron, and a combination thereof, (e) from about 0.05 ppm to about 100 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.05 wt % of caffeine; and (g) from about 0.01 wt % to about 0.5 wt % of one or more acids selected from the group consisting of ascorbic acid, citric acid, lactic acid, malic acid, phosphoric acid, tartaric acid, and a combination thereof; wherein the beverage has a turbidity of less than 100 NTUs and/or an absorbance of less than 0.1 at 600 nm wavelength.

In some aspects, the present disclosure provides a beverage comprising from about 1 wt % to about 6 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; a nanoemulsion comprising an oil phase comprising MCT, from about 20 wt % to about 30 wt % of propylene glycol, from about 50 wt % to about 70 wt % of one or more additional surfactants selected from the group consisting of polysorbate 20, polysorbate 40, polysorbate 60, polysorbate 80, and a combination thereof, and from about 60% DV to about 120% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 25 nm; from about 0.10 wt % to about 0.30 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, and from about 0.75 wt % to about 2.0 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; wherein the beverage has a turbidity of less than 98 NTUs and/or an absorbance of less than 0.1 at 600 nm wavelength.

In some aspects, the present disclosure provides a beverage comprising from about 1 wt % to about 6 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof comprising protein isolate and protein hydrolysate, wherein the protein isolate and the protein hydrolysate are in a weight ratio of from about 80:20 to about 40:60; a nanoemulsion comprising an oil phase comprising MCT, from about 20 wt % to about 30 wt % of propylene glycol, from about 50 wt % to about 70 wt % of one or more additional surfactants selected from the group consisting of polysorbate 20, polysorbate 40, polysorbate 60, polysorbate 80, and a combination thereof, and from about 60% DV to about 120% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 25 nm; from about 0.10 wt % to about 0.30 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 0.75 wt % to about 2.0 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and one or more of the following: (a) from about 0.5 wt % to about 8 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, honey, agave syrup, apple juice, white grape juice, pear juice, tagatose, and glucose syrup; (b) from about 3 ppm to about 300 ppm of a non-nutritive sweetener selected from the group consisting of aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof; (c) from about 0.05 wt % to about 1.1 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 30% DV to about 100% DV of one or more minerals selected from the group consisting of calcium, magnesium, potassium, sodium, iron, and a combination thereof, (e) from about 0.8 ppm to about 60 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.04 wt % of caffeine; and (g) from about 0.07 wt % to about 0.3 wt % of one or more acids selected from the group consisting of ascorbic acid, citric acid, lactic acid, malic acid, phosphoric acid, tartaric acid, and a combination thereof; wherein the beverage has a turbidity of less than 98 NTUs and/or an absorbance of less than 0.1 at 600 nm wavelength.

In some aspects, the present disclosure provides a beverage comprising from about 1 wt % to about 5 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; a nanoemulsion comprising an oil phase comprising MCT, from about 22 wt % to about 28 wt % of propylene glycol, from about 55 wt % to about 65 wt % of one or more additional surfactants selected from the group consisting of polysorbate 20, polysorbate 40, polysorbate 60, polysorbate 80, and a combination thereof, and from about 90% DV to about 110% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 20 nm; about 0.1 wt % to about 0.2 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, and from about 0.75 wt % to about 2.0 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; wherein the beverage has a turbidity of less than 96 NTUs and/or an absorbance of less than 0.1 at 600 nm wavelength.

In some aspects, the present disclosure provides a beverage comprising from about 1 wt % to about 5 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof comprising protein isolate and protein hydrolysate, wherein the protein isolate and the protein hydrolysate are in a weight ratio of about 70:30; and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 22 wt % to about 28 wt % of propylene glycol, from about 55 wt % to about 65 wt % of one or more additional surfactants selected from the group consisting of polysorbate 20, polysorbate 40, polysorbate 60, polysorbate 80, and a combination thereof, and from about 90% DV to about 110% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 20 nm; about 0.1 wt % to about 0.2 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 0.75 wt % to about 2.0 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; and one or more of the following: (a) from about 1 wt % to about 5 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, honey, agave syrup, apple juice, white grape juice, pear juice, tagatose, and glucose syrup; (b) from about 3 ppm to 300 ppm of a non-nutritive sweetener selected from the group consisting of aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof, (c) from about 0.07 wt % to about 1.0 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 50% DV to about 100% DV of one or more minerals selected from the group consisting of magnesium, potassium, sodium, iron, and a combination thereof, (e) from about 2 ppm to about 7 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.02 wt % of caffeine; and (g) from about 0.08 wt % to about 0.2 wt % of one or more acids selected from the group consisting of ascorbic acid, citric acid, lactic acid, malic acid, phosphoric acid, tartaric acid, and a combination thereof; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein selected from the group consisting of collagen, pea protein, rice protein, whey protein isolate (either non-animal whey protein obtained from fermentation processes known in the art or animal whey protein), and a combination thereof, a nanoemulsion comprising an oil phase comprising MCT, from about 10 wt % to about 40 wt % of propylene glycol, from about 40 wt % to about 80 wt % of polysorbate 60, and from about 10% DV to about 200% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 30 nm; from about 0.05 wt % to about 0.35 wt % of one or more electrolytes selected from the group consisting of sodium chloride, potassium citrate, sodium citrate, and a combination thereof; and from about 0.5 wt % to about 3 wt % of a soluble fiber selected from the group consisting of soluble corn fiber; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein selected from the group consisting of collagen, pea protein, rice protein, whey protein isolate (either non-animal whey protein obtained from fermentation processes known in the art or animal whey protein), and a combination thereof comprising protein isolate and protein hydrolysate, wherein the protein isolate and the protein hydrolysate are in a weight ratio of from about 90:10 to about 30:70; and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 10 wt % to about 40 wt % of propylene glycol, from about 40 wt % to about 80 wt % of polysorbate 60, and from about 10% DV to about 200% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 30 nm; from about 0.05 wt % to about 0.35 wt % of one or more electrolytes selected from the group consisting of sodium chloride, potassium citrate, sodium citrate, and a combination thereof; from about 0.5 wt % to about 3 wt % of soluble corn fiber; and one or more of the following: (a) from about 0.25 wt % to about 20 wt % of a nutritive sweetener selected from the group consisting of allulose, fructose, galactose, glucose, high fructose corn syrup, lactose, maltose, maltulose, sucrose, and a combination thereof, (b) from about 0.1 ppm to about 700 ppm of a non-nutritive sweetener selected from the group consisting of aspartame, acesulfame potassium, sucralose, erythritol, monk fruit, xylitol, a steviol glycoside, and a combination thereof; (c) from about 0.01 wt % to about 1.2 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 0.1% DV to about 100% DV of one or more minerals selected from the group consisting of calcium, magnesium, potassium, sodium, iron, and a combination thereof, (e) from about 0.05 ppm to about 100 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.05 wt % of caffeine; and (g) from about 0.01 wt % to about 0.5 wt % of one or more acids selected from the group consisting of malic acid, tartaric acid, and a combination thereof, wherein the beverage has a turbidity of less than 100 NTUs and/or an absorbance of less than 0.1 at 600 nm wavelength.

In some aspects, the present disclosure provides a beverage comprising from about 1 wt % to about 6 wt % of protein selected from the group consisting of collagen, pea protein, rice protein, whey protein isolate (either non-animal whey protein obtained from fermentation processes known in the art or animal whey protein), and a combination thereof, a nanoemulsion comprising from about 60% DV to about 120% DV of one or more vitamins selected from the group consisting of fat soluble vitamins, water soluble vitamins, and a combination thereof, wherein the nanoemulsion has a particle size distribution: D90 of not more than 25 nm; from about 0.10 wt % to about 0.30 wt % of one or more electrolytes selected from the group consisting of sodium chloride, potassium citrate, sodium citrate, and a combination thereof, and from about 0.75 wt % to about 2.0 wt % of soluble corn fiber; wherein the beverage has a turbidity of less than 98 NTUs and/or an absorbance of less than 0.1 at 600 nm wavelength.

In some aspects, the present disclosure provides a beverage comprising from about 1 wt % to about 6 wt % of protein selected from the group consisting of collagen, pea protein, rice protein, whey protein isolate (either non-animal whey protein obtained from fermentation processes known in the art or animal whey protein), and a combination thereof comprising protein isolate and protein hydrolysate, wherein the protein isolate and the protein hydrolysate are in a weight ratio of from about 80:20 to about 40:60; and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 20 wt % to about 30 wt % of propylene glycol, from about 50 wt % to about 70 wt % of polysorbate 60, and from about 90% DV to about 110% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 25 nm; from about 0.10 wt % to about 0.30 wt % of one or more electrolytes selected from the group consisting of sodium chloride, potassium citrate, sodium citrate, and a combination thereof, from about 0.75 wt % to about 2.0 wt % of soluble corn fiber; and one or more of the following: (a) from about 0.5 wt % to about 8 wt % of a nutritive sweetener selected from the group consisting of allulose, fructose, galactose, glucose, high fructose corn syrup lactose, maltose, maltulose, sucrose, and a combination thereof, (b) from about 3 ppm to about 300 ppm of a non-nutritive sweetener selected from the group consisting of aspartame, acesulfame potassium, sucralose, erythritol, monk fruit, xylitol, a steviol glycoside, and a combination thereof: (c) from about 0.05 wt % to about 1.1 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 30% DV to about 100% DV of one or more minerals selected from the group consisting of calcium, magnesium, potassium, sodium, iron, and a combination thereof, (e) from about 0.8 ppm to about 60 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.04 wt % of caffeine; and (g) from about 0.08 wt % to about 0.2 wt % of one or more acids selected from the group consisting of malic acid, tartaric acid, and a combination thereof, wherein the beverage has a turbidity of less than 98 NTUs and/or an absorbance of less than 0.1 at 600 nm wavelength.

In some aspects, the present disclosure provides a beverage comprising from about 1 wt % to about 5 wt % of protein selected from the group consisting of collagen, pea protein, rice protein, whey protein isolate (either non-animal whey protein obtained from fermentation processes known in the art or animal whey protein), and a combination thereof, a nanoemulsion comprising an oil phase comprising MCT, from about 22 wt % to about 28 wt % of propylene glycol, from about 55 wt % to about 65 wt % of polysorbate 60, and from about 90% DV to about 110% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 20 nm; about 0.1 wt % to about 0.2 wt % of one or more electrolytes selected from the group consisting of sodium chloride, potassium citrate, sodium citrate, and a combination thereof, and from about 0.75 wt % to about 2.0 wt % of soluble corn fiber wherein the beverage has a turbidity of less than 96 NTUs and/or an absorbance of less than 0.1 at 600 nm wavelength.

In some aspects, the present disclosure provides a beverage comprising from about 1 wt % to about 5 wt % of protein selected from the group consisting of collagen, pea protein, rice protein, whey protein isolate (either non-animal whey protein obtained from fermentation processes known in the art or animal whey protein), and a combination thereof comprising protein isolate and protein hydrolysate, wherein the protein isolate and the protein hydrolysate are in a weight ratio of about 70:30; and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 22 wt % to about 28 wt % of propylene glycol, from about 55 wt % to about 65 wt % of polysorbate 60, and from about 90% DV to about 110% DV of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, wherein the nanoemulsion has a particle size distribution: D90 of not more than 20 nm; about 0.1 wt % toa bout 0.2 wt % of one or more electrolytes selected from the group consisting of sodium chloride, potassium citrate, sodium citrate, and a combination thereof; from about 0.75% to about 2.0 wt % of soluble corn fiber; and one or more of the following: (a) from about 1 wt % to about 5 wt % of a nutritive sweetener selected from the group consisting of allulose, fructose, galactose, glucose, high fructose corn syrup lactose, maltose, maltulose, sucrose, and a combination thereof; (b) from about 3 ppm to about 300 ppm of a non-nutritive sweetener selected from the group consisting of aspartame, acesulfame potassium, sucralose, erythritol, monk fruit, xylitol, a steviol glycoside, and a combination thereof, (c) from about 0.07 wt % to about 1.0 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 50% DV to about 100% DV of one or more minerals selected from the group consisting of calcium, magnesium, potassium, sodium, iron, and a combination thereof, (e) from about 2 ppm to about 7 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.02 wt % of caffeine; and (g) from about 0.08 wt % to about 0.2 wt % of one or more acids selected from the group consisting of malic acid, tartaric acid, and a combination thereof, wherein the beverage has a turbidity of less than 96 NTUs and/or an absorbance of less than 0.1 at 600 nm wavelength.

In some aspects, the present disclosure provides a beverage comprising from about 1 wt % to about 10 wt % of whey protein isolate (either animal whey protein or non-animal whey protein obtained from fermentation processes known in the art); a nanoemulsion comprising an oil phase comprising MCT, from about 10 wt % to about 40 wt % of propylene glycol, from about 40 wt % to about 80 wt % of polysorbate 60, and from about 10% DV to about 200% DV of vitamin D, vitamin E, or a combination thereof, wherein the nanoemulsion has a particle size distribution: D90 of not more than 30 nm; from about 0.05 wt % to about 0.35 wt % of a combination of sodium chloride, potassium citrate, and sodium citrate; and from about 0.5 wt % to about 3 wt % of a soluble corn fiber; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of a mixture of whey protein isolate and whey protein hydrolysate (either non-animal whey protein obtained from fermentation processes known in the art or animal whey protein), wherein the protein isolate and the protein hydrolysate are in a weight ratio of from about 90:10 to about 30:70 and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 10 wt % to about 40 wt % of propylene glycol, from about 40 wt % to about 80 wt % of polysorbate 60, and from about 10% DV to about 200% DV of vitamin D, vitamin E, or a combination thereof, wherein the nanoemulsion has a particle size distribution: D90 of not more than 30 nm; from about 0.05 wt % to about 0.35 wt % of a mixture of sodium chloride, potassium citrate, and; from about 0.5 wt % to about 3 wt % of soluble corn fiber; and one or more of the following: (a) from about 0.25 wt % to about 20 wt % of sucrose; (b) from about 0.1 ppm to about 700 ppm of a non-nutritive sweetener selected from the group consisting of aspartame, acesulfame potassium, sucralose, erythritol, monk fruit, xylitol, a steviol glycoside, and a combination thereof; (c) from about 0.01 wt % to about 1.2 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1% DV to about 100% DV of one or more minerals selected from the group consisting of calcium, magnesium, potassium, sodium, iron, and a combination thereof, (e) from about 0.5 ppm to about 100 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.05 wt % of caffeine; and (g) from about 0.01 wt % to about 0.5 wt % of one or more acids selected from the group consisting of malic acid, tartaric acid, and a combination thereof, wherein the beverage has a turbidity of less than 100 NTUs and/or an absorbance of less than 0.1 at 600 nm wavelength.

In some aspects, the present disclosure provides a beverage comprising from about 1 wt % to about 6 wt % of a mixture of whey protein isolate and whey protein hydrolysate (either non-animal whey protein obtained from fermentation processes known in the art or animal whey protein), wherein the protein isolate and the protein hydrolysate are in a weight ratio of from about 80:20 to about 40:60; and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 20 wt % to about 30 wt % of propylene glycol, from about 50 wt % to about 70 wt % of polysorbate 60, and from about 60% DV to about 120% DV of vitamin D, vitamin E, or a combination thereof, wherein the nanoemulsion has a particle size distribution: D90 of not more than 25 nm; from about 0.10 wt % to about 0.30 wt % of a combination of sodium chloride, potassium citrate, and sodium citrate; and from about 0.75 wt % to about 2.0 wt % of soluble corn fiber; wherein the beverage has a turbidity of less than 98 NTUs and/or an absorbance of less than 0.1 at 600 nm wavelength.

In some aspects, the present disclosure provides a beverage comprising from about 1 wt % to about 6 wt % of whey protein isolate and whey protein hydrolysate (either non-animal whey protein obtained from fermentation processes known in the art or animal whey protein), wherein the protein isolate and the protein hydrolysate are in a weight ratio of from about 80:20 to about 40:60; and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 20 wt % to about 30 wt % of propylene glycol, from about 50 wt % to about 70 wt % of polysorbate 60, and from about 60% DV to about 120% DV of vitamin D, vitamin E, or a combination thereof, wherein the nanoemulsion has a particle size distribution: D90 of not more than 25 nm; from about 0.10 wt % to about 0.30 wt % of a combination of sodium chloride, potassium citrate, and sodium citrate; from about 0.75 wt % to about 2.0 wt % of soluble corn fiber; and one or more of the following: (a) from about 0.5 wt % to about 8 wt % of sucrose; (b) from about 3 ppm to about 300 ppm of a non-nutritive sweetener selected from the group consisting of aspartame, acesulfame potassium, sucralose, erythritol, monk fruit, xylitol, a steviol glycoside, and a combination thereof, (c) from about 0.05 wt % to about 1.1 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 30% DV to about 100% DV wt % of one or more minerals selected from the group consisting of calcium, magnesium, potassium, sodium, iron, and a combination thereof, (e) from about 0.8 ppm to about 60 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.04 wt % of caffeine; and (g) from about 0.07 wt % to about 0.3 wt % of one or more acids selected from the group consisting of malic acid, tartaric acid, and a combination thereof wherein the beverage has a turbidity of less than 98 NTUs and/or an absorbance of less than 0.1 at 600 nm wavelength.

In some aspects, the present disclosure provides a beverage comprising from about 1 wt % to about 5 wt % of whey protein isolate (either non-animal whey protein obtained from fermentation processes known in the art or animal whey protein), wherein the protein isolate and the protein hydrolysate are in a weight ratio of about 70:30; and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 22 wt % to about 28 wt % of propylene glycol, from about 55 wt % to about 65 wt % of polysorbate 60, and from about 90% DV to about 110% DV of vitamin D, vitamin E, or a combination thereof, wherein the nanoemulsion has a particle size distribution: D90 of not more than 20 nm; about 0.1 wt % to about 0.2 wt % wt % of a combination of sodium chloride, potassium citrate, and sodium citrate; and from about 0.75 wt % to about 2.0 wt % of soluble corn fiber; wherein the beverage has a turbidity of less than 96 NTUs and/or an absorbance of less than 0.1 at 600 nm wavelength.

In some aspects, the present disclosure provides a beverage comprising from about 1 wt % to about 5 wt % of whey protein isolate and whey protein hydrolysate (either non-animal whey protein obtained from fermentation processes known in the art or animal whey protein), wherein the protein isolate and the protein hydrolysate are in a weight ratio of about 70:30; and wherein the protein isolate comprises one or more of: a) no more than 1.3 wt % potassium; b) no more than 0.50 wt % calcium, or c) no more than 0.60 wt % sodium; a nanoemulsion comprising an oil phase comprising MCT, from about 22 wt % to about 28 wt % of propylene glycol, from about 55 wt % to about 65 wt % of polysorbate 60, and from about 90% DV to about 110% DV of vitamin D, vitamin E, or a combination thereof, wherein the nanoemulsion has a particle size distribution: D90 of not more than 20 nm; about 0.1 wt % to about 0.2 wt % of a combination of sodium chloride, potassium citrate, and sodium citrate; from about 0.75% to about 2.0 wt % of corn fiber; and one or more of the following: (a) from about 1 wt % to about 5 wt % of sucrose; (b) from about 3 ppm to about 300 ppm of a non-nutritive sweetener selected from the group consisting of aspartame, acesulfame potassium, sucralose, erythritol, monk fruit, xylitol, a steviol glycoside, and a combination thereof, (c) from about 0.07 wt % to about 1.0 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 50% DV to about 100% DV of one or more minerals selected from the group consisting of calcium, magnesium, potassium, sodium, iron, and a combination thereof, (e) from about 2 ppm to about 7 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.02 wt % of caffeine; and (g) from about 0.08 wt % to about 0.2 wt % of one or more acids selected from the group consisting of malic acid, tartaric acid, and a combination thereof, wherein the beverage has a turbidity of less than 96 NTUs and/or an absorbance of less than 0.1 at 600 nm wavelength.

In some aspects, the present disclosure provides a beverage comprising from about 1 wt % to about 10 wt % of protein comprising protein isolate and protein hydrolysate, wherein the protein isolate and the protein hydrolysate are in a weight ratio of from about 90:10 to about 30:70, and wherein the protein isolate comprises one or more of: a) no more than 1.3 wt % potassium; b) no more than 0.50 wt % calcium, or c) no more than 0.60 wt % sodium; a nanoemulsion comprising MCT and one or more surfactants having a particle size distribution: D90 of not more than 30 nm and comprising from about 10% DV to about 200% DV of one or more vitamins; from about 0.05 wt % to about 0.35 wt % of one or more electrolytes; from about 0.5 wt % to about 3 wt % of soluble fiber; and one or more of the following: (a) from about 0.25 wt % to about 20 wt % of a nutritive sweetener; (b) from about 0.1 ppm to about 700 ppm of a non-nutritive sweetener; (c) from about 0.01 wt % to about 1.2 wt % of a flavoring agent; (d) from about 0.1% DV to about 100% DV of one or more minerals; (e) from about 0.5 ppm to about 100 ppm of one or more coloring agents; (f) from about 0.01 wt % to about 0.05 wt % of caffeine; and (g) from about 0.01 wt % to about 0.5 wt % of one or more acids; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; from about 0.05 wt % to about 0.35 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof; and from about 0.5 wt % to about 3 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof comprising protein isolate and protein hydrolysate, wherein the protein isolate and the protein hydrolysate are in a weight ratio of from about 90:10 to about 30:70; from about 0.05 wt % to about 0.35 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 0.5 wt % to about 3 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and one or more of the following: (a) from about 0.25 wt % to about 20 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, honey, agave syrup, apple juice, white grape juice, pear juice, tagatose, and glucose syrup; (b) from about 0.1 ppm to about 700 ppm of a non-nutritive sweetener selected from the group consisting of aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof, (c) from about 0.1 wt % to about 1.2 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1% DV to about 100% DV of one or more minerals selected from the group consisting calcium, magnesium, potassium, sodium, iron, and a combination thereof, (e) from about 0.05 ppm to about 100 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.05 wt % of caffeine; and (g) from about 0.01 wt % to about 0.5 wt % of one or more acids selected from the group consisting of ascorbic acid, citric acid, lactic acid, malic acid, phosphoric acid, tartaric acid, and a combination thereof; wherein the beverage has a turbidity of less than 100 NTUs and/or an absorbance of less than 0.1 at 600 nm wavelength.

In some aspects, the present disclosure provides a beverage comprising from about 1 wt % to about 6 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; from about 0.10 wt % to about 0.30 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, and from about 0.75 wt % to about 2.0 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; wherein the beverage has a turbidity of less than 98 NTUs and/or an absorbance of less than 0.1 at 600 nm wavelength.

In some aspects, the present disclosure provides a beverage comprising from about 1 wt % to about 6 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof comprising protein isolate and protein hydrolysate, wherein the protein isolate and the protein hydrolysate are in a weight ratio of from about 80:20 to about 40:60; from about 0.10 wt % to about 0.30 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 0.75 wt % to about 2.0 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and one or more of the following: (a) from about 0.5 wt % to about 8 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, honey, agave syrup, apple juice, white grape juice, pear juice, tagatose, and glucose syrup; (b) from about 3 ppm to about 300 ppm of a non-nutritive sweetener selected from the group consisting of aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof, (c) from about 0.05 wt % to about 1.1 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 30% DV to about 100% DV of one or more minerals selected from the group consisting calcium, magnesium, potassium, sodium, iron, and a combination thereof, (e) from about 0.8 ppm to about 60 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.04 wt % of caffeine; and (g) from about 0.07 wt % to about 0.3 wt % of one or more acids selected from the group consisting of ascorbic acid, citric acid, lactic acid, malic acid, phosphoric acid, tartaric acid, and a combination thereof; wherein the beverage has a turbidity of less than 98 NTUs and/or an absorbance of less than 0.1 at 600 nm wavelength.

In some aspects, the present disclosure provides a beverage comprising from about 1 wt % to about 5 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof, about 0.1 wt % to about 0.2 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, and from about 0.75 wt % to about 2.0 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; wherein the beverage has a turbidity of less than 96 NTUs and/or an absorbance of less than 0.1 at 600 nm wavelength.

In some aspects, the present disclosure provides a beverage comprising from about 1 wt % to about 5 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof comprising protein isolate and protein hydrolysate, wherein the protein isolate and the protein hydrolysate are in a weight ratio of about 70:30; and wherein the protein isolate comprises one or more of: a) no more than 1.3 wt % potassium; b) no more than 0.50 wt % calcium, or c) no more than 0.60 wt % sodium; about 0.1 wt % to about 0.2 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 0.75 wt % to about 2.0 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; and one or more of the following: (a) from about 1 wt % to about 5 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (e.g., HFCS55, HFCS42, or HFCS90), coupling sugars, soybean oligosaccharides, honey, agave syrup, apple juice, white grape juice, pear juice, tagatose, and glucose syrup; (b) from about 3 ppm to 300 ppm of a non-nutritive sweetener selected from the group consisting of aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof, (c) from about 0.07 wt % to about 1.0 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 50% DV to about 100% DV of one or more minerals selected from the group consisting of magnesium, potassium, sodium, iron, and a combination thereof, (e) from about 2 ppm to about 7 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.02 wt % of caffeine; and (g) from about 0.08 wt % to about 0.2 wt % of one or more acids selected from the group consisting of ascorbic acid, citric acid, lactic acid, malic acid, phosphoric acid, tartaric acid, and a combination thereof; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein selected from the group consisting of collagen, pea protein, rice protein, whey protein isolate (either non-animal whey protein obtained from fermentation processes known in the art or animal whey protein), and a combination thereof, from about 0.05 wt % to about 0.35 wt % of one or more electrolytes selected from the group consisting sodium chloride, potassium citrate, sodium citrate, and a combination thereof; and from about 0.5 wt % to about 3 wt % of a soluble fiber selected from the group consisting of soluble corn fiber; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of protein selected from the group consisting of collagen, pea protein, rice protein, whey protein isolate (either non-animal whey protein obtained from fermentation processes known in the art or animal whey protein), and a combination thereof comprising protein isolate and protein hydrolysate, wherein the protein isolate and the protein hydrolysate are in a weight ratio of from about 90:10 to about 30:70; and wherein the protein isolate comprises one or more of: a) no more than 1.3 wt % potassium; b) no more than 0.50 wt % calcium, or c) no more than 0.60 wt % sodium; from about 0.05 wt % to about 0.35 wt % of one or more electrolytes selected from the group consisting sodium chloride, potassium citrate, sodium citrate, and a combination thereof, from about 0.5 wt % to about 3 wt % of soluble corn fiber; and one or more of the following: (a) from about 0.25 wt % to about 20 wt % of a nutritive sweetener selected from the group consisting of allulose, fructose, galactose, glucose, high fructose corn syrup, lactose, maltose, maltulose, sucrose, and a combination thereof, (b) from about 0.1 ppm to about 700 ppm of a non-nutritive sweetener selected from the group consisting of aspartame, acesulfame potassium, sucralose, erythritol, monk fruit, xylitol, a steviol glycoside, and a combination thereof; (c) from about 0.01 wt % to about 1.2 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 0.1% DV to about 100% DV of one or more minerals selected from the group consisting calcium, magnesium, potassium, sodium, iron, and a combination thereof, (e) from about 0.05 ppm to about 100 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.05 wt % of caffeine; and (g) from about 0.01 wt % to about 0.5 wt % of one or more acids selected from the group consisting of malic acid, tartaric acid, and a combination thereof; wherein the beverage has a turbidity of less than 100 NTUs and/or an absorbance of less than 0.1 at 600 nm wavelength.

In some aspects, the present disclosure provides a beverage comprising from about 1 wt % to about 6 wt % of protein selected from the group consisting of collagen, pea protein, rice protein, whey protein isolate (either non-animal whey protein obtained from fermentation processes known in the art or animal whey protein), and a combination thereof, from about 0.10 wt % to about 0.30 wt % of one or more electrolytes selected from the group consisting sodium chloride, potassium citrate, sodium citrate, and a combination thereof; and from about 0.75 wt % to about 2.0 wt % of soluble corn fiber; wherein the beverage has a turbidity of less than 98 NTUs and/or an absorbance of less than 0.1 at 600 nm wavelength.

In some aspects, the present disclosure provides a beverage comprising from about 1 wt % to about 6 wt % of protein selected from the group consisting of collagen, pea protein, rice protein, whey protein isolate (either non-animal whey protein obtained from fermentation processes known in the art or animal whey protein), and a combination thereof comprising protein isolate and protein hydrolysate, wherein the protein isolate and the protein hydrolysate are in a weight ratio of from about 80:20 to about 40:60; and wherein the protein isolate comprises one or more of: a) no more than 1.3 wt % potassium; b) no more than 0.50 wt % calcium, or c) no more than 0.60 wt % sodium; from about 0.10 wt % to about 0.30 wt % of one or more electrolytes selected from the group consisting sodium chloride, potassium citrate, sodium citrate, and a combination thereof, from about 0.75 wt % to about 2.0 wt % of soluble corn fiber; and one or more of the following: (a) from about 0.5 wt % to about 8 wt % of a nutritive sweetener selected from the group consisting of allulose, fructose, galactose, glucose, high fructose corn syrup lactose, maltose, maltulose, sucrose, and a combination thereof, (b) from about 3 ppm to about 300 ppm of a non-nutritive sweetener selected from the group consisting of aspartame, acesulfame potassium, sucralose, erythritol, monk fruit, xylitol, a steviol glycoside, and a combination thereof; (c) from about 0.05 wt % to about 1.1 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 30% DV to about 100% DV of one or more minerals selected from the group consisting calcium, magnesium, potassium, sodium, iron, and a combination thereof, (e) from about 0.8 ppm to about 60 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.04 wt % of caffeine; and (g) from about 0.08 wt % to about 0.2 wt % of one or more acids selected from the group consisting of malic acid, tartaric acid, and a combination thereof; wherein the beverage has a turbidity of less than 98 NTUs and/or an absorbance of less than 0.1 at 600 nm wavelength.

In some aspects, the present disclosure provides a beverage comprising from about 1 wt % to about 5 wt % of protein selected from the group consisting of collagen, pea protein, rice protein, whey protein isolate (either non-animal whey protein obtained from fermentation processes known in the art or animal whey protein), and a combination thereof, about 0.1 wt % to about 0.2 wt % of one or more electrolytes selected from the group consisting sodium chloride, potassium citrate, sodium citrate, and a combination thereof; and from about 0.75 wt % to about 2.0 wt % of soluble corn fiber wherein the beverage has a turbidity of less than 96 NTUs and/or an absorbance of less than 0.1 at 600 nm wavelength.

In some aspects, the present disclosure provides a beverage comprising from about 1 wt % to about 5 wt % of protein selected from the group consisting of collagen, pea protein, rice protein, whey protein isolate (either non-animal whey protein obtained from fermentation processes known in the art or animal whey protein), and a combination thereof comprising protein isolate and protein hydrolysate, wherein the protein isolate and the protein hydrolysate are in a weight ratio of about 70:30; and wherein the protein isolate comprises one or more of: a) no more than 1.3 wt % potassium; b) no more than 0.50 wt % calcium, or c) no more than 0.60 wt % sodium; about 0.1 wt % to about 0.2 wt % of one or more electrolytes selected from the group consisting sodium chloride, potassium citrate, sodium citrate, and a combination thereof; from about 0.75% to about 2.0 wt % of soluble corn fiber; and one or more of the following: (a) from about 1 wt % to about 5 wt % of a nutritive sweetener selected from the group consisting of allulose, fructose, galactose, glucose, high fructose corn syrup lactose, maltose, maltulose, sucrose, and a combination thereof, (b) from about 3 ppm to about 300 ppm of a non-nutritive sweetener selected from the group consisting of aspartame, acesulfame potassium, sucralose, erythritol, monk fruit, xylitol, a steviol glycoside, and a combination thereof; (c) from about 0.07 wt % to about 1.0 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 50% DV to about 100% DV of one or more minerals selected from the group consisting calcium, magnesium, potassium, sodium, iron, and a combination thereof, (e) from about 2 ppm to about 7 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.02 wt % of caffeine; and (g) from about 0.08 wt % to about 0.2 wt % of one or more acids selected from the group consisting of malic acid, tartaric acid, and a combination thereof, wherein the beverage has a turbidity of less than 96 NTUs and/or an absorbance of less than 0.1 at 600 nm wavelength.

In some aspects, the present disclosure provides a beverage comprising from about 1 wt % to about 10 wt % of whey protein isolate (either animal whey protein or non-animal whey protein obtained from fermentation processes known in the art); from about 0.05 wt % to about 0.35 wt % of a combination sodium chloride, potassium citrate, and sodium citrate; and from about 0.5 wt % to about 3 wt % of a soluble corn fiber; wherein the beverage has a turbidity of less than 100 NTUs and/or an absorbance of less than 0.1 at 600 nm wavelength.

In some aspects, the present disclosure provides a beverage comprising from about 1 wt % to about 10 wt % of a mixture of whey protein isolate and whey protein hydrolysate (either non-animal whey protein obtained from fermentation processes known in the art or animal whey protein), wherein the protein isolate and the protein hydrolysate are in a weight ratio of from about 90:10 to about 30:70 and wherein the protein isolate comprises one or more of: a) no more than 1.3 wt % potassium; b) no more than 0.50 wt % calcium, or c) no more than 0.60 wt % sodium; from about 0.05 wt % to about 0.35 wt % of a mixture sodium chloride, potassium citrate, and; from about 0.5 wt % to about 3 wt % of soluble corn fiber; and one or more of the following: (a) from about 0.25 wt % to about 20 wt % of sucrose; (b) from about 0.1 ppm to about 700 ppm of a non-nutritive sweetener selected from the group consisting of aspartame, acesulfame potassium, sucralose, erythritol, monk fruit, xylitol, a steviol glycoside, and a combination thereof, (c) from about 0.01 wt % to about 1.2 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1% DV to about 100% DV of one or more minerals selected from the group consisting calcium, magnesium, potassium, sodium, iron, and a combination thereof, (e) from about 0.5 ppm to about 100 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.05 wt % of caffeine; and (g) from about 0.01 wt % to about 0.5 wt % of one or more acids selected from the group consisting of malic acid, tartaric acid, and a combination thereof; wherein the beverage has a turbidity of less than 100 NTUs and/or an absorbance of less than 0.1 at 600 nm wavelength.

In some aspects, the present disclosure provides a beverage comprising from about 1 wt % to about 6 wt % of a mixture of whey protein isolate and whey protein hydrolysate (either non-animal whey protein obtained from fermentation processes known in the art or animal whey protein), wherein the protein isolate and the protein hydrolysate are in a weight ratio of from about 80:20 to about 40:60; and wherein the protein isolate comprises one or more of: a) no more than 1.3 wt % potassium; b) no more than 0.50 wt % calcium, or c) no more than 0.60 wt % sodium; from about 0.10 wt % to about 0.30 wt % of a combination sodium chloride, potassium citrate, and sodium citrate; and from about 0.75 wt % to about 2.0 wt % of soluble corn fiber; wherein the beverage has a turbidity of less than 98 NTUs and/or an absorbance of less than 0.1 at 600 nm wavelength.

In some aspects, the present disclosure provides a beverage comprising from about 1 wt % to about 6 wt % of whey protein isolate and whey protein hydrolysate (either non-animal whey protein obtained from fermentation processes known in the art or animal whey protein), wherein the protein isolate and the protein hydrolysate are in a weight ratio of from about 80:20 to about 40:60; and wherein the protein isolate comprises one or more of: a) no more than 1.3 wt % potassium; b) no more than 0.50 wt % calcium, or c) no more than 0.60 wt % sodium; from about 0.10 wt % to about 0.30 wt % of a combination sodium chloride, potassium citrate, and sodium citrate; from about 0.75 wt % to about 2.0 wt % of soluble corn fiber; and one or more of the following: (a) from about 0.5 wt % to about 8 wt % of sucrose; (b) from about 3 ppm to about 300 ppm of a non-nutritive sweetener selected from the group consisting of aspartame, acesulfame potassium, sucralose, erythritol, monk fruit, xylitol, a steviol glycoside, and a combination thereof, (c) from about 0.05 wt % to about 1.1 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 30% DV to about 100% DV wt % of one or more minerals selected from the group consisting calcium, magnesium, potassium, sodium, iron, and a combination thereof, (e) from about 0.8 ppm to about 60 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.04 wt % of caffeine; and (g) from about 0.07 wt % to about 0.3 wt % of one or more acids selected from the group consisting of malic acid, tartaric acid, and a combination thereof wherein the beverage has a turbidity of less than 98 NTUs and/or an absorbance of less than 0.1 at 600 nm wavelength.

In some aspects, the present disclosure provides a beverage comprising from about 1 wt % to about 5 wt % of whey protein isolate (either non-animal whey protein obtained from fermentation processes known in the art or animal whey protein), wherein the protein isolate and the protein hydrolysate are in a weight ratio of about 70:30; and wherein the protein isolate comprises one or more of: a) no more than 1.3 wt % potassium; b) no more than 0.50 wt % calcium, or c) no more than 0.60 wt % sodium; about 0.1 wt % to about 0.2 wt % wt % of a combination sodium chloride, potassium citrate, and sodium citrate; and from about 0.75 wt % to about 2.0 wt % of soluble corn fiber; wherein the beverage has a turbidity of less than 96 NTUs and/or an absorbance of less than 0.1 at 600 nm wavelength.

In some aspects, the present disclosure provides a beverage comprising from about 1 wt % to about 5 wt % of whey protein isolate and whey protein hydrolysate (either non-animal whey protein obtained from fermentation processes known in the art or animal whey protein), wherein the protein isolate and the protein hydrolysate are in a weight ratio of about 70:30; and wherein the protein isolate comprises one or more of: a) no more than 1.3 wt % potassium; b) no more than 0.50 wt % calcium, or c) no more than 0.60 wt % sodium; about 0.1 wt % to about 0.2 wt wt % of a combination sodium chloride, potassium citrate, and sodium citrate; from about 0.75% to about 2.0 wt % of corn fiber; and one or more of the following: (a) from about 1 wt % to about 5 wt % of sucrose; (b) from about 3 ppm to about 300 ppm of a non-nutritive sweetener selected from the group consisting of aspartame, acesulfame potassium, sucralose, erythritol, monk fruit, xylitol, a steviol glycoside, and a combination thereof; (c) from about 0.07 wt % to about 1.0 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 50% DV to about 100% DV of one or more minerals selected from the group consisting calcium, magnesium, potassium, sodium, iron, and a combination thereof, (e) from about 2 ppm to about 7 ppm of one or more coloring agents selected from the group consisting of an agent derived from anthocyanin, a betanin, carmine, a carotenoid, chlorophyll, cochineal, curcumin, a cyclohexene dione dimer, a phycocyanin, or an agent derived from the reaction of an iridoid and an amino acid; (f) from about 0.01 wt % to about 0.02 wt % of caffeine; and (g) from about 0.08 wt % to about 0.2 wt % of one or more acids selected from the group consisting of malic acid, tartaric acid, and a combination thereof, wherein the beverage has a turbidity of less than 96 NTUs and/or an absorbance of less than 0.1 at 600 nm wavelength.

In some aspects, the beverages described herein can comprise at least one dissolved gas. In some aspects, the at least one dissolved gas can comprise an effervescent gas, such as, e.g., carbon dioxide, nitrogen, nitrous oxide, oxygen, compressed air (e.g., comprising at least 78% nitrogen, at least 20% oxygen, and less than 2% argon by volume), or a combination thereof. In some aspects, the at least one dissolved gas can comprise a combination of carbon dioxide and a second gas, such as nitrogen gas or nitrous oxide. In some aspects, the beverage comprises carbon dioxide (i.e., the beverage is carbonated).

When more than one gas is used, the gasses can be provided in any suitable volume ratio. In some aspects, two gases (e.g., carbon dioxide and nitrogen gas) can be present in a volume ratio of about 90:10 to about 10:90. In some aspects, the two gases can be present in a volume ratio (e.g., a carbon dioxide to nitrogen gas volume ratio) of about 85:15 to about 15:85, about 80:20 to about 20:80, about 75:25 to about 25:75, about 70:30 to about 30:70, about 65:35 to about 35:65, or about 60:40 to about 40:60 (e.g., about 50:50). In some aspects, the two gases can be present in a volume ratio (e.g., a carbon dioxide to nitrogen gas volume ratio) of about 90:10, about 85:15, about 80:20, about 75:25, about 70:30, about 65:35, about 60:40, about 55:45, about 50:50, about 45:55, about 40:60, about 35:65, about 30:70, about 25:75, about 20:80, about 15:85, or about 10:90.

In some aspects, the beverage can be a ready to drink beverage. In some aspects, the ready to drink beverage can be disposed in a sealed container. The container can be any suitable receptacle that can be sealed after filling, such as a can (e.g., a metal can, such as an aluminum can), carton, bottle (e.g., a glass bottle, a polyester or polyethylene terephthalate (PET) bottle), or keg. In some aspects, the ready to drink beverage can be disposed in a sealed can (e.g., an aluminum can). In some aspects, the ready to drink beverage can be disposed in a sealed carton. In some aspects, the ready to drink beverage can be disposed in a sealed bottle (e.g., a glass bottle). In some aspects, the ready to drink beverage can be disposed in a sealed keg.

### Powder Base

In some aspects the present disclosure provides a ready-to-mix powder base containing protein that can be added to a beverage (i.e., water, or any other beverage described herein). In some aspects, the beverage is a fountain beverage, a frozen beverage, a fruit juice, a fruit juice-flavored drink, a fruit-flavored drink, a cola beverage, a sports drink, an energy drink, a fortified/enhanced water drink, a flavored water, a soy drink, a vegetable drink, a grain-based drink, a malt beverage, a fermented drink, a yogurt drink, kefir, a coffee beverage, a tea beverage, a dairy beverage, a smoothie drink, a caffeinated energy drink, or an alcoholic beverage.

In certain aspects, the powder base comprises protein. In some aspects, the protein comprises collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, or a combination thereof. In some aspects, the protein comprises collagen, pea protein, rice protein, whey protein isolate, or a combination thereof.

In some aspects, the protein can be present in the powder base in an amount from about 40 wt % to about 80 wt %. In some aspects, the protein can be present in the powder base in an amount from about 45 wt % to about 75 wt %. In some aspects, the protein can be present in the beverage in an amount of about 50 wt %, about 70 wt %,

In some aspects, the powder base comprises a mixture of protein isolate and protein hydrolysate. Without being bound by a particular theory, protein hydrolysates are thought to increase plasma amino acid concentrations compared to intact protein isolates, accelerate protein digestion and absorption from the gut, augment postprandial amino acid availability, and tend to increase the incorporation rate of dietary amino acids into skeletal muscle protein. As protein hydrolysates typically have an unpleasant taste, using a mix a mixture of protein isolate and protein hydrolysate is thought to provide improved digestion of the protein while maintaining acceptable flavor.

In some aspects, the protein isolate comprises no more than about 1.5 wt % potassium. In some aspects, the protein isolate comprises no more than about 1.4 wt % potassium. In some aspects, the protein isolate comprises no more than about 1.3 wt % potassium. In some aspects, the protein isolate comprises no more than about 1.2 wt % potassium. In some aspects, the protein isolate comprises no more than about 1.1 wt % potassium. In some aspects, the protein isolate comprises no more than about 1.0 wt % potassium. In some aspects, the protein isolate comprises no more than about 0.9 wt % potassium. In some aspects, the protein isolate comprises no more than about 0.8 wt % potassium. In some aspects, the protein isolate comprises no more than about 0.7 wt % potassium. In some aspects, the protein isolate comprises no more than about 0.6 wt % potassium. In some aspects, the protein isolate comprises no more than about 0.5 wt % potassium. In some aspects, the protein isolate comprises no more than about 0.4 wt % potassium. In some aspects, the protein isolate comprises no more than about 0.3 wt % potassium. In some aspects, the protein isolate comprises no more than about 0.2 wt % potassium. In some aspects, the protein isolate comprises no more than about 0.1 wt % potassium. In some aspects, the protein isolate does not comprise potassium.

In some aspects, the protein isolate comprises no more than about 0.70 wt % calcium. In some aspects, the protein isolate comprises no more than about 0.60 wt % calcium. In some aspects, the protein isolate comprises no more than about 0.50 wt % calcium. In some aspects, the protein isolate comprises no more than about 0.40 wt % calcium. In some aspects, the protein isolate comprises no more than about 0.30 wt % calcium. In some aspects, the protein isolate comprises no more than about 0.20 wt % calcium. In some aspects, the protein isolate comprises no more than about 0.10 wt % calcium. In some aspects, the protein isolate comprises no more than about 0.05 wt % calcium. In some aspects, the protein isolate comprises no more than about 0.1 wt % calcium. In some aspects, the protein isolate comprises no more than about 0.09 wt % calcium. In some aspects, the protein isolate comprises no more than about 0.08 wt % calcium. In some aspects, the protein isolate comprises no more than about 0.07 wt % calcium. In some aspects, the protein isolate comprises no more than about 0.06 wt % calcium. In some aspects, the protein isolate comprises no more than about 0.05 wt % calcium. In some aspects, the protein isolate comprises no more than about 0.04 wt % calcium. In some aspects, the protein isolate comprises no more than about 0.03 wt % calcium. In some aspects, the protein isolate comprises no more than about 0.02 wt % calcium. In some aspects, the protein isolate comprises no more than about 0.01 wt % calcium. In some aspects, the protein isolate does not comprise calcium.

In some aspects, the protein isolate comprises no more than about 1.0 wt % sodium. In some aspects, the protein isolate comprises no more than about 0.95 wt % sodium. In some aspects, the protein isolate comprises no more than about 0.90 wt % sodium. In some aspects, the protein isolate comprises no more than about 0.85 wt sodium. In some aspects, the protein isolate comprises no more than about 0.80 wt sodium. In some aspects, the protein isolate comprises no more than about 0.75 wt sodium. In some aspects, the protein isolate comprises no more than about 0.70 wt sodium. In some aspects, the protein isolate comprises no more than about 0.67 wt % sodium. In some aspects, the protein isolate comprises no more than about 0.65 wt sodium. In some aspects, the protein isolate comprises no more than about 0.60 wt sodium. In some aspects, the protein isolate comprises no more than about 0.55 wt sodium. In some aspects, the protein isolate comprises no more than about 0.50 wt sodium. In some aspects, the protein isolate comprises no more than about 0.45 wt sodium. In some aspects, the protein isolate comprises no more than about 0.40 wt sodium. In some aspects, the protein isolate comprises no more than about 0.35 wt sodium. In some aspects, the protein isolate comprises no more than about 0.30 wt % sodium. In some aspects, the protein isolate comprises no more than about 0.25 wt sodium. In some aspects, the protein isolate comprises no more than about 0.20 wt sodium. In some aspects, the protein isolate comprises no more than about 0.15 wt sodium. In some aspects, the protein isolate comprises no more than about 0.10 wt % sodium. In some aspects, the protein isolate does not comprise sodium.

In some aspects, the protein isolate comprises one or more of: a) no more than about 1.5 wt % potassium; b) no more than about 0.7 wt % calcium, or c) no more than about 1.0 wt % sodium.

In some aspects, the protein isolate comprises one or more of: a) no more than about 1.2 wt % potassium; b) no more than about 0.60 wt % calcium, or c) no more than about 0.90 wt % sodium.

In some aspects, the protein isolate comprises one or more of: a) no more than about 1.0 wt % potassium; b) no more than about 0.50 wt % calcium, or c) no more than about 0.80 wt % sodium.

In some aspects, the protein isolate comprises one or more of: a) no more than about 0.80 wt % potassium; b) no more than about 0.40 wt % calcium, or c) no more than about 0.70 wt % sodium.

In some aspects, the protein isolate comprises one or more of: a) no more than about 0.60 wt % potassium; b) no more than about 0.30 wt % calcium, or c) no more than about 0.50 wt % sodium.

In some aspects, the protein isolate comprises one or more of: a) no more than about 0.40 wt % potassium; b) no more than about 0.10 wt % calcium, or c) no more than about 0.40 wt % sodium.

In some aspects, the protein isolate comprises one or more of: a) no more than about 0.20 wt % potassium; b) no more than about 0.08 wt % calcium, or c) no more than about 0.20 wt % sodium.

In some aspects, the protein isolate comprises one or more of: a) no more than about 1.2 wt % potassium; b) no more than about 0.05 wt % calcium, or c) no more than about 0.60 wt % sodium.

In some aspects, the protein isolate comprises one or more of: a) no more than 1.3 wt % potassium; b) no more than 0.50 wt % calcium, or c) no more than 0.60 wt % sodium.

In some aspects, the powder base comprises from about 5 wt % to about 55 wt % of protein hydrolysate. In some aspects, the powder base comprises about 5 wt % to about 45 wt % of protein hydrolysate. In some aspects, the powder base comprises about 5 wt % to about 40 wt % of protein hydrolysate. In some aspects, the powder base comprises about 5 wt % to about 35 wt % of protein hydrolysate. In some aspects, the powder base comprises about 5 wt % to about 30 wt % of protein hydrolysate. In some aspects, the powder base comprises about 10 wt % to about 25 wt % of protein hydrolysate. In some aspects, the powder base comprises about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, or about 55 wt % or protein hydrolysate.

In some aspects, the protein isolate and the protein hydrolysate are present in the powder base in a weight ratio ranging from about 90:10 to about 30:70. In some aspects, the protein isolate and the protein hydrolysate are present in the powder base in a weight ratio ranging from about 80:20 to about 40:60. In some aspects, the protein isolate and the protein hydrolysate are present in the beverage in a weight ratio of 90:10, about 80:20, about 70:30, about 60:40, about 50:50, about 40:60, or about 30:70. In some aspects, the protein isolate and the protein hydrolysate are present in the powder base in a weight ratio of about 70:30.

In certain aspects, the powder base comprises from about 40 wt % to about 80 wt % of a mixture of protein isolate and protein hydrolysate, wherein the protein isolate and the protein hydrolysate are present in the powder base in a weight ratio ranging from about 90:10 to about 30:70. In some aspects, the powder base comprises from about 45 wt % to about 75 wt % of a mixture of protein isolate and protein hydrolysate, wherein the protein isolate and the protein hydrolysate are present in the powder base in a weight ratio ranging from about 80:20 to about 40:60. In certain aspects, the powder base comprises about 50 wt % to about 70 wt % of a mixture of protein isolate and protein hydrolysate, wherein the protein isolate and the protein hydrolysate are present in the powder base in a weight ratio of about 70:30.

In certain aspects, the powder base comprises from about 40 wt % to about 80 wt % of a protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof, wherein the protein comprises a mixture of protein isolate and protein hydrolysate that present in the powder base in a weight ratio ranging from about 90:10 to about 30:70. In some aspects, the powder base comprises from about 45 wt % to about 75 wt % of a protein selected from the group consisting of collagen, whey protein, wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof, wherein the protein comprises a mixture of protein isolate and protein hydrolysate that are present in the powder base in a weight ratio ranging from about 80:20 to about 40:60. In certain aspects, the powder base comprises about 50 wt % to about 70 wt % of a protein selected from the group consisting of collagen, whey protein, wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof, wherein the protein comprises a mixture of protein isolate and protein hydrolysate that are present in the powder base in a weight ratio of from about 70:30.

In certain aspects, the powder base comprises from about 40 wt % to about 80 wt % of a protein selected from the group consisting of collagen, pea protein, rice protein, whey protein isolate (either non-animal whey protein obtained from fermentation processes known in the art or animal whey protein), and a combination thereof, wherein the protein comprises a mixture of protein isolate and protein hydrolysate that are present in the powder base in a weight ratio ranging from about 90:10 to about 30:70. In some aspects, the powder base comprises from about 45 wt % to about 75 wt % of a protein selected from the group consisting of collagen, pea protein, rice protein, whey protein isolate, and a combination thereof, wherein the protein comprises a mixture of protein isolate and protein hydrolysate that are present in the powder base in a weight ratio ranging from about 80:20 to about 40:60. In certain aspects, the powder base comprises about 50 wt % to about 70 wt % of a protein selected from the group consisting of collagen, pea protein, rice protein, whey protein isolate, and a combination thereof, wherein the protein comprises a mixture of protein isolate and protein hydrolysate that are present in the powder base in a weight ratio of from about 70:30.

In certain aspects, the powder base comprises one or more vitamins. In some aspects, the power base does not contain vitamins. In some aspects, the one or more vitamins comprise vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof. In some aspects, the one or more vitamins comprise vitamin D, vitamin E, or a combination thereof.

In some aspects, the powder base comprises from about 10% to about 200% of the daily value (DV) of the one or more vitamins. The “daily value” of a particular vitamin is the recommended amount of that vitamin that should be consumed each day as determined by the U.S. Food and Drug Administration. In some aspects, the powder base comprises from about 20% DV to about 175% DV of the one or more vitamins. In some aspects, the powder base comprises from about 30% DV to about 150% DV of the one or more vitamins. In some aspects, the powder base comprises from about 40% DV to about 140% DV of the one or more vitamins. In some aspects, the powder base comprises from about 50% DV to about 130% DV of the one or more vitamins. In some aspects, the powder base comprises from about 60% DV to about 120% DV of the one or more vitamins. In some aspects, the powder base comprises from about 70% DV to about 110% DV of the one or more vitamins. In some aspects, the powder base comprises from about 75% DV to about 125% DV of the one or more vitamins. In some aspects, the powder base comprises from about 90% DV to about 110% DV of the one or more vitamins. In some aspects, the powder base comprises about 100% DV of the one or more vitamins.

In some aspects, the powder base comprises from about 0.01 wt % to about 0.3 wt % of one or more vitamins. In some aspects, the powder base comprises from about 0.02 wt % to about 0.2 wt % of the one or more vitamins. In some aspects, the powder base comprises from about 0.04 wt % to about 0.1 wt % of the one or more vitamins. In some aspects, the powder base comprises about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.10 wt %, about 0.11 wt %, about 0.12 wt %, about 0.13 wt %, about 0.14 wt %, about 0.15 wt %, about 0.16 wt %, about 0.17 wt %, about 0.18 wt %, about 0.19 wt %, about 0.20 wt %, 0.21 wt %, about 0.22 wt %, about 0.23 wt %, about 0.24 wt %, about 0.25 wt %, about 0.26 wt %, about 0.27 wt %, about 0.28 wt %, about 0.29 wt %, or about 0.30 wt % of one or more vitamins.

In some aspects, the powder base comprises one or more electrolytes. In some aspects, the one or more electrolytes comprise sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, or combinations thereof. In some aspects, the one or more electrolytes comprise sodium chloride, potassium citrate, sodium citrate, or a combination thereof. In some aspects, the one or more electrolytes comprise a combination of sodium chloride, potassium citrate, and sodium citrate.

In certain aspects, the powder base comprises from about 1 wt % to about 5 wt % of one or more electrolytes. In some aspects, the powder base comprises from about 1.1 wt % to about 4.5 wt % of one or more electrolytes. In some aspects, the powder base comprises from about 1.2 wt % to about 4.0 wt % of one or more electrolytes. In some aspects, the beverage comprises about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, or about 5.0 wt % of one or more electrolytes.

In some aspects, the powder base comprise from about 1 wt % to about 5 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof. In some aspects, the powder base comprises from about 1.1 wt % to about 4.5 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof. In some aspects, the powder base comprises from about 1.2 wt % to about 4.0 wt % of one or more electrolytes selected from the group consisting of potassium chloride, sodium chloride, potassium citrate, sodium citrate, and a combination thereof. In some aspects, the powder base comprises about 1.0 wt % to about 2.0 wt % of a combination of potassium chloride, sodium chloride, potassium citrate, and sodium citrate.

In some aspects, the powder base comprises one or more chelators. In some aspects the one or more chelators comprises citric acid, glutamic acid, diacetic acid, methylglycine, N,N-diacetic acid, aulvic acid, gluconic acid, sodium gluconate, glucono-delta-lactone, zinc gluconate, rosmarinic acid, quercetin, L-carnitine, potassium polyaspartate, phytic acid, or a combination thereof. In some aspects, the chelator comprises citric acid.

In some aspects, the powder base comprises from about 0.2 wt % to about 5 wt % of one or more chelators. In some aspects, the powder base comprises from about 0.4 wt % to about 4 wt % of one or more chelators. In some aspects, the powder base comprises about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2.0 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3.0 wt %, about 3.0 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4.0 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5.0 wt % of one or more chelators.

In some aspects, the powder base comprises fiber. In some aspects, the fiber in the powder base comprises soluble fiber. In some aspects, the soluble fiber comprises Bacillus coagulans sodium, calcium polycarbophil, fructo-oligosaccharides, inulin, methylcellulose, polydextrose, psyllium husk, soluble corn fiber, oat, barley, fruit pectin, or a combination thereof. In some aspects, the soluble fiber comprises soluble corn fiber.

In some aspects, the powder base comprises from about 5 wt % to about 20 wt % of soluble fiber. In some aspects, the powder base comprises from about 5 wt % to about 15 wt % of soluble fiber. In some aspects, the powder base comprises about 5 wt % to about 10 wt %, of soluble fiber. In some aspects, the powder base comprises about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, or about 20 wt % of soluble fiber.

In some aspects, the beverage comprises from about 5 wt % to about 20 wt % of a soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof. In some aspects, the beverage comprises about 5 wt % to about 10 wt % of soluble corn fiber.

In certain aspects, the powder base can further comprise one or more sweeteners. In some aspects, the one or more sweeteners comprise a nutritive sweetener, a non-nutritive sweetener, or a combination thereof.

Examples of suitable nutritive sweeteners include sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, coupling sugars, tagatose, and soybean oligosaccharides. In some aspects, the powder base comprises a nutritive sweetener selected from the group consisting of allulose, fructose, galactose, glucose, lactose, maltose, maltulose, sucrose, and a combination thereof.

Examples of suitable non-nutritive sweeteners include aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof. In some aspects, the powder base comprises a non-nutritive sweetener selected from the group consisting of aspartame, acesulfame potassium, sucralose, erythritol, xylitol, a steviol glycoside, and a combination thereof.

Examples of suitable steviol glycosides include rebaudioside A, rebaudioside B, rebaudioside C (dulcoside B), rebaudioside D, rebaudioside E, rebaudioside F, rebaudioside H, rebaudioside I, rebaudioside J, rebaudioside K, rebaudioside L, rebaudioside M, rebaudioside N, rebaudioside O, rebaudioside R, rebaudioside S, rebaudioside T, rebaudioside U, rebaudioside V, dulcoside A, rubusoside, stevia extract, stevioside, mogroside IV, mogroside V, siamenoside, polypodoside A, pterocaryoside A, pterocaryoside B, mukurozioside, phlomisoside I, periandrin I, abrusoside A, cyclocarioside I, and a combination thereof. In some aspects, the powder base comprises a steviol glycoside selected from the group consisting of stevoside, steviolbioside, rubusoside, dulcoside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, rebaudioside Q, and a combination thereof.

In some aspects, the powder base can comprise one or more nutritive sweeteners in an amount from about 0.01 wt % to about 80 wt %. In some aspects, the powder base can comprise one or more nutritive sweeteners in an amount from about 0.1 wt % to about 80 wt %. In some aspects, the powder base can comprise one or more nutritive sweeteners in an amount of about 0.5 wt % to about 80 wt %. In some aspects, the powder base can comprise one or more nutritive sweeteners in an amount of about 1 wt % to about 80 wt %. In some aspects, the powder base can comprise one or more nutritive sweeteners in an amount of about 5 wt % to about 75 wt %. In some aspects, the powder base can comprise one or more nutritive sweeteners in an amount of about 10 wt % to about 70 wt %. In some aspects, the powder base can comprise one or more nutritive sweeteners in an amount of about 0.01 wt %, about 0.05 wt %, about 0.10 wt %, about 0.5 wt %, about 1 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, or about 80 wt %.

In some aspects, the beverage can comprise one or more non-nutritive sweeteners sweeteners in a total amount ranging from about 1 ppm to about 11,000 ppm. In some aspects, the beverage can comprise one or more non-nutritive sweeteners in a total amount ranging from about 5 ppm to about 10,500 ppm. In some aspects, the beverage can comprise one or more non-nutritive sweeteners in a total amount of about 10 ppm to about 10,000 ppm. In some aspects, the beverage can comprise one or more non-nutritive sweeteners in a total amount of about 10 ppm to about 10,000 ppm. In some aspects, the beverage can comprise one or more non-nutritive sweeteners in a total amount of about 50 ppm to about 9,000 ppm. In some aspects, the beverage can comprise one or more non-nutritive sweeteners in a total amount of about 100 ppm to about 10,000 ppm. In some aspects, the beverage can comprise one or more non-nutritive sweeteners in a total amount of about 200 ppm to about 9,500 ppm. In some aspects, the beverage can comprise one or more non-nutritive sweeteners in a total amount of about 300 ppm to about 9,000 ppm. In some aspects, the beverage can comprise one or more non-nutritive sweeteners in a total amount of about 400 ppm to about 8,500 ppm. In some aspects, the beverage can comprise one or more non-nutritive sweeteners in a total amount of about 500 ppm to about 8,000 ppm. In some aspects, the beverage can comprise one or more non-nutritive sweeteners in a total amount of about 600 ppm to about 7,500 ppm. In some aspects, the beverage can comprise one or more non-nutritive sweeteners in a total amount of about 700 ppm to about 7,000 ppm. In some aspects, the beverage can comprise one or more non-nutritive sweeteners in a total amount of about 800 ppm to about 6,500 ppm. In some aspects, the beverage can comprise one or more non-nutritive sweeteners in a total amount of about 900 ppm to about 6,000 ppm. In some aspects, the beverage can comprise one or more non-nutritive sweeteners in a total amount of about 1,000 ppm to about 5,500 ppm. In some aspects, the beverage can comprise one or more non-nutritive sweeteners in a total amount of about 1 ppm, about 5 ppm, about 10 ppm, about 25 ppm, about 50 ppm, about 75 ppm, about 100 ppm, about 200 ppm, about 300 ppm, about 400 ppm, about 500 ppm, about 600 ppm, about 700 ppm, about 800 ppm, about 900 ppm, about 1,000 ppm, about 1,500 ppm, about 1,750 ppm, about 2,000 ppm, 2,500 ppm, about 3,000 ppm, about 3,500 ppm, about 4,000 ppm, about 4,500 ppm, about 5,000 ppm, about 5,500 ppm, about 6,000 ppm, about 6,500 ppm, about 7,000 ppm, about 7,500 ppm, about 8,000, about 8,500 ppm, about 9,000 ppm, about 9,500 ppm, about 10,000 ppm, about 10,500 ppm, or about 11,000 ppm of one or more non-nutritive sweeteners.

In some aspects, the powder base can comprise from about 1 ppm to about 11,000 ppm of stevia extract. In some aspects, the powder base can from about 1,000 ppm, about 5,500 ppm of stevia extract.

In some aspects, the powder base comprises one or more flow agents. In some aspects, the flow agents comprise silicon dioxide, colloidal silica, calcium silicate, magnesium carbonate, sodium aluminum phosphate, calcium phosphate, calcium carbonate, talc, tricalcium phosphate, or a combination thereof. In some aspects, the one or more flow agents comprises silicon dioxide.

In some aspects, the powder base comprises from about 0.01 wt % to about 2 wt % of one or more flow agents. In some aspects, the powder base comprises from about 0.05 wt % to about 1.5 wt % of one or more flow agents. In some aspects, the powder base comprises from about 0.1 wt % to about 1 wt % of one or more flow agents. In some aspects, the powder base comprises from about 0.1 wt % to about 0.9 wt % of one or more flow agents.

In some aspects, the powder base comprises from about 0.01 wt % to about 2 wt % one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof. In some aspects, the powder base comprises. In some aspects, the one or more flow agents comprises from about 0.1 wt % to about 0.9 wt % of silicon dioxide.

In some aspects, the powder base comprises one or more flavoring agents. The one or more flavoring agents can be natural or synthetic. Examples of flavoring agents include, but are not limited to, apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof.

In some aspects, the powder base comprises from about 0.05 wt % to about 3 wt % of one or more flavoring agents. In some aspects, the powder base comprises from about 0.1 wt % to about 3 wt % of one or more flavoring agents. In some aspects, the powder base comprises from about 0.2 wt % to about 3 wt % of one or more flavoring agents. In some aspects, the powder base comprises from about 0.5 wt % to about 2.5 wt % of one or more flavoring agents.

In some aspects, the powder base comprises one or more minerals. In some aspects, the one or more minerals comprise calcium, magnesium, potassium, sodium, iron, or combinations thereof. In some aspects, the powder base comprises from about 0.01 wt % to about 1 wt % of one or more minerals. In some aspects, the powder base comprises from about 0.05 wt % to about 0.8 wt % of one or more minerals. In some aspects, the powder base comprises from about 0.1 wt % to about 0.6 wt % of one or more minerals. In some aspects, the powder base from about 0.01 wt % to about 1 wt % of one or more minerals selected from the group consisting of calcium, magnesium, potassium, sodium, iron, and a combination thereof. In some aspects, the powder base from about 0.05 wt % to about 0.8 wt % of one or more minerals selected from the group consisting of calcium, magnesium, potassium, sodium, iron, and a combination thereof.

In some aspects, the powder base does not comprise caffeine. In some aspects, the powder base comprises caffeine. In some aspects, the powder base comprises from about 0.01 wt % to about 0.25 wt % of caffeine. In some aspects, the powder base comprises from about 0.05 wt % to about 0.20 wt %. In some aspects, the powder base comprises from about 0.1 wt % to about 0.15 wt %.

In certain aspects, the powder base comprises one or more acids. In some aspects, the one or more acids comprise ascorbic acid, citric acid, lactic acid, malic acid, tartaric acid, or combinations thereof. In some aspects, the powder base comprise malic acid, tartaric acid, or a combination thereof. In some aspects, the powder base comprises malic acid, tartaric acid, or a combination thereof.

In some aspects the powder base comprises from about 0.01 wt % to about 8 wt % of one or more acids. In some aspects, the powder base comprises from about 0.05 wt % to about 7 wt % of one or more acids. In some aspects, the powder base comprises about 0.1 wt %, about 5 wt %, of one or more acids.

In some aspects the powder base comprises from about 0.01 wt % to about 8 wt % of one or more acids selected from the group consisting of malic acid, tartaric acid, and a combination thereof. In some aspects, the beverage comprises from about 0.05 wt % to about 7 wt % of one or more acids selected from the group consisting of malic acid, tartaric acid, and a combination thereof. In some aspects, the beverage comprises about 0.1 wt % to about 5 wt % of an acid selected from the group consisting of malic acid, tartaric acid, and a combination thereof.

Typically the beverages prepared from the powder base are clear. In some aspects, where the protein and/or other components provide color to the beverage, the beverages described herein can further comprise one or more coloring agents to remove the color provided by the protein and/or other component. In some aspects the coloring agent is derived from a natural source. In some aspects, the coloring agent is derived from anthocyanin, a betanin, carmine, a carotenoid, chlorophyll, cochineal, curcumin, a cyclohexene dione dimer, a phycocyanin, or an agent derived from the reaction of an iridoid and an amino acid.

Anthocyanins are a class of compounds that provide pigmentation and are derived from natural sources. Anthocyanins found in black currants (Ribes nigrum) that provide pigmentation include 3-diglucoside and 3-rutinoside of cyanidin and delphinidin. Similarly, blueberries (Vaccinium augustifolium or Vaccinium corymbosum) typically contain the following anthocyanins that provide pigmentation: 3-glucosides, 3-galactosides, and 3-arabinosides of cyanidin, delphinidin, peonidin, petunidin, and malvidin. Exemplary anthocyanidins have structures as described below:

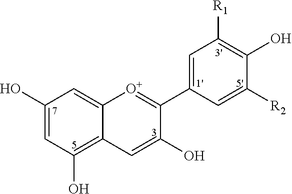

pelargonidin (R₁, R₂═H), cyanidin (R₁═OH, R₂═H), delphinidin (R₁, R₂═OH), peonidin (R₁═OCH₃, R₂═H), petunidin (R₁═OCH₃, R₂═OH), and malvidin (R₁, R₂═OCH₃).

A blue coloring agent that is derived from natural sources is gardenia blue, which may be formed by the reaction of an iridoid and an amino acid. For example, hydrolysis of the iridoid glycoside geniposide with beta-glucosidase, as indicated below, produces the iridoid genipin. Amino acids, such as glycine, lysine or phenylalanine, will react with the colorless genipin and form blue pigments:

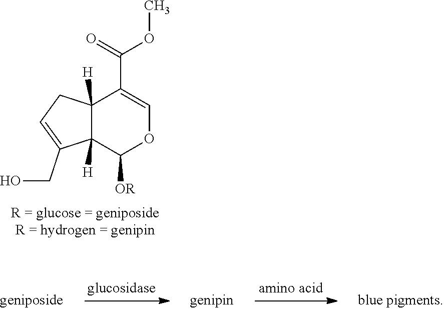

Phycocyanin is a blue protein complex found in Spirulina (blue green algae). Phycocyanins are proteins containing the covalently bound chromophore phycocyanobilin having the structure shown below:

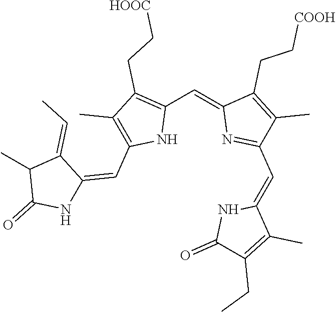

Further examples of colors derived from natural sources are carthamus yellow and carthamus red. Carthamus yellow and carthamus red may be derived from safflower (Carthamus tinctorius), and include cyclohexene dione dimers, which are classified as chalcone compounds. The chemical structure of carthamus yellow, or carthamin, is provided below:

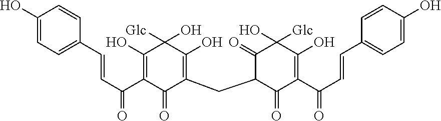

Beta-carotene and lycopene are carotenoids and are oil soluble pigments found in fruits, vegetables, etc. having the structures shown below:

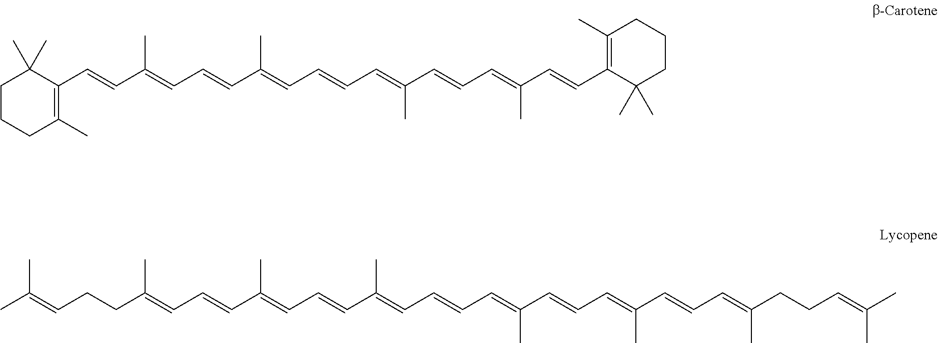

All of the aforementioned coloring agents can be purchased from well-known color manufacturing suppliers.

In some aspects, the one or more coloring agents can be present in the powder base in an amount of from about 0.05 ppm to about 1600 ppm. In some aspects, the one or more coloring agents can be present in the powder base in an amount of from about 0.1 ppm to about 1500 ppm. In some aspects, the one or more coloring agents can be present in the powder base in an amount of about 0.5 ppm to about 1000 ppm. In some aspects, the one or more coloring agents can be present in the powder base in an amount of about 1 ppm to about 750 ppm. In some aspects, the one or more coloring agents can be present in the powder base in an amount of about 10 ppm to about 500 ppm. In some aspects, the one or more coloring agents can be present in the powder base in an amount of about 0.05 ppm, about 0.1 ppm, about 0.5 ppm, about 1 ppm, about 5 ppm, about 10 ppm, about 20 ppm, about 30 ppm, about 40 ppm, about 50 ppm, about 60 ppm, about 70 ppm, about 80 ppm, about 90 ppm, about 100 ppm, about 200 ppm, about 300 ppm, about 400 ppm, about 500 ppm, about 600 ppm, about 700 ppm, about 800 ppm, about 900 ppm, about 1000 ppm, about 1100 ppm, about 1200 ppm, about 1300 ppm, about 1400 ppm, about 1500 ppm, or about 1600 ppm.

In any of the foregoing aspects, the powder base has a property that when the powder is added to water as described above, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein; about 0.01 wt % to about 0.3 wt % of one or more vitamins; from about 1 wt % to about 5 wt % of one or more electrolytes; from about 5 wt % to about 20 wt % of soluble fiber; and from about 0.01 wt % to about 2 wt % of one or more flow agents; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein; about 0.01 wt % to about 0.3 wt % of one or more vitamins; from about 1 wt % to about 5 wt % of one or more electrolytes; from about 5 wt % to about 20 wt % of soluble fiber; from about 0.01 wt % to about 2 wt % of one or more flow agents; and one or more of the following: (a) from about 0.01 wt % to about 80 wt % of a nutritive sweetener; (b) from about 1 ppm to about 11,000 ppm of a non-nutritive sweetener; (c) from about 0.05 wt % to about 3 wt % of a flavoring agent; (d) from about 0.01 wt % to about 1 wt % of one or more minerals; (e) from about 0.05 ppm to about 1600 ppm of one or more coloring agents; (f) from about 0.01 wt % to about 0.25 wt % of caffeine; and (g) from about 0.01 wt % to about 0.8 wt % of one or more acids; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof: about 0.01 wt % to about 0.3 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1 wt % to about 5 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 5 wt % to about 20 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.01 wt % to about 2 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof wherein the protein comprises a mixture of protein isolate and protein hydrolysate that are present in the powder base in a weight ratio ranging from about 90:10 to about 30:70, wherein the protein isolate comprises one or more of: a) no more than 1.3 wt % potassium; b) no more than 0.50 wt % calcium, or c) no more than 0.60 wt % sodium; about 0.01 wt % to about 0.3 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1 wt % to about 5 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 5 wt % to about 20 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; and from about 0.01 wt % to about 2 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof; and one or more of the following: (a) from about 0.01 wt % to about 80 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, coupling sugars, tagatose, soybean oligosaccharides, and a combination thereof; (b) from about 1 ppm to about 11,000 ppm of a non-nutritive sweetener aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof. In some aspects, the powder base comprises a non-nutritive sweetener selected from the group consisting of aspartame, acesulfame potassium, sucralose, erythritol, xylitol, a steviol glycoside, and a combination thereof; (c) from about 0.05 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.01 wt % to about 1 wt % of one or more minerals selected from the group consisting of calcium, magnesium, potassium, sodium, iron, and a combination thereof, (e) from about 0.05 ppm to about 1600 ppm of one or more coloring agents; (f) from about 0.01 wt % to about 0.25 wt % of caffeine; and (g) from about 0.01 wt % to about 0.8 wt % of one or more acids selected from the group consisting of ascorbic acid, citric acid, lactic acid, malic acid, tartaric acid, and a combination thereof; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; about 0.02 wt % to about 0.2 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof; from about 1.1 wt % to about 4.5 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof; from about 5 wt % to about 15 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.05 wt % to about 15 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds

In some aspects, the present disclosure provides a powder base comprising from about 45 wt % to about 75 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof wherein the protein comprises a mixture of protein isolate and protein hydrolysate that are present in the powder base in a weight ratio ranging from about 80:20 to about 40:60 and wherein the protein isolate comprises one or more of: a) no more than 1.3 wt % potassium; b) no more than 0.50 wt % calcium, or c) no more than 0.60 wt % sodium; about 0.02 wt % to about 0.2 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1.2 wt % to about 4 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 5 wt % to about 10 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.05 wt % to about 1.5 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof, and one or more of the following: (a) from about 1 wt % to about 80 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, coupling sugars, tagatose, soybean oligosaccharides, and a combination thereof, (b) from about 300 ppm to about 9,000 ppm of a non-nutritive sweetener aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof. In some aspects, the powder base comprises a non-nutritive sweetener selected from the group consisting of aspartame, acesulfame potassium, sucralose, erythritol, xylitol, a steviol glycoside, and a combination thereof; (c) from about 0.1 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.01 wt % to about 1 wt % of one or more minerals selected from the group consisting of calcium, magnesium, potassium, sodium, iron, and a combination thereof, (e) from about 0.05 ppm to about 1600 ppm of one or more coloring agents; (f) from about 0.05 wt % to about 0.0 wt % of caffeine; and (g) from about 0.05 wt % to about 0.7 wt % of one or more acids selected from the group consisting of ascorbic acid, citric acid, lactic acid, malic acid, tartaric acid, and a combination thereof, wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of protein selected from the group consisting of collagen, whey protein, wheat protein (either non-animal whey protein obtained from fermentation processes known in the art or animal whey protein), rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof, about 0.04 wt % to about 0.1 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1.2 wt % to about 4 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof; from about 5 wt % to about 10 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.1 wt % to about 1 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof, wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof wherein the protein comprises a mixture of protein isolate and protein hydrolysate that are present in the powder base in a 70:30 weight ratio and wherein the protein isolate comprises one or more of: a) no more than 1.3 wt % potassium; b) no more than 0.50 wt % calcium, or c) no more than 0.60 wt % sodium; about 0.04 wt % to about 0.1 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1.2 wt % to about 4 wt % of one or more electrolytes selected from the group consisting of sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 5 wt % to about 10 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; and from about 0.1 wt % to about 1 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof; and one or more of the following: (a) from about 5 wt % to about 75 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, coupling sugars, tagatose, soybean oligosaccharides, and a combination thereof; (b) from about 600 ppm to about 7,500 ppm of a non-nutritive sweetener aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof. In some aspects, the powder base comprises a non-nutritive sweetener selected from the group consisting of aspartame, acesulfame potassium, sucralose, erythritol, xylitol, a steviol glycoside, and a combination thereof, (c) from about 0.2 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1 wt % to about 0.6 wt % of one or more minerals selected from the group consisting of calcium, magnesium, potassium, sodium, iron, and a combination thereof, (e) from about 10 ppm to about 500 ppm of one or more coloring agents; (f) from about 0.1 wt % to about 0.15 wt % of caffeine; and (g) from about 0.05 wt % to about 0.7 wt % of one or more acids selected from the group consisting of ascorbic acid, citric acid, lactic acid, malic acid, tartaric acid, and a combination thereof, wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein selected from the group consisting of collagen, pea protein, rice protein, whey protein isolate (either non-animal whey protein obtained from fermentation processes known in the art or animal whey protein), and a combination thereof, about 0.01 wt % to about 0.3 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1 wt % to about 5 wt % of one or more electrolytes selected from the group consisting of potassium chloride, sodium chloride, potassium citrate, sodium citrate, and a combination thereof; from about 5 wt % to about 20 wt % of soluble corn fiber; and from about 0.01 wt % to about 2 wt % of silicon dioxide; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein selected from the group consisting of collagen, pea protein, rice protein, whey protein isolate (either non-animal whey protein obtained from fermentation processes known in the art or animal whey protein), and a combination thereof wherein the protein comprises a mixture of protein isolate and protein hydrolysate that are present in the powder base in a weight ratio ranging from about 90:10 to about 30:70 and wherein the protein isolate comprises one or more of: a) no more than 1.3 wt % potassium; b) no more than 0.50 wt % calcium, or c) no more than 0.60 wt % sodium; about 0.01 wt % to about 0.3 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1 wt % to about 5 wt % of one or more electrolytes selected from the group consisting of potassium chloride, sodium chloride, potassium citrate, sodium citrate, and a combination thereof; from about 5 wt % to about 20 wt % of soluble corn fiber; from about 0.01 wt % to about 2 wt % of silicon dioxide; and one or more of the following: (a) from about 0.01 wt % to about 80 wt % of a nutritive sweetener selected from the group consisting of allulose, fructose, galactose, glucose, lactose, maltose, maltulose, sucrose, and a combination thereof, (b) from about 1 ppm to about 11,000 ppm of a non-nutritive sweetener selected from the group consisting of aspartame, acesulfame potassium, sucralose, erythritol, xylitol, a steviol glycoside, and a combination thereof; (c) from about 0.05 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.01 wt % to about 1 wt % of one or more minerals selected from the group consisting of calcium, magnesium, potassium, sodium, iron, and a combination thereof, (e) from about 0.05 ppm to about 1600 ppm of one or more coloring agents; (f) from about 0.01 wt % to about 0.25 wt % of caffeine; and (g) from about 0.01 wt % to about 0.8 wt % of one or more acids selected from the group consisting of malic acid, tartaric acid, and a combination thereof; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of protein selected from the group consisting of collagen, pea protein, rice protein, whey protein isolate (either non-animal whey protein obtained from fermentation processes known in the art or animal whey protein), and a combination thereof, about 0.02 wt % to about 0.2 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof; from about 1.1 wt % to about 4.5 wt % of one or more electrolytes selected from the group consisting of potassium chloride, sodium chloride, potassium citrate, sodium citrate, and a combination thereof, from about 5 wt % to about 15 wt % of soluble corn fiber; and from about 0.05 wt % to about 15 wt % of silicon dioxide; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of protein selected from the group consisting of collagen, pea protein, rice protein, whey protein isolate (either non-animal whey protein obtained from fermentation processes known in the art or animal whey protein), and a combination thereof wherein the protein comprises a mixture of protein isolate and protein hydrolysate that are present in the powder base in a weight ratio ranging from about 80:20 to about 40:60 and wherein the protein isolate comprises one or more of: a) no more than 1.3 wt % potassium; b) no more than 0.50 wt % calcium, or c) no more than 0.60 wt % sodium; about 0.02 wt % to about 0.2 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1.2 wt % to about 4 wt % of one or more electrolytes selected from the group consisting of potassium chloride, sodium chloride, potassium citrate, sodium citrate, and a combination thereof; from about 5 wt % to about 10 wt % of soluble corn fiber; from about 0.05 wt % to about 1.5 wt % of silicon dioxide; and one or more of the following: (a) from about 1 wt % to about 80 wt % of a nutritive sweetener selected from the group consisting of allulose, fructose, galactose, glucose, lactose, maltose, maltulose, sucrose, and a combination thereof, (b) from about 300 ppm to about 9,000 ppm of a non-nutritive sweetener selected from the group consisting of aspartame, acesulfame potassium, sucralose, erythritol, xylitol, a steviol glycoside, and a combination thereof; (c) from about 0.1 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.01 wt % to about 1 wt % of one or more minerals selected from the group consisting of calcium, magnesium, potassium, sodium, iron, and a combination thereof, (e) from about 0.05 ppm to about 1600 ppm of one or more coloring agents; (f) from about 0.05 wt % to about 0.0 wt % of caffeine; and (g) from about 0.05 wt % to about 0.7 wt % of one or more acids selected from the group consisting of malic acid, tartaric acid, and a combination thereof; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of protein selected from the group consisting of collagen, pea protein, rice protein, whey protein isolate (either animal whey protein or non-animal whey protein obtained from fermentation processes known in the art); about 0.04 wt % to about 0.1 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1.2 wt % to about 4 wt % of one or more electrolytes selected from the group consisting of potassium chloride, sodium chloride, potassium citrate, sodium citrate, and a combination thereof; from about 5 wt % to about 10 wt % of soluble corn fiber; and from about 0.1 wt % to about 1 wt % of silicon dioxide; wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of protein selected from the group consisting of collagen, pea protein, rice protein, whey protein isolate (either non-animal whey protein obtained from fermentation processes known in the art or animal whey protein), and a combination thereof wherein the protein comprises a mixture of protein isolate and protein hydrolysate that are present in the powder base in a 70:30 weight ratio and wherein the protein isolate comprises one or more of: a) no more than 1.3 wt % potassium; b) no more than 0.50 wt % calcium, or c) no more than 0.60 wt % sodium; about 0.04 wt % to about 0.1 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1.2 wt % to about 4 wt % of one or more electrolytes selected from the group consisting of potassium chloride, sodium chloride, potassium citrate, sodium citrate, and a combination thereof, from about 5 wt % to about 10 wt % of soluble corn fiber; from about 0.1 wt % to about 1 wt % of silicon dioxide; and one or more of the following: (a) from about 5 wt % to about 75 wt % of a nutritive sweetener selected from the group consisting of allulose, fructose, galactose, glucose, lactose, maltose, maltulose, sucrose, and a combination thereof; (b) from about 600 ppm to about 7,500 ppm of a non-nutritive sweetener aspartame, acesulfame potassium, sucralose, erythritol, xylitol, a steviol glycoside, and a combination thereof; (c) from about 0.2 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1 wt % to about 0.6 wt % of one or more minerals selected from the group consisting of calcium, magnesium, potassium, sodium, iron, and a combination thereof, (e) from about 10 ppm to about 500 ppm of one or more coloring agents; (f) from about 0.1 wt % to about 0.15 wt % of caffeine; and (g) from about 0.05 wt % to about 0.7 wt % of one or more acids selected from the group consisting of malic acid, tartaric acid, and a combination thereof; wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of whey protein isolate (either animal whey protein or non-animal whey protein obtained from fermentation processes known in the art); about 0.01 wt % to about 0.3 wt % of vitamin D, vitamin E, or a combination thereof, from about 1 wt % to about 5 wt % of one or more electrolytes selected from the group consisting of potassium chloride, sodium chloride, potassium citrate, sodium citrate, or a combination there; from about 5 wt % to about 20 wt % of soluble corn fiber; and from about 0.01 wt % to about 2 wt % of silicon dioxide; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of whey protein isolate (either non-animal whey protein obtained from fermentation processes known in the art or animal whey protein), wherein the protein comprises a mixture of protein isolate and protein hydrolysate that are present in the powder base in a weight ratio ranging from about 90:10 to about 30:70 and wherein the protein isolate comprises one or more of: a) no more than 1.3 wt % potassium; b) no more than 0.50 wt % calcium, or c) no more than 0.60 wt % sodium; about 0.01 wt % to about 0.3 wt % of vitamin D, vitamin E, or a combination thereof; from about 1 wt % to about 5 wt % of one or more electrolytes selected from the group consisting of potassium chloride, sodium chloride, potassium citrate, sodium citrate, and a combination thereof; from about 5 wt % to about 20 wt % of soluble corn fiber; from about 0.01 wt % to about 2 wt % of silicon dioxide; and one or more of the following: (a) from about 0.01 wt % to about 80 wt % of sucrose; (b) from about 1 ppm to about 11,000 ppm of a steviol glycoside; (c) from about 0.05 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 0.01 wt % to about 1 wt % of one or more minerals selected from the group consisting of calcium, magnesium, potassium, sodium, iron, and a combination thereof; (e) from about 0.05 ppm to about 1600 ppm of one or more coloring agents; (f) from about 0.01 wt % to about 0.25 wt % of caffeine; and (g) from about 0.01 wt % to about 0.8 wt % of one or more acids selected from the group consisting of malic acid, tartaric acid, and a combination thereof; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of whey protein isolate (either animal whey protein or non-animal whey protein obtained from fermentation processes known in the art); about 0.02 wt % to about 0.2 wt % of vitamin D, vitamin E, or a combination thereof; from about 1.1 wt % to about 4.5 wt % of one or more electrolytes selected from the group consisting of sodium chloride, potassium citrate, sodium citrate, and a combination thereof; from about 5 wt % to about 15 wt % of soluble corn fiber; and from about 0.05 wt % to about 15 wt % of silicon dioxide; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of whey protein isolate (either non-animal whey protein obtained from fermentation processes known in the art or animal whey protein), wherein the protein comprises a mixture of protein isolate and protein hydrolysate that are present in the powder base in a weight ratio of about 80:20 to about 60:40 and wherein the protein isolate comprises one or more of: a) no more than 1.3 wt % potassium; b) no more than 0.50 wt % calcium, or c) no more than 0.60 wt % sodium; from about 0.02 wt % to about 0.2 wt % of one or more vitamins selected from the group consisting of vitamin A, vitamin B1, vitamin B2, vitamin B3, vitamin B5, vitamin B6, vitamin B8, vitamin B9, vitamin B12, vitamin C, vitamin D, vitamin E, vitamin K, and a combination thereof, from about 1.2 wt % to about 4 wt % of one or more electrolytes selected from the group consisting of sodium chloride, potassium citrate, sodium citrate, and a combination thereof, from about 5 wt % to about 10 wt % of soluble corn fiber; from about 0.05 wt % to about 1.5 wt % of silicon dioxide; and one or more of the following: (a) from about 1 wt % to about 80 wt % sucrose, and a combination thereof, (b) from about 300 ppm to about 9,000 ppm of a steviol glycoside; (c) from about 0.1 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 0.01 wt % to about 1 wt % of one or more minerals selected from the group consisting of calcium, magnesium, potassium, sodium, iron, and a combination thereof; (e) from about 0.05 ppm to about 1600 ppm of one or more coloring agents; (f) from about 0.05 wt % to about 0.0 wt % of caffeine; and (g) from about 0.05 wt % to about 0.7 wt % of one or more acids selected from the group consisting of malic acid, tartaric acid, and a combination thereof; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of whey protein isolate (either animal whey protein or non-animal whey protein obtained from fermentation processes known in the art); about 0.04 wt % to about 0.1 wt % of vitamin D, vitamin E, or a combination thereof, from about 1.2 wt % to about 4 wt % of one or more electrolytes selected from the group consisting sodium chloride, potassium citrate, sodium citrate, and a combination thereof; from about 5 wt % to about 10 wt % of soluble corn fiber; and from about 0.1 wt % to about 1 wt % of silicon dioxide; wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of whey protein isolate (either non-animal whey protein obtained from fermentation processes known in the art or animal whey protein), wherein the protein comprises a mixture of protein isolate and protein hydrolysate that are present in the powder base in a 70:30 weight ratio; about 0.04 wt % to about 0.1 wt % of vitamin D, vitamin E, or a combination thereof, from about 1.2 wt % to about 4 wt % of one or more electrolytes selected from the group consisting of sodium chloride, potassium citrate, sodium citrate, and a combination thereof, from about 5 wt % to about 10 wt % of soluble corn fiber; from about 0.1 wt % to about 1 wt % of silicon dioxide; and one or more of the following: (a) from about 5 wt % to about 75 wt % sucrose; (b) from about 600 ppm to about 7,500 ppm of a steviol glycoside; (c) from about 0.2 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1 wt % to about 0.6 wt % of one or more minerals selected from the group consisting of calcium, magnesium, potassium, sodium, iron, and a combination thereof, (e) from about 10 ppm to about 500 ppm of one or more coloring agents; (f) from about 0.1 wt % to about 0.15 wt % of caffeine; and (g) from about 0.05 wt % to about 0.7 wt % of one or more acids selected from the group consisting of malic acid, tartaric acid, and a combination thereof; wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein; from about 1 wt % to about 5 wt % of one or more electrolytes; from about 5 wt % to about 20 wt % of soluble fiber; and from about 0.01 wt % to about 2 wt % of one or more flow agents; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein; from about 1 wt % to about 5 wt % of one or more electrolytes; from about 5 wt % to about 20 wt % of soluble fiber; from about 0.01 wt % to about 2 wt % of one or more flow agents; and one or more of the following: (a) from about 0.01 wt % to about 80 wt % of a nutritive sweetener; (b) from about 1 ppm to about 11,000 ppm of a non-nutritive sweetener; (c) from about 0.05 wt % to about 3 wt % of a flavoring agent; (d) from about 0.01 wt % to about 1 wt % of one or more minerals; (e) from about 0.05 ppm to about 1600 ppm of one or more coloring agents; (f) from about 0.01 wt % to about 0.25 wt % of caffeine; and (g) from about 0.01 wt % to about 0.8 wt % of one or more acids; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; from about 1 wt % to about 5 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 5 wt % to about 20 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.01 wt % to about 2 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof, wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof wherein the protein comprises a mixture of protein isolate and protein hydrolysate that are present in the powder base in a weight ratio ranging from about 90:10 to about 30:70, wherein the protein isolate comprises one or more of: a) no more than 1.3 wt % potassium; b) no more than 0.50 wt % calcium, or c) no more than 0.60 wt % sodium; from about 1 wt % to about 5 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 5 wt % to about 20 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.01 wt % to about 2 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof, and one or more of the following: (a) from about 0.01 wt % to about 80 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, coupling sugars, tagatose, soybean oligosaccharides, and a combination thereof, (b) from about 1 ppm to about 11,000 ppm of a non-nutritive sweetener aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof. In some aspects, the powder base comprises a non-nutritive sweetener selected from the group consisting of aspartame, acesulfame potassium, sucralose, erythritol, xylitol, a steviol glycoside, and a combination thereof; (c) from about 0.05 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.01 wt % to about 1 wt % of one or more minerals selected from the group consisting calcium, magnesium, potassium, sodium, iron, and a combination thereof, (e) from about 0.05 ppm to about 1600 ppm of one or more coloring agents; (f) from about 0.01 wt % to about 0.25 wt % of caffeine; and (g) from about 0.01 wt % to about 0.8 wt % of one or more acids selected from the group consisting of ascorbic acid, citric acid, lactic acid, malic acid, tartaric acid, and a combination thereof; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; from about 1.1 wt % to about 4.5 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof; from about 5 wt % to about 15 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.05 wt % to about 15 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds

In some aspects, the present disclosure provides a powder base comprising from about 45 wt % to about 75 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof wherein the protein comprises a mixture of protein isolate and protein hydrolysate that are present in the powder base in a weight ratio ranging from about 80:20 to about 40:60 and wherein the protein isolate comprises one or more of: a) no more than 1.3 wt % potassium; b) no more than 0.50 wt % calcium, or c) no more than 0.60 wt % sodium; from about 1.2 wt % to about 4 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 5 wt % to about 10 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.05 wt % to about 1.5 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof, and one or more of the following: (a) from about 1 wt % to about 80 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, coupling sugars, tagatose, soybean oligosaccharides, and a combination thereof, (b) from about 300 ppm to about 9,000 ppm of a non-nutritive sweetener aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof. In some aspects, the powder base comprises a non-nutritive sweetener selected from the group consisting of aspartame, acesulfame potassium, sucralose, erythritol, xylitol, a steviol glycoside, and a combination thereof; (c) from about 0.1 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.01 wt % to about 1 wt % of one or more minerals selected from the group consisting calcium, magnesium, potassium, sodium, iron, and a combination thereof, (e) from about 0.05 ppm to about 1600 ppm of one or more coloring agents; (f) from about 0.05 wt % to about 0.0 wt % of caffeine; and (g) from about 0.05 wt % to about 0.7 wt % of one or more acids selected from the group consisting of ascorbic acid, citric acid, lactic acid, malic acid, tartaric acid, and a combination thereof; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of protein selected from the group consisting of collagen, whey protein, wheat protein (either non-animal whey protein obtained from fermentation processes known in the art or animal whey protein), rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof; from about 1.2 wt % to about 4 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof; from about 5 wt % to about 10 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof, and from about 0.1 wt % to about 1 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof, wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of protein selected from the group consisting of collagen, whey protein (either non-animal whey protein obtained from fermentation processes known in the art or animal whey protein), wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, and a combination thereof wherein the protein comprises a mixture of protein isolate and protein hydrolysate that are present in the powder base in a 70:30 weight ratio and wherein the protein isolate comprises one or more of: a) no more than 1.3 wt % potassium; b) no more than 0.50 wt % calcium, or c) no more than 0.60 wt % sodium; from about 1.2 wt % to about 4 wt % of one or more electrolytes selected from the group consisting sodium bicarbonate, calcium carbonate, potassium carbonate, sodium chloride, potassium chloride, calcium chloride, potassium citrate, sodium citrate, magnesium citrate, magnesium oxide, sodium gluconate, potassium gluconate, sodium phosphate, potassium phosphate, and a combination thereof, from about 5 wt % to about 10 wt % of soluble fiber selected from the group consisting of Bacillus coagulans sodium, calcium polycarbophil, fructo-oligosaccharides, inulin, methylcellulose, polydextrose, psyllium husk, soluble corn fiber, oat, barley, fruit pectin, and a combination thereof; and from about 0.1 wt % to about 1 wt % of one or more flow agents selected from the group consisting of silicon dioxide, colloidal silica, calcium silicate, magnesium carbonate, sodium aluminum phosphate, calcium phosphate, calcium carbonate, talc, tricalcium phosphate, and a combination thereof; and one or more of the following: (a) from about 5 wt % to about 75 wt % of a nutritive sweetener selected from the group consisting of sucrose, fructose, glucose, erythritol, maltitol, lactitol, sorbitol, mannitol, xylitol, D-tagatose, trehalose, galactose, rhamnose, cyclodextrin (e.g., α-cyclodextrin, β-cyclodextrin, and λ-cyclodextrin), ribulose, threose, arabinose, xylose, lyxose, allose, allulose, altrose, mannose, idose, lactose, maltose, invert sugar, isotrehalose, neotrehalose, palatinose or isomaltulose, maltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, xylo-oligosaccharides (xylotriose, xylobiose and the like), gentio-oligoscaccharides (gentiobiose, gentiotriose, gentiotetraose and the like), galacto-oligosaccharides, sorbose, nigerooligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, coupling sugars, tagatose, soybean oligosaccharides, and a combination thereof; (b) from about 600 ppm to about 7,500 ppm of a non-nutritive sweetener aspartame, acesulfame potassium, sucralose, erythritol, xylitol, a steviol glycoside, monk fruit, Luo Han Guo sweetener, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, and a combination thereof. In some aspects, the powder base comprises a non-nutritive sweetener selected from the group consisting of aspartame, acesulfame potassium, sucralose, erythritol, xylitol, a steviol glycoside, and a combination thereof, (c) from about 0.2 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1 wt % to about 0.6 wt % of one or more minerals selected from the group consisting calcium, magnesium, potassium, sodium, iron, and a combination thereof, (e) from about 10 ppm to about 500 ppm of one or more coloring agents; (f) from about 0.1 wt % to about 0.15 wt % of caffeine; and (g) from about 0.05 wt % to about 0.7 wt % of one or more acids selected from the group consisting of ascorbic acid, citric acid, lactic acid, malic acid, tartaric acid, and a combination thereof, wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein selected from the group consisting of collagen, pea protein, rice protein, whey protein isolate (either non-animal whey protein obtained from fermentation processes known in the art or animal whey protein), and a combination thereof, from about 1 wt % to about 5 wt % of one or more electrolytes selected from the group consisting potassium chloride, sodium chloride, potassium citrate, sodium citrate, and a combination thereof; from about 5 wt % to about 20 wt % of soluble corn fiber; and from about 0.01 wt % to about 2 wt % of silicon dioxide; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of protein selected from the group consisting of collagen, pea protein, rice protein, whey protein isolate (either non-animal whey protein obtained from fermentation processes known in the art or animal whey protein), and a combination thereof wherein the protein comprises a mixture of protein isolate and protein hydrolysate that are present in the powder base in a weight ratio ranging from about 90:10 to about 30:70 and wherein the protein isolate comprises one or more of: a) no more than 1.3 wt % potassium; b) no more than 0.50 wt % calcium, or c) no more than 0.60 wt % sodium; from about 1 wt % to about 5 wt % of one or more electrolytes selected from the group consisting potassium chloride, sodium chloride, potassium citrate, sodium citrate, and a combination thereof, from about 5 wt % to about 20 wt % of soluble corn fiber; from about 0.01 wt % to about 2 wt % of silicon dioxide; and one or more of the following: (a) from about 0.01 wt % to about 80 wt % of a nutritive sweetener selected from the group consisting of allulose, fructose, galactose, glucose, lactose, maltose, maltulose, sucrose, and a combination thereof, (b) from about 1 ppm to about 11,000 ppm of a non-nutritive sweetener selected from the group consisting of aspartame, acesulfame potassium, sucralose, erythritol, xylitol, a steviol glycoside, and a combination thereof; (c) from about 0.05 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.01 wt % to about 1 wt % of one or more minerals selected from the group consisting calcium, magnesium, potassium, sodium, iron, and a combination thereof, (e) from about 0.05 ppm to about 1600 ppm of one or more coloring agents; (f) from about 0.01 wt % to about 0.25 wt % of caffeine; and (g) from about 0.01 wt % to about 0.8 wt % of one or more acids selected from the group consisting of malic acid, tartaric acid, and a combination thereof; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of protein selected from the group consisting of collagen, pea protein, rice protein, whey protein isolate (either non-animal whey protein obtained from fermentation processes known in the art or animal whey protein), and a combination thereof, from about 1.1 wt % to about 4.5 wt % of one or more electrolytes selected from the group consisting potassium chloride, sodium chloride, potassium citrate, sodium citrate, and a combination thereof: from about 5 wt % to about 15 wt % of soluble corn fiber; and from about 0.05 wt % to about 15 wt % of silicon dioxide; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of protein selected from the group consisting of collagen, pea protein, rice protein, whey protein isolate (either non-animal whey protein obtained from fermentation processes known in the art or animal whey protein), and a combination thereof wherein the protein comprises a mixture of protein isolate and protein hydrolysate that are present in the powder base in a weight ratio ranging from about 80:20 to about 40:60 and wherein the protein isolate comprises one or more of: a) no more than 1.3 wt % potassium; b) no more than 0.50 wt % calcium, or c) no more than 0.60 wt % sodium; from about 1.2 wt % to about 4 wt % of one or more electrolytes selected from the group consisting potassium chloride, sodium chloride, potassium citrate, sodium citrate, and a combination thereof, from about 5 wt % to about 10 wt % of soluble corn fiber; from about 0.05 wt % to about 1.5 wt % of silicon dioxide; and one or more of the following: (a) from about 1 wt % to about 80 wt % of a nutritive sweetener selected from the group consisting of allulose, fructose, galactose, glucose, lactose, maltose, maltulose, sucrose, and a combination thereof, (b) from about 300 ppm to about 9,000 ppm of a non-nutritive sweetener selected from the group consisting of aspartame, acesulfame potassium, sucralose, erythritol, xylitol, a steviol glycoside, and a combination thereof; (c) from about 0.1 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.01 wt % to about 1 wt % of one or more minerals selected from the group consisting calcium, magnesium, potassium, sodium, iron, and a combination thereof, (e) from about 0.05 ppm to about 1600 ppm of one or more coloring agents; (f) from about 0.05 wt % to about 0.0 wt % of caffeine; and (g) from about 0.05 wt % to about 0.7 wt % of one or more acids selected from the group consisting of malic acid, tartaric acid, and a combination thereof; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of protein selected from the group consisting of collagen, pea protein, rice protein, whey protein isolate (either animal whey protein or non-animal whey protein obtained from fermentation processes known in the art); from about 1.2 wt % to about 4 wt % of one or more electrolytes selected from the group consisting potassium chloride, sodium chloride, potassium citrate, sodium citrate, and a combination thereof, from about 5 wt % to about 10 wt % of soluble corn fiber; and from about 0.1 wt % to about 1 wt % of silicon dioxide; wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of protein selected from the group consisting of collagen, pea protein, rice protein, whey protein isolate (either non-animal whey protein obtained from fermentation processes known in the art or animal whey protein), and a combination thereof wherein the protein comprises a mixture of protein isolate and protein hydrolysate that are present in the powder base in a 70:30 weight ratio and wherein the protein isolate comprises one or more of: a) no more than 1.3 wt % potassium; b) no more than 0.50 wt % calcium, or c) no more than 0.60 wt % sodium; from about 1.2 wt % to about 4 wt % of one or more electrolytes selected from the group consisting potassium chloride, sodium chloride, potassium citrate, sodium citrate, and a combination thereof, from about 5 wt % to about 10 wt % of soluble corn fiber; from about 0.1 wt % to about 1 wt % of silicon dioxide; and one or more of the following: (a) from about 5 wt % to about 75 wt % of a nutritive sweetener selected from the group consisting of allulose, fructose, galactose, glucose, lactose, maltose, maltulose, sucrose, and a combination thereof, (b) from about 600 ppm to about 7,500 ppm of a non-nutritive sweetener aspartame, acesulfame potassium, sucralose, erythritol, xylitol, a steviol glycoside, and a combination thereof, (c) from about 0.2 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1 wt % to about 0.6 wt % of one or more minerals selected from the group consisting calcium, magnesium, potassium, sodium, iron, and a combination thereof, (e) from about 10 ppm to about 500 ppm of one or more coloring agents; (f) from about 0.1 wt % to about 0.15 wt % of caffeine; and (g) from about 0.05 wt % to about 0.7 wt % of one or more acids selected from the group consisting of malic acid, tartaric acid, and a combination thereof; wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of whey protein isolate (either animal whey protein or non-animal whey protein obtained from fermentation processes known in the art); from about 1 wt % to about 5 wt % of one or more electrolytes selected from the group consisting potassium chloride, sodium chloride, potassium citrate, sodium citrate, or a combination there; from about 5 wt % to about 20 wt % of soluble corn fiber; and from about 0.01 wt % to about 2 wt % of silicon dioxide; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 40 wt % to about 80 wt % of whey protein isolate (either non-animal whey protein obtained from fermentation processes known in the art or animal whey protein), wherein the protein comprises a mixture of protein isolate and protein hydrolysate that are present in the powder base in a weight ratio ranging from about 90:10 to about 30:70 and wherein the protein isolate comprises one or more of: a) no more than 1.3 wt % potassium; b) no more than 0.50 wt % calcium, or c) no more than 0.60 wt % sodium; from about 1 wt % to about 5 wt % of one or more electrolytes selected from the group consisting potassium chloride, sodium chloride, potassium citrate, sodium citrate, and a combination thereof; from about 5 wt % to about 20 wt % of soluble corn fiber; from about 0.01 wt % to about 2 wt % of silicon dioxide; and one or more of the following: (a) from about 0.01 wt % to about 80 wt % of sucrose; (b) from about 1 ppm to about 11,000 ppm of a steviol glycoside; (c) from about 0.05 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 0.01 wt % to about 1 wt % of one or more minerals selected from the group consisting calcium, magnesium, potassium, sodium, iron, and a combination thereof, (e) from about 0.05 ppm to about 1600 ppm of one or more coloring agents; (f) from about 0.01 wt % to about 0.25 wt % of caffeine; and (g) from about 0.01 wt % to about 0.8 wt % of one or more acids selected from the group consisting of malic acid, tartaric acid, and a combination thereof; wherein when the powder is added to water, the resulting mixture provides a beverage having a turbidity of less than 100 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of whey protein isolate (either animal whey protein or non-animal whey protein obtained from fermentation processes known in the art); from about 1.1 wt % to about 4.5 wt % of one or more electrolytes selected from the group consisting sodium chloride, potassium citrate, sodium citrate, and a combination thereof; from about 5 wt % to about 15 wt % of soluble corn fiber; and from about 0.05 wt % to about 15 wt % of silicon dioxide; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 45 wt % to about 75 wt % of whey protein isolate (either non-animal whey protein obtained from fermentation processes known in the art or animal whey protein), wherein the protein comprises a mixture of protein isolate and protein hydrolysate that are present in the powder base in a weight ratio of about 80:20 to about 60:40 and wherein the protein isolate comprises one or more of: a) no more than 1.3 wt % potassium; b) no more than 0.50 wt % calcium, or c) no more than 0.60 wt % sodium; from about 1.2 wt % to about 4 wt % of one or more electrolytes selected from the group consisting sodium chloride, potassium citrate, sodium citrate, and a combination thereof, from about 5 wt % to about 10 wt % of soluble corn fiber; from about 0.05 wt % to about 1.5 wt % of silicon dioxide; and one or more of the following: (a) from about 1 wt % to about 80 wt % sucrose, and a combination thereof, (b) from about 300 ppm to about 9,000 ppm of a steviol glycoside; (c) from about 0.1 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof; (d) from about 0.01 wt % to about 1 wt % of one or more minerals selected from the group consisting calcium, magnesium, potassium, sodium, iron, and a combination thereof, (e) from about 0.05 ppm to about 1600 ppm of one or more coloring agents; (f) from about 0.05 wt % to about 0.0 wt % of caffeine; and (g) from about 0.05 wt % to about 0.7 wt % of one or more acids selected from the group consisting of malic acid, tartaric acid, and a combination thereof; wherein when the powder is added to water, the resulting mixture provides a beverage having a turbidity of less than 98 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of whey protein isolate (either animal whey protein or non-animal whey protein obtained from fermentation processes known in the art); from about 1.2 wt % to about 4 wt % of one or more electrolytes selected from the group consisting sodium chloride, potassium citrate, sodium citrate, and a combination thereof; from about 5 wt % to about 10 wt % of soluble corn fiber; and from about 0.1 wt % to about 1 wt % of silicon dioxide; wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

In some aspects, the present disclosure provides a powder base comprising from about 50 wt % to about 70 wt % of whey protein isolate (either non-animal whey protein obtained from fermentation processes known in the art or animal whey protein), wherein the protein comprises a mixture of protein isolate and protein hydrolysate that are present in the powder base in a 70:30 weight ratio; from about 1.2 wt % to about 4 wt % of one or more electrolytes selected from the group consisting sodium chloride, potassium citrate, sodium citrate, and a combination thereof, from about 5 wt % to about 10 wt % of soluble corn fiber; from about 0.1 wt % to about 1 wt % of silicon dioxide; and one or more of the following: (a) from about 5 wt % to about 75 wt % sucrose; (b) from about 600 ppm to about 7,500 ppm of a steviol glycoside; (c) from about 0.2 wt % to about 3 wt % of a flavoring agent selected from the group consisting of apple flavor, apricot flavor, banana flavor, berry flavor, black cherry flavor, black currant flavor, blackberry flavor, blood orange flavor, blueberry flavor, boysenberry flavor, cantaloupe flavor, cherry flavor, citrus flavor, cranberry flavor, cucumber flavor, dragonfruit flavor, elderberry flavor, grape flavor, guava flavor, honeydew flavor, huckleberry flavor, jackfruit flavor, lemon flavor, lime flavor, mango flavor, monk fruit flavor, nectarine flavor, orange flavor, passion fruit flavor, papaya flavor, peach flavor, pear flavor, pineapple flavor, plum flavor, pomegranate flavor, raspberry flavor, strawberry flavor, vanilla flavor, mint flavor, ginger flavor, basil flavor, lemon flavor, vinegar flavor, peach flavor, watermelon flavor, and a combination thereof, (d) from about 0.1 wt % to about 0.6 wt % of one or more minerals selected from the group consisting calcium, magnesium, potassium, sodium, iron, and a combination thereof, (e) from about 10 ppm to about 500 ppm of one or more coloring agents; (f) from about 0.1 wt % to about 0.15 wt % of caffeine; and (g) from about 0.05 wt % to about 0.7 wt % of one or more acids selected from the group consisting of malic acid, tartaric acid, and a combination thereof, wherein when the powder is added to water, the resulting mixture provides a beverage having a turbidity of less than 96 NTUs and/or an absorbance of less than 0.1 at 600 nm wavelength, when about 20 g to about 40 g of the powder is added to about 500 mL and shaken for at least 15 seconds.

### Methods of the Disclosure

### Methods of Preparing Vitamin Nanoemulsions

In certain aspects, the beverages described herein comprise nanoemulsions of fat soluble vitamins. Without being bound by a particular theory, it is thought that smaller particle sizes are more bioavailable and increase absorption of the vitamins they contain.

In some aspects, the nanoemulsions are prepared by combining one or more vitamins with MCT and one or more surfactants, then homogenizing the resulting mixture and diluting in water while heating. Once the water is added the mixture can spontaneously emulsify to create small particles sizes that provide a transparent emulsion.

In some aspects, the surfactants used in the nanoemulsion are selected from the group consisting of polysorbate 20, polysorbate 40, polysorbate 60, polysorbate 80, propylene glycol, and a combination thereof. In some aspects, the surfactants are selected from the group consisting of polysorbate 60, propylene glycol, and a combination thereof. Without being bound by a particular theory, the use of the propylene glycol facilitates the self-emulsification process without the need for additional high shear mixing. In some aspects, the amount of propylene glycol in the oil phase can be from about 10 wt % to about 40 wt %. In some aspects, the amount of propylene glycol in the oil phase can be from about 20 wt % to about 30 wt %. In some aspects, the amount of propylene glycol in the oil phase can be from about 22 wt % to about 28 wt %. In some aspects, the amount of propylene glycol in the oil phase can be about 25 wt % to about 26 wt %. In some aspects, the amount of propylene glycol in the oil phase can be about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, or about 40 wt %.

In some aspects, the nanoemulsion comprises about 40 wt % to about 80 wt % of polysorbate 20, polysorbate 40, polysorbate 60, polysorbate 80, propylene glycol, or a combination thereof. In some aspects, the nanoemulsion comprises about 50 wt % to about 70 wt % of polysorbate 20, polysorbate 40, polysorbate 60, polysorbate 80, propylene glycol, or a combination thereof. In some aspects, the nanoemulsion comprises about 55 wt % to about 65 wt % of polysorbate 20, polysorbate 40, polysorbate 60, polysorbate 80, propylene glycol, or a combination thereof. In some aspects, the nanoemulsion comprises about 55 wt % to about 65 wt % of polysorbate 60.

In some aspects, the amount of vitamins in the oil phase can be from about 10 wt % to about 20 wt %. In some aspects, the amount of vitamins in the oil phase can be from about 12 wt % to about 18 wt %. In some aspects, the amount of vitamins in the oil phase can be from about 14 wt % to about 16 wt %.

In some aspects, after self-emulsification, the nanoemulsion has a particle size distribution: D90 of not more than 30 nm. In some aspects, the nanoemulsion has a particle size distribution: D90 of not more than 25 nm. In some aspects, the nanoemulsion has a particle size distribution: D90 of not more than 20 nm. In some aspects, the nanoemulsion has a particle size distribution: D90 of not more than 20 nm, 21 nm, 22 nm, 23 nm, 24 nm, 25 nm, 26 nm, 27 nm, 28 nm, 29 nm, or 30 nm.

### Methods of Preventing Muscle Mass Loss

In certain aspects, the present disclosure provides a method of preventing muscle mass loss in a subject taking a GLP-1 receptor agonist. In some aspects, the method comprises administering to the subject an effective amount of a beverage described herein. Without being bound by a particular theory, the presence of the hydrolyzed protein in the beverages described herein is thought to provide easier digestion, which can be advantageous to consumers taking a GLP-1 RA who often have smaller appetites. In addition, the beverages described herein are thought to be lighter and more refreshing to the consumer. In some aspects, the GLP-1 receptor agonist is selected from the group consisting of dulaglutide, exenatide, liraglutide, semaglutide, tirzepatide, survodutide, mazdutide, retatrutide, maridebart cafraglutide, and a combination thereof. In some aspects, the GLP-1 receptor agonist is selected from the group consisting of liraglutide, semaglutide, tirzepatide, and a combination thereof.

In some aspects, the effective amount of the beverage is from about 350 mL to about 3000 mL. In some aspects, the effective amount of the beverage is from about 400 mL to about 2500 mL. In some aspects, the effective amount of the beverage is from about 450 mL to about 2000 mL. In some aspects, the effective amount of the beverage is from about 500 mL to about 1500 mL. In certain aspects the effective amount of the beverage is provided in a single dose. In some aspects, the single dose does not exceed 500 mL. In some aspects, the single dose does not exceed 450 mL. In some aspects, the single dose does not exceed 400 mL. In some aspects, the single dose does not exceed 350 mL. In some aspects, the single dose does not exceed 300 mL. In some aspects, the single dose does not exceed 250 mL. In some aspects, the single dose does not exceed 200 mL. In some aspects, the single dose does not exceed 150 mL. In some aspects, the effective amount of the beverage is provided as a series of divided doses. In some aspect, each divided dose does not exceed 500 mL. In some aspects, the divided dose does not exceed 450 mL. In some aspects, the divided dose does not exceed 400 mL. In some aspects, the divided dose does not exceed 350 mL. In some aspects, the divided dose does not exceed 300 mL. In some aspects, the divided dose does not exceed 250 mL. In some aspects, the divided dose does not exceed 200 mL. In some aspects, the divided dose does not exceed 150 mL.

In some aspects, the beverage is supplemented with an additional protein source. In some aspects, the additional protein source comprises collagen, whey protein, wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, or a combination thereof. In some aspects, the additional protein source comprises at least one protein and at least one additional nutritive agent. In some aspects the additional nutritive agent comprises a fat, a nutritional sweetener, a mineral, a vitamin, or a combination thereof.

### Methods of Providing Nutrition

In certain aspects, the present disclosure provides a method of providing nutrition to a subject taking a GLP-1 receptor agonist. In some aspects, the GLP-1 receptor agonist is selected from the group consisting of dulaglutide, exenatide, liraglutide, semaglutide, tirzepatide, survodutide, mazdutide, retatrutide, maridebart cafraglutide, and a combination thereof. In some aspects, the GLP-1 receptor agonist is selected from the group consisting of liraglutide, semaglutide, tirzepatide, and a combination thereof. In some aspects, the method comprises administering to the subject an effective amount of a beverage described herein. Without being bound by a particular theory, the presence of the nanoemulsion comprising the one or more vitamins in the beverages described herein is thought to provide better bioavailability of the vitamins, which can be advantageous to consumers taking a GLP-1 RA who often have smaller appetites and consume fewer nutrients. In some aspects, the beverage comprises from about 10% to about 200% of the daily value (DV) of the one or more vitamins. The “daily value” of a particular vitamin is the recommended amount of that vitamin that should be consumed each day as determined by the U.S. Food and Drug Administration. In some aspects, the beverage comprises from about 20% DV to about 175% DV of the one or more vitamins. In some aspects, the beverage comprises from about 30% DV to about 150% DV of the one or more vitamins. In some aspects, the beverage comprises from about 40% DV to about 140% DV of the one or more vitamins. In some aspects, the beverage comprises from about 50% DV to about 130% DV of the one or more vitamins. In some aspects, the beverage comprises from about 60% DV to about 120% DV of the one or more vitamins. In some aspects, the beverage comprises from about 70% DV to about 110% DV of the one or more vitamins. In some aspects, the beverage comprises from about 75% DV to about 125% DV of the one or more vitamins. In some aspects, the beverage comprises from about 90% DV to about 110% DV of the one or more vitamins. In some aspects, the beverage comprises about 100% DV of the one or more vitamins. In some aspects, the beverage comprises about

In some aspects, the effective amount of the beverage is from about 350 mL to about 3000 mL. In some aspects, the effective amount of the beverage is from about 400 mL to about 2500 mL. In some aspects, the effective amount of the beverage is from about 450 mL to about 2000 mL. In some aspects, the effective amount of the beverage is from about 500 mL to about 1500 mL. In certain aspects the effective amount of the beverage is provided in a single dose. In some aspects, the single dose does not exceed 500 mL. In some aspects, the single dose does not exceed 450 mL. In some aspects, the single dose does not exceed 400 mL. In some aspects, the single dose does not exceed 350 mL. In some aspects, the single dose does not exceed 300 mL. In some aspects, the single dose does not exceed 250 mL. In some aspects, the single dose does not exceed 200 mL. In some aspects, the single dose does not exceed 150 mL. In some aspects, the effective amount of the beverage is provided as a series of divided doses. In some aspect, each divided dose does not exceed 500 mL. In some aspects, the divided dose does not exceed 450 mL. In some aspects, the divided dose does not exceed 400 mL. In some aspects, the divided dose does not exceed 350 mL. In some aspects, the divided dose does not exceed 300 mL. In some aspects, the divided dose does not exceed 250 mL. In some aspects, the divided dose does not exceed 200 mL. In some aspects, the divided dose does not exceed 150 mL.

In some aspects, the beverage is supplemented with an additional protein source. In some aspects, the additional protein source comprises collagen, whey protein, wheat protein, rice protein, maize protein, corn protein, oat protein, barley protein, rye protein, millet protein, sorghum protein, canola protein, hemp seed protein, pumpkin seed protein, sesame seed protein, sunflower seed protein, chia seed protein, cotton seed protein, soy protein, flax seed protein, pea protein, bean protein, chickpea protein, lentil protein, chicken protein, beef protein, marine protein, milk protein, casein, or a combination thereof. In some aspects, the additional protein source comprises at least one protein and at least one additional nutritive agent. In some aspects the additional nutritive agent comprises a fat, a nutritional sweetener, a mineral, a vitamin, or a combination thereof.

### GLP-1 Receptor Agonists

In certain aspects, the present disclosure provides a method of preventing muscle mass loss in a subject taking a GLP-1 receptor agonist. In some aspects, the GLP-1 receptor agonist is selected from the group consisting of dulaglutide, exenatide, liraglutide, semaglutide, tirzepatide, survodutide, mazdutide, retatrutide, maridebart cafraglutide, and a combination thereof.

In some aspects, the GLP-1 receptor agonist can be dulaglutide. In some aspects, dulaglutide can be administered to adults and children age 10 and over with type 2 diabetes mellitus. In some aspects, administration of dulaglutide can cause weight loss. In some aspects, dulaglutide can be administered for weight loss. In some aspects, 0.75 mg of dulaglutide can be administered subcutaneously once weekly. In some aspects, the dosage can be increased after four weeks to 1.5 mg once weekly. In some aspects, if additional glycemic control is needed, the dosage can be increased in 1.5 mg increments every four weeks. In some aspects, the maximum dosage is 4.5 mg once weekly. In some aspects, dulaglutide can be administered with our without food.

In some aspects, the GLP-1 receptor agonist can be exanatide. In some aspects, exanatide can be administered to adults with type 2 diabetes mellitus. In some aspects, administration of exanatide can cause weight loss. In some aspects, exanatide can be administered for weight loss. In some aspects, 5 micrograms of exanatide can be administered subcutaneously twice daily. In some aspects, the dosage can be increased after one month to 10 micrograms twice daily. In some aspects, exanatide can be administered within 60 minutes of a morning and evening meal can be consumed at least six hours apart. In some aspects, exanatide is not administered after a meal.

In some aspects, the GLP-1 receptor agonist can be extended-release exanatide. In some aspects, extended-release exanatide can be administered to adults or children age 10 and older with type 2 diabetes mellitus. In some aspects, administration of extended-release exanatide can cause weight loss. In some aspects, extended-release exanatide can be administered for weight loss. In some aspects, 2 micrograms of extended-release exanatide can be administered subcutaneously once weekly. In some aspects, extended-release exanatide can be administered at any time of day. In some aspects, extended-release exanatide can be administered with a meal. In some aspects, extended-release exanatide can be administered without a meal.

In some aspects, the GLP-1 receptor can be liraglutide. In some aspects, luraglutide can be administered to obese adults or to overweight adults with at least one weight-related comorbid condition. In some aspects, 0.6 mg liraglutide can be administered subcutaneously once per day for one week. In some aspects, the dose can be increased weekly until a dose of 3 mg is reached. In some aspects, luraglutide can be administered to obese children age 12 and over. In some aspects, 0.6 mg liraglutide can be administered subcutaneously once per day for one week. In some aspects, the dose can be increased weekly until a dose of 3 mg is reached. In some aspects, if the 3 mg dose is not tolerated, the dose can be reduced to 2.4 mg. In some aspects, liraglutide can be administered with a meal. In some aspects, liraglutide can be administered without a meal.

In some aspects, the GLP-1 receptor can be semaglutide. In some aspects, semaglutide can be administered to adults with type 2 diabetes mellitus. In some aspects, semaglutide can be administered to adults with established cardiovascular disease who are either obese or overweight. In some aspects, semaglutide can be administered to adults or children age 12 and older who are obese. In some aspects, semaglutide can be administered to overweight adults with at least one weight-related comorbid condition.

In some aspects, semaglutide can be administered orally. In some aspects, semaglutide can be administered as a tablet. In some aspects, 3 mg of semaglutide can be administered orally once daily for 30 days. In some aspects, the dosage can be increased after 30 days to 7 mg once daily. In some aspects the dosage can be increased again after 30 days to 14 mg once daily. In some aspects, 1.5 mg of semaglutide can be administered orally once daily for 30 days. In some aspects, the dosage can be increased after 30 days to 4 mg once daily. In some aspects the dosage can be increased again after 30 days to 9 mg once daily. In some aspects, semaglutide can be taken at least 30 minutes before food or beverage consumption. In some aspects, semaglutide can be taken at least 30 minutes before other medications are taken.

In some aspects, semaglutide can be administered subcutaneously. In some aspects, 0.25 mg of semaglutide can be administered subcutaneously once per week. In some aspects, after four weeks, the dosage can be increased to 0.5 mg once daily. In some aspects, after an additional four weeks, the dosage can be increased to 1 mg once weekly. In some aspects, after yet an additional four weeks, the dosage can be increased to 1.7 mg or 2 mg once weekly. In some aspects, semaglutide can be administered with a meal. In some aspects, semaglutide can be administered without a meal.

In some aspects, the GLP-1 receptor agonist can be tirzepatide. In some aspects, tirzepatide can be administered to adults with type 2 diabetes mellitus. In some aspects, tirzepatide can be administered to obese adults or overweight adults with at least one weight-related comorbid condition. In some aspects, tirzepatide can be administered to obese adults with at least one weight-related comorbid condition. In some aspects, 2.5 mg of tirzaepatide can be administered subcutaneously. In some aspects, after four weeks the dosage can be increased to 5 mg once weekly. In some aspects, the dosage can be increased every four weeks by 2.5 mg increments. In some aspects, the maximum dosage can be 15 mg weekly. In some aspects, tirzepatide can be administered with a meal. In some aspects, tirzepatide can be administered without a meal.

In some aspects, the GLP-1 receptor agonist can be survotide, mazdutide, maridebart/cafraglutide, or retatrutide.

### EXAMPLES

### Example 1: Preparation of Vitamin Nanoemulsion

Vitamin D and medium chain triglycerides (MCT) were incorporated into a mixture of vitamin E and polysorbate 60 at ambient temperature. To this mixture, propylene glycol (PG) was added, achieving a final composition of approximately vitamin E (13 wt %), vitamin D (0.022 wt %), polysorbate 60 (60 wt %), MCT (1% wt), and propylene glycol (26 wt %). The mixture was homogenized using an overhead mixer for 15 minutes at ambient temperature before being diluted in water at a 1:49 weight ratio (blend to water) at or above 120° F.

The particle size of the vitamin nanoemulsion was measured using a dynamic light scattering instrument (Malvern Zetasizer Nano-ZS). Particle size was determined from intensity-time fluctuations of a laser beam (633 nm) scattered from a sample at an angle of 173°. After the oil phase was dispersed in water at a 1:49 weight ratio (oil to water) for 15 min at or above 120° F., the resulting emulsion was cooled to ambient temperature before the measurement was taken. One mL of the emulsion was placed in a 12-mm o.d. square disposable polystyrene cuvette. Measurements were performed at 20° C. and each measurement was calculated as the average of 10 runs. The mean particle size (Z-average value) and D90 value (diameter below which 90% of the particles are found) were calculated from the particle size distribution.

The mean particle size (Z-average value) and D90 of three different emulsions prepared on three different days is shown below.

| Sample Number | Z-Average Value (nm) | D90 |
|---|---|---|
| 1 | 14.07 | 18.17 |
| 2 | 14.29 | 18.17 |
| 3 | 14.33 | 21.04 |

### Example 2-1: Preparation of High Acid Beverage 1 (Benchtop Scale)

Sodium chloride (10.17 g), potassium citrate (3.30 g), sodium citrate (3.91 g), whey protein isolate (461 g), whey protein hydrolysate (199 g), soluble corn fiber (92 g), and sucrose (232 g) were added into ambient deionized (DI) water (6,730 mL). These ingredients were mixed with an overhead mixer using a cross-blade impeller for about 10 minutes until fully dispersed and dissolved. Separately, stevia (0.618 g) was added into DI water (480 mL), heated above 140° F., and mixed until fully dissolved. The same process was repeated for vitamin nano-emulsions: a nanoemulsion containing Vitamin E and D (3.29 g) was added into DI water (about 480 mL), heated above 140° F. and mixed until fully dissolved. Both the stevia and vitamin solutions were then incorporated into the protein mixture.

Once all the ingredients were dispersed and dissolved, the pH of the batch was measured and adjusted to 3.3-3.4 using 25% (w/w) malic acid as needed. DI water was then added to give the final mixture a target volume of 10,630 mL.

The batched product was heat treated to simulate hot filling conditions on a production scale through a benchtop-scale heating element.

To heat treat and fill bottles on a benchtop scale, a Vorwerk Thermomix TM6 was employed as the heating element. This thermal treatment facilitated the hot filling of single bottles per formulation. The target thermal treatment was set at 95° C. for 30 seconds. The protein solution, not exceeding 750 mL in volume, was added to the Thermomix without a paddle attachment. The vessel lid was sealed, the temperature set to 120° C., and the stirring speed set to 2.5 to ensure product movement without scorching or excess foam generation. The time taken to reach 95° C. was monitored, typically taking 5-6 minutes. The temperature was periodically checked with a thermometer probe. Upon reaching 95° C., the Thermomix temperature setting was reduced to 98° C., and the sample was stirred for a total of 30-35 seconds. The heat-treated product was then immediately decanted into hot-fill compliant bottles, filled to eliminate headspace, capped, inverted for 30 seconds, and then placed in an ice bath.

### Example 2-2: Preparation of High Acid Beverage 2 (Lab Scale)

Sodium chloride (15.80 g), potassium citrate (6.08 g), sodium citrate (6.08 g), whey protein isolate (508 g), whey protein hydrolysate (219 g), and soluble corn fiber (202 g) were added into ambient deionized (DI) water (about 12,800 mL). These ingredients were mixed with an overhead mixer using a cross-blade impeller for about 10 minutes until fully dispersed and dissolved. Separately, stevia (3.20 g) was added into DI water (about 750 mL), heated above 140° F., and mixed until fully dissolved. The same process was repeated for vitamin nanoemulsions: nanoemulsion containing Vitamin E and D (3.63 g) was added to DI water (750 mL), heated above 140° F. and mixed until fully dissolved. Both the stevia and vitamin solutions were then incorporated into the protein mixture. Once all the ingredients were dispersed and dissolved, the pH of the batch was measured and adjusted to 3.3-3.4 using 25% (w/w) malic acid as needed. DI water was then added to give the final mixture a target volume of 16,344 mL. The batched product was heat treated to simulate hot filling conditions on a production scale through a lab scale hot filling unit.

To heat treat and fill bottles using a lab scale hot fill machine, the following method was used: The hot fill machine's internal heated water tank was first warmed to 95° C. while treated water was recirculated through the product line for 1-2 hours. Fresh treated water was then continuously fed through the product line for at least 15 minutes. The pump was then moved from the treated water to the raw product batching vessel. The raw product was peristaltically pumped through the hot water tank at a rate of 1.150 L/min to thermally process the product at 95° C. for 30 seconds. After allowing 2 liters of product to flow out without bottling to ensure pure processed product was exiting, the thermally treated product was dispensed into hot-fill compliant bottles, filled to overflow slightly, capped, inverted for 1 minute, and submerged in an ice bath.

### Example 3: Preparation of Low Acid Beverage

Whey protein isolate (4.7 wt %) and whey protein hydrolysate (1.1 wt %) were added into ambient deionized (DI) water (79.2 wt %), constituting approximately 85% of the total water required for the batch. These ingredients were mixed with an overhead mixer using a cross-blade impeller for about 10 minutes until fully dispersed and dissolved. Separately, stevia (0.027 wt %) was added into DI water (4.7 wt %), representing about 5% of the total water required, heated above 140° F., and mixed until fully dissolved. The same process was repeated for vitamin nanoemulsions: a nanoemulsion containing Vitamin E and D (0.03 wt %) was added into about 4.7 wt % DI water, heated above 140° F. and mixed until fully dissolved. Next, the remaining soluble corn fiber (0.82 wt %), sodium citrate (0.11 wt %), flavors (0.17 wt %), and the stevia and vitamin solutions were added to the protein batch tank and mixed for an additional 20 minutes, for a total of 30 minutes of mix time. Once all the ingredients were dispersed and dissolved, the pH of the batch was measured and DI water was used to bring the batch to the target weight of 8 kg. Final pH (7.0-7.4) was measured and recorded. The batched product was then heat treated using direct steam injection for 3 seconds at 292° F. The product was then filled into sterile bottles that had undergone an air/oxygen flush.

### Example 4: Preparation of Ready-to-Mix Beverage Powder Base

The ready-to-mix powder was blended on bench-top to simulate production scale ribbon blender conditions. Half of the formula amounts of whey protein isolate (10 g), whey protein hydrolysate (2.5 g), and soluble corn fiber (1.75 g) were loaded into a bench-top mixer and evenly distributed. Potassium chloride (0.12 g), sodium chloride (0.06 g), sodium citrate (0.36 g), stevia extract (0.11 g), silicon dioxide (0.05 g), and powder flavor ingredients (0.95 g) were then loaded into the mixer followed by the remaining half of the amounts of whey protein isolate (10 g), whey protein hydrolysate (2.5 g), and soluble corn fiber (1.75 g). The batch was blended for 15 minutes to achieve a homogenous mixture. The mixture was then hand-filled into sachets by weight.

### Example 5: Preparation of Beverage from Ready-to-Mix Powder Base

Water (500 mL, 16.9 fl oz) was poured into a shaker bottle. A single serving (30 g) of powder (as prepared in Example 4) was then added, the bottle was capped, and the mixture was shaken for 1 minute until it was homogenous. The mixture was then allowed to sit for 5 minutes to allow foaming to settle. The pH of the finished batch was measured and recorded (pH 7.0-7.4)).

### Example 6: Determination of Beverage Turbidity

A TL2360 Turbidimeter from Hach was used to measure turbidity of the samples in Nephelometric Turbidity Units (NTUs). The phrase “NTU” as used herein refers to Nephelometric Turbidity Units. For a given sample, turbidity in NTUs can be measured at 20±2° C. using a Hach 2100AN Turbidimeter. The instrument can be calibrated using a STABLCAL Calibration Kit including samples having turbidities ranging from 0.1 NTU to 7500 NTU. Test samples can be measured in a Turbidimeter glass vial and NTU values can be read after a 30 second stabilization period. Also, a UV/vis spectrophotometer was used to measure absorbance values of the samples at 600 nm. Example 2-1 had a turbidity measurement of 96 NTU and an absorbance of 0.0716.

### Example 7: Protein Combination Turbidity Studies

Sample ready-to-mix powders containing mixtures of proteins sourced from different manufacturers (Protein Source A, Protein Source B, and Protein Source C) were prepared as described below.

Sample Powder 7A

| Description | Amount (g) | Weight % |
|---|---|---|
| WHEY PROTEIN ISOLATE (PROTEIN SOURCE A) | 20.90 | 74.66 |
| MALTODEXTRIN DIGESTION RESISTANT FIBER | 3.50 | 12.50 |
| WHEY PROTEIN HYDROLYSATE | 2.32 | 8.30 |
| FLAVOR POWDER | 0.69 | 2.46 |
| SODIUM CHLORIDE AND SODIUM CITRATE | 0.32 | 1.15 |
| OTHER AGENTS | 0.26 | 0.93 |

Sample Powder 7B

| Description | Amount (g) | Weight % |
|---|---|---|
| WHEY PROTEIN ISOLATE (PROTEIN SOURCE B) | 10.45 | 37.33 |
| WHEY PROTEIN ISOLATE (PROTEIN SOURCE A) | 10.45 | 37.33 |
| MALTODEXTRIN DIGESTION RESISTANT FIBER | 3.40 | 12.14 |
| WHEY PROTEIN HYDROLYSATE | 2.32 | 8.30 |
| FLAVOR POWDER | 0.69 | 2.46 |
| SODIUM CHLORIDE AND SODIUM CITRATE | 0.44 | 1.59 |
| OTHER AGENTS | 0.24 | 0.85 |

Sample Powder 7C

| Description | Amount (g) | Weight % |
|---|---|---|
| WHEY PROTEIN ISOLATE (PROTEIN SOURCE C) | 12.54 | 44.79 |
| WHEY PROTEIN ISOLATE (PROTEIN SOURCE A) | 8.36 | 29.86 |
| MALTODEXTRIN DIGESTION RESISTANT FIBER | 3.40 | 12.14 |
| WHEY PROTEIN HYDROLYSATE | 2.32 | 8.30 |
| FLAVOR POWDER | 0.69 | 2.46 |
| SODIUM CHLORIDE AND SODIUM CITRATE | 0.44 | 1.59 |
| OTHER AGENTS | 0.24 | 0.85 |

Sample Powder 7D

| Description | Amount (g) | Weight % |
|---|---|---|
| WHEY PROTEIN ISOLATE (PROTEIN SOURCE C) | 10.45 | 37.33 |
| WHEY PROTEIN ISOLATE (PROTEIN SOURCE A) | 10.45 | 37.33 |
| MALTODEXTRIN DIGESTION RESISTANT FIBER | 3.40 | 12.14 |
| WHEY PROTEIN HYDROLYSATE | 2.32 | 8.30 |
| FLAVOR POWDER | 0.69 | 2.46 |
| SODIUM CHLORIDE AND SODIUM CITRATE | 0.44 | 1.59 |
| OTHER AGENTS | 0.24 | 0.85 |

Sample Powder 7E

| Description | Amount (g) | Weight % |
|---|---|---|
| WHEY PROTEIN ISOLATE (PROTEIN SOURCE C) | 14.63 | 52.26 |
| WHEY PROTEIN ISOLATE (PROTEIN SOURCE A) | 6.27 | 22.40 |
| MALTODEXTRIN DIGESTION RESISTANT FIBER | 3.40 | 12.14 |
| WHEY PROTEIN HYDROLYSATE | 2.32 | 8.30 |
| FLAVOR POWDER | 0.69 | 2.46 |
| SODIUM CHLORIDE AND SODIUM CITRATE | 0.44 | 1.59 |
| OTHER AGENTS | 0.24 | 0.85 |

Beverage samples were prepared from the above powders by adding 28 g of the powder to 12 fluid ounces of reverse osmosis (RO) water. The turbidity of each sample beverage was measured according to the procedure described in Example 6. Results are shown in Table 1.

TABLE 1
Turbidity of Protein Combinations

| | Turbidity | |
|---|---|---|
| Sample | (NTU) | pH |
| Sample Beverage 7A (100% Protein Source A) | 15.3 | 6.7 |
| Sample Beverage 7B (1:1 weight ratio | 47.8 | 6.9 |
| Protein Source A/Protein Source B) | | |
| Sample Beverage 7C (2:3 weight ratio | 41.6 | 6.3 |
| Protein Source A/ Protein Source C | | |
| Sample Beverage 7D (1:1 weight ratio | 33.8 | 6.4 |
| Protein Source A/Protein Source C) | | |
| Sample Beverage 7E (3:7 weight ratio | 48.3 | 6.2 |
| Protein Source A/Protein Source C) | | |

As shown in Table 1, sample beverages containing 100% Protein Source A had a higher degree of clarity than beverages containing mixtures of Protein Source A with Protein Source B or Protein Source C. In sample beverages containing mixtures of proteins, the higher the amount of Protein Source A within the mixture, the better the clarity. Without being bound by theory, it is believed that the potassium, sodium, and calcium levels within the protein sources was responsible for the degree of clarity of the sample beverages. As shown in Table 2, Protein Source A has higher amounts of potassium and lower amounts of sodium and calcium than Protein Sources B or C. Based on the results shown in the table, sample beverages containing lower percentages of potassium and higher percentages of sodium and calcium had lower clarity than those with higher percentages of potassium and lower percentages sodium and calcium.

TABLE 2
Potassium, Calcium, and Sodium Levels in Protein Sources

| Protein Source | Potassium wt % | Calcium wt % | Sodium wt % |
|---|---|---|---|
| Protein Source A | 1.00 wt % | 0.04 wt % | 0.40 wt % |
| Protein Source B | 0.07 wt % | 0.10 wt % | 0.67 wt % |
| Protein Source C | 0.52 wt % | 0.51 wt % | 0.51 wt % |

### Example 8: Protein Combination Absorption Studies

Sample ready-to-drink beverages (8A-8F) containing mixtures of proteins sourced from different manufacturers (Protein Source A, Protein C, and Protein D) were prepared using the ingredients described below. KOH was added to each sample to achieve a target pH of 7.2. The sample beverages were then heat treated using an oil bath (at 150° C. for 30 seconds). The turbidity of the sample beverages was measured using the procedure described in Example 6. Results are shown in Table 3.

Sample Beverage 8A

| Description | Amount (g) | Weight % |
|---|---|---|
| REVERSE OSMOSIS (RO) WATER | 390.29 | 91.96 |
| WHEY PROTEIN ISOLATE (PROTEIN SOURCE A) | 21.15 | 4.98 |
| WHEY PROTEIN HYDROLYSATE | 2.35 | 0.55 |
| PROTEIN MASKING FLAVOR | 0.02 | 0.005 |
| MALTODEXTRIN DIGESTION RESISTANT FIBER | 6.78 | 1.60 |
| SODIUM CITRATE, DIHYDRATE, FINE GRANULAR | 0.42 | 0.10 |
| POTASSIUM CITRATE | 0.85 | 0.20 |
| SWEETENER | 0.11 | 0.03 |
| FLAVORING AGENTS | 2.38 | 0.56 |
| POTASSIUM HYDROXIDE FOOD GRADE | 0.06 | 0.02 |

Sample Beverage 8B

| Description | Amount (g) | Weight % |
|---|---|---|
| REVERSE OSMOSIS (RO) WATER | 390.11 | 91.96 |
| WHEY PROTEIN ISOLATE (PROTEIN SOURCE A) | 10.58 | 2.49 |
| WHEY PROTEIN ISOLATE (PROTEIN SOURCE C) | 10.58 | 2.49 |
| WHEY PROTEIN HYDROLYSATE | 2.35 | 0.55 |
| PROTEIN MASKING FLAVOR | 0.02 | 0.005 |
| MALTODEXTRIN DIGESTION RESISTANT FIBER | 6.78 | 1.60 |
| SODIUM CITRATE, DIHYDRATE, FINE GRANULAR | 0.60 | 0.14 |
| POTASSIUM CITRATE | 0.85 | 0.20 |
| SWEETENER | 0.11 | 0.03 |
| FLAVORING AGENTS | 2.38 | 0.56 |
| POTASSIUM HYDROXIDE FOOD GRADE | 0.06 | 0.01 |

Sample Beverage 8C

| Description | Amount (g) | Weight % |
|---|---|---|
| REVERSE OSMOSIS (RO) WATER | 390.09 | 91.96 |
| WHEY PROTEIN ISOLATE (PROTEIN SOURCE C) | 12.70 | 2.99 |
| WHEY PROTEIN ISOLATE (PROTEIN SOURCE A) | 8.45 | 1.99 |
| WHEY PROTEIN HYDROLYSATE | 2.35 | 0.55 |
| PROTEIN MASKING FLAVOR | 0.02 | 0.005 |
| MALTODEXTRIN DIGESTION RESISTANT FIBER | 6.78 | 1.60 |
| SODIUM CITRATE, DIHYDRATE, FINE GRANULAR | 0.62 | 0.15 |
| POTASSIUM CITRATE | 0.85 | 0.20 |
| SWEETENER | 0.11 | 0.03 |
| FLAVORING AGENTS | 2.38 | 0.56 |
| POTASSIUM HYDROXIDE FOOD GRADE | 0.06 | 0.02 |

Sample Beverage 8D

| Description | Amount (g) | Weight % |
|---|---|---|
| REVERSE OSMOSIS (RO) WATER | 390.06 | 91.96 |
| WHEY PROTEIN ISOLATE (PROTEIN SOURCE C) | 14.80 | 3.49 |
| WHEY PROTEIN ISOLATE (PROTEIN SOURCE A) | 6.34 | 1.50 |
| WHEY PROTEIN HYDROLYSATE | 2.35 | 0.55 |
| PROTEIN MASKING FLAVOR | 0.02 | 0.005 |
| MALTODEXTRIN DIGESTION RESISTANT FIBER | 6.78 | 1.60 |
| SODIUM CITRATE, DIHYDRATE, FINE GRANULAR | 0.65 | 0.15 |
| POTASSIUM CITRATE | 0.85 | 0.20 |
| SWEETENER | 0.11 | 0.03 |
| FLAVORING AGENTS | 2.38 | 0.56 |
| POTASSIUM HYDROXIDE FOOD GRADE | 0.06 | 0.02 |

Sample Beverage 8E

| Description | Amount (g) | Weight % |
|---|---|---|
| REVERSE OSMOSIS (RO) WATER | 390.29 | 91.96 |
| WHEY PROTEIN ISOLATE (PROTEIN SOURCE C) | 21.15 | 4.98 |
| WHEY PROTEIN HYDROLYSATE | 2.35 | 0.55 |
| PROTEIN MASKING FLAVOR | 0.02 | 0.005 |
| MALTODEXTRIN DIGESTION RESISTANT FIBER | 6.78 | 1.60 |
| SODIUM CITRATE, DIHYDRATE, FINE GRANULAR | 0.42 | 0.10 |
| POTASSIUM CITRATE | 0.85 | 0.20 |
| SWEETENER | 0.11 | 0.03 |
| FLAVORING AGENTS | 2.38 | 0.56 |
| POTASSIUM HYDROXIDE FOOD GRADE | 0.06 | 0.02 |

Sample Beverage 8F

| Description | Amount (g) | Weight % |
|---|---|---|
| REVERSE OSMOSIS (RO) WATER | 390.11 | 91.96 |
| WHEY PROTEIN ISOLATE (PROTEIN SOURCE D) | 10.58 | 2.49 |
| WHEY PROTEIN ISOLATE (PROTEIN SOURCE A) | 10.58 | 2.49 |
| WHEY PROTEIN HYDROLYSATE | 2.35 | 0.55 |
| PROTEIN MASKING FLAVOR | 0.02 | 0.005 |
| MALTODEXTRIN DIGESTION RESISTANT FIBER | 6.78 | 1.60 |
| SODIUM CITRATE, DIHYDRATE, FINE GRANULAR | 0.60 | 0.14 |
| POTASSIUM CITRATE | 0.85 | 0.20 |
| SWEETENER | 0.11 | 0.03 |
| FLAVORING AGENTS | 2.38 | 0.56 |
| POTASSIUM HYDROXIDE FOOD GRADE | 0.06 | 0.02 |

TABLE 3
Turbidity of Protein Combinations

| | Turbidity | |
|---|---|---|
| | (absorption at | |
| Sample | 600 nm) | pH |
| Sample Beverage 8A (100% Protein Source A) | 0.046 | 6.9 |
| Sample Beverage 8B (1:1 weight ratio of Protein Source A/ | 0.057 | 6.5 |
| Protein Source C) | | |
| Sample Beverage 8C (2:3 weight ratio of Protein Source A/ | 0.053 | 6.4 |
| Protein Source C) | | |
| Sample Beverage 8D (3:7 weight ratio of Protein Source A/ | 0.087 | 6.6 |
| Protein Source C) | | |
| Sample Beverage 8E (100% Protein Source C) | 0.159 | 6.2 |
| Sample Beverage 8F (1:1 weight ratio Protein Source A/ | 0.092 | 6.7 |
| Protein Source D) | | |

As shown in Table 3, the sample beverage containing 100 of Protein Source A had a higher degree of clarity than sample beverages containing mixtures of Protein Source A with Protein source C or with Protein Source C alone. In addition, the sample beverage containing a 50/50 mixture of Protein Source A and Protein Source D showed less clarity than the sample beverage containing Protein Source A alone. As shown in Table 4, protein Source D contains a lower amount potassium and a higher amount calcium than Protein Source A. These results support the premise that the potassium and calcium levels within the protein sources influence the degree of clarity of the sample beverages.

TABLE 4
Potassium, Calcium, and Sodium Levels in Protein Sources

| Protein Source | Potassium wt % | Calcium wt % | Sodium wt % |
|---|---|---|---|
| Protein Source A | 1.00 wt % | 0.04 wt % | 0.40 wt % |
| Protein Source C | 0.52 wt % | 0.51 wt % | 0.51 wt % |
| Protein Source D | 0.30 wt % | 0.50 wt % | 0.15 wt % |

### Example 9: Chelator Turbidity Studies

Sample ready-to-mix powders containing varying amounts of the chelator sodium citrate were prepared as described below.

Sample Powder 9A

| Description | Amount (g) | Weight % |
|---|---|---|
| WHEY PROTEIN ISOLATE (PROTEIN SOURCE C) | 21.24 | 77.29 |
| MALTODEXTRIN DIGESTION RESISTANT FIBER | 3.99 | 12.37 |
| WHEY PROTEIN HYDROLYSATE | 2.32 | 8.45 |
| SODIUM CITRATE, DIHYDRATE, FINE GRANULAR | 0.25 | 0.90 |
| SODIUM CHLORIDE | 0.20 | 0.71 |
| SILICON DIOXIDE - MICRONIZED | 0.05 | 0.18 |
| ANTIFOAM, MALTODEXTRIN BASED, POWDER | 0.02 | 0.08 |

Sample Powder 9B

| Description | Amount (g) | Weight % |
|---|---|---|
| WHEY PROTEIN ISOLATE (PROTEIN SOURCE C) | 21.24 | 77.29 |
| MALTODEXTRIN DIGESTION RESISTANT FIBER | 3.99 | 12.37 |
| WHEY PROTEIN HYDROLYSATE | 2.32 | 8.45 |
| SODIUM CITRATE, DIHYDRATE, FINE GRANULAR | 0.28 | 1.00 |
| SODIUM CHLORIDE | 0.20 | 0.71 |
| SILICON DIOXIDE - MICRONIZED | 0.05 | 0.18 |
| ANTIFOAM, MALTODEXTRIN BASED, POWDER | 0.02 | 0.08 |

Sample Powder 9C

| Description | Amount (g) | Weight % |
|---|---|---|
| WHEY PROTEIN ISOLATE (PROTEIN SOURCE C) | 21.24 | 77.29 |
| MALTODEXTRIN DIGESTION RESISTANT FIBER | 3.99 | 12.37 |
| WHEY PROTEIN HYDROLYSATE | 2.32 | 8.45 |
| SODIUM CITRATE, DIHYDRATE, FINE GRANULAR | 0.30 | 1.10 |
| SODIUM CHLORIDE | 0.20 | 0.71 |
| SILICON DIOXIDE - MICRONIZED | 0.05 | 0.18 |
| ANTIFOAM, MALTODEXTRIN BASED, POWDER | 0.02 | 0.08 |

Sample Powder 9D

| Description | Amount (g) | Weight % |
|---|---|---|
| WHEY PROTEIN ISOLATE (PROTEIN SOURCE C) | 21.24 | 77.29 |
| MALTODEXTRIN DIGESTION RESISTANT FIBER | 3.99 | 12.37 |
| WHEY PROTEIN HYDROLYSATE | 2.32 | 8.45 |
| SODIUM CITRATE, DIHYDRATE, FINE GRANULAR | 0.33 | 1.20 |
| SODIUM CHLORIDE | 0.20 | 0.71 |
| SILICON DIOXIDE - MICRONIZED | 0.05 | 0.18 |
| ANTIFOAM, MALTODEXTRIN BASED, POWDER | 0.02 | 0.08 |

Sample Powder 9E

| Description | Amount (g) | Weight % |
|---|---|---|
| WHEY PROTEIN ISOLATE (PROTEIN SOURCE C) | 21.24 | 77.29 |
| MALTODEXTRIN DIGESTION RESISTANT FIBER | 3.99 | 12.37 |
| WHEY PROTEIN HYDROLYSATE | 2.32 | 8.45 |
| SODIUM CITRATE, DIHYDRATE, FINE GRANULAR | 0.36 | 1.30 |
| SODIUM CHLORIDE | 0.20 | 0.71 |
| SILICON DIOXIDE - MICRONIZED | 0.05 | 0.18 |
| ANTIFOAM, MALTODEXTRIN BASED, POWDER | 0.02 | 0.08 |

Sample Powder 9F

| Description | Amount (g) | Weight % |
|---|---|---|
| WHEY PROTEIN ISOLATE (PROTEIN SOURCE C) | 21.24 | 77.29 |
| MALTODEXTRIN DIGESTION RESISTANT FIBER | 3.99 | 12.37 |
| WHEY PROTEIN HYDROLYSATE | 2.32 | 8.45 |
| SODIUM CITRATE, DIHYDRATE, FINE GRANULAR | 0.39 | 1.40 |
| SODIUM CHLORIDE | 0.20 | 0.71 |
| SILICON DIOXIDE - MICRONIZED | 0.05 | 0.18 |
| ANTIFOAM, MALTODEXTRIN BASED, POWDER | 0.02 | 0.08 |

Sample Powder 9G

| Description | Amount (g) | Weight % |
|---|---|---|
| WHEY PROTEIN ISOLATE (PROTEIN SOURCE C) | 21.24 | 77.29 |
| MALTODEXTRIN DIGESTION RESISTANT FIBER | 3.99 | 12.37 |
| WHEY PROTEIN HYDROLYSATE | 2.32 | 8.45 |
| SODIUM CITRATE, DIHYDRATE, FINE GRANULAR | 0.53 | 1.90 |
| SODIUM CHLORIDE | 0.20 | 0.71 |
| SILICON DIOXIDE - MICRONIZED | 0.05 | 0.18 |
| ANTIFOAM, MALTODEXTRIN BASED, POWDER | 0.02 | 0.08 |

Sample Powder 9H

| Description | Amount (g) | Weight % |
|---|---|---|
| WHEY PROTEIN ISOLATE (PROTEIN SOURCE C) | 21.24 | 77.29 |
| MALTODEXTRIN DIGESTION RESISTANT FIBER | 3.99 | 12.37 |
| WHEY PROTEIN HYDROLYSATE | 2.32 | 8.45 |
| SODIUM CITRATE, DIHYDRATE, FINE GRANULAR | 0.81 | 2.90 |
| SODIUM CHLORIDE | 0.20 | 0.71 |
| SILICON DIOXIDE - MICRONIZED | 0.05 | 0.18 |
| ANTIFOAM, MALTODEXTRIN BASED, POWDER | 0.02 | 0.08 |

Beverage samples were prepared from the above powders by adding 28 g of the powder to 12 fluid ounces of reverse osmosis (RO) water. The turbidity of each sample beverage was measured according to the procedure described in Example 6. Results are shown in Table 5.

TABLE 5
Turbidity of Protein Combinations

| | Turbidity |
|---|---|
| Sample | (NTU) |
| Sample Beverage 9A (Control, no additional sodium citrate for chelation) | 224 |
| Sample Beverage 9B (0.1 wt % additional sodium citrate for chelation) | 251 |
| Sample Beverage 9C (0.2 wt % additional sodium citrate for chelation) | 152 |
| Sample Beverage 9D (0.3 wt % additional sodium citrate for chelation) | 122 |
| Sample Beverage 9E (0.4 wt % additional sodium citrate for chelation) | 89 |
| Sample Beverage 9F (0.5 wt % additional sodium citrate for chelation) | 78.5 |
| Sample Beverage 9G (1.0 wt % additional sodium citrate for chelation) | 61.8 |
| Sample Beverage 9H (2.0 wt % additional sodium citrate for chelation) | 57.2 |

As shown in Table 5, sample beverages containing higher amounts sodium citrate had a higher degree of clarity than beverages containing lower amounts. Without being bound by theory, it is believed that the additional sodium citrate acts as a chelator and binds to the metal ions, improving the clarity of the beverage.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary aspects, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

1. (canceled)

2. A beverage comprising:
a. from about 1 wt % to about 10 wt % of protein;
b. one or more electrolytes; and
c. fiber;
wherein the beverage has a turbidity measurement of less than 100 NTUs and/or an absorbance of less than 0.1 at 600 nm wavelength.

3. The beverage of claim 2, wherein the protein comprises collagen, pea protein, rice protein, whey protein isolate, or a combination thereof.

4. The beverage of claim 3, wherein the whey protein isolate comprises one or more of:
a. no more than 1.3 wt % potassium;
b. no more than 0.50 wt % calcium; or
c. no more than 0.6 wt % sodium.

5. The beverage of claim 2, wherein the beverage comprises from about 0.1 wt % to about 7 wt % of protein hydrolysate.

6. The beverage of claim 2, wherein the beverage comprises whey protein isolate and protein hydrolysate, wherein the protein isolate and the protein hydrolysate are in a weight ratio of from about 90:10 to about 30:70.

7.-20. (canceled)

21. The beverage of claim 2, wherein the beverage further comprises from about 0.01 wt % to about 0.5 wt % of one or more acids.

22.-27. (canceled)

28. A powder base for preparing a beverage, the powder base comprising:
a. from about 40 wt % to about 80 wt % of protein;
b. one or more electrolytes; and
c. fiber;
wherein the powder base provides a beverage having a turbidity of less than 100 NTUs and/or an absorbance of less than 0.04 at 600 nm wavelength, when about 20 g to about 40 g of the powder is added to about 500 mL water and shaken for at least 15 seconds.

29. The powder base of claim 28, wherein the powder base comprises collagen, pea protein, rice protein, whey protein isolate, or a combination thereof.

30. The powder base of claim 29, wherein the whey protein isolate comprises one or more of:
a. no more than 1.3 wt % potassium;
b. no more than 0.50 wt % calcium; or
c. no more than 0.60 wt % sodium.

31. The powder base of claim 28, wherein the powder base comprises from about 5% wt % to about 55 wt % of protein hydrolysate.

32. The powder base claim 28, wherein the powder base comprises whey protein isolate and whey protein hydrolysate, wherein the whey protein isolate and the protein hydrolysate are in a weight ratio of from about 90:10 to about 30:70.

33.-50. (canceled)

51. A method of preventing muscle mass loss in a subject taking a GLP-1 receptor agonist, the method comprising administering to the subject an effective amount of a beverage comprising:
a. from about 1 wt % to about 10 wt % of protein;
b. one or more electrolytes; and
c. fiber;
wherein the beverage has a turbidity measurement of less than 100 NTUs and/or less than 0.04 absorbance at 600 nm wavelength.

52.-53. (canceled)

54. The method of claim 51, wherein the protein comprises the protein comprises collagen, pea protein, rice protein, whey protein isolate, or a combination thereof.

55. The method of claim 54, wherein the whey protein isolate comprises one or more of:
a. no more than 1.3 wt % potassium;
b. no more than 0.50 wt % calcium, or
c. no more than 0.60 wt % sodium.

56. The method of claim 51, wherein the protein comprises from about 0.5 wt % to about 7 wt % of whey protein hydrolysate.

57. The method of claim 51, wherein the beverage comprises whey protein isolate and why protein hydrolysate, wherein the whey protein isolate and the whey protein hydrolysate are in a weight ratio of from about 90:10 to about 30:70.

58.-71. (canceled)

72. The method of claim 51, wherein the beverage further comprises from about 0.01 wt % to about 0.5 wt % of one or more acids.

73.-85. (canceled)
